(19) United States
(12) Patent Application Publication
(10) Pub. No.: US 2002/0070953 A1
(43) Pub. Date: Jun. 13, 2002

(54) Systems and methods for visualizing and analyzing conditioned data

(76) Inventors: Timothy A. Barg, Naperville, IL (US); Stephen G. Eick, Naperville, IL (US); Jonathan C. Martin, Wheaton, IL (US); William C. Swanson, Saint Charles, IL (US); Ronald D. Smith, Batavia, IL (US); Darryl Whitmore, Palatine, IL (US); Kurt D. Rivard, Naperville, IL (US)

Correspondence Address: OLIFF & BERRIDGE, PLC, P.O. Box 19928, Alexandria, VA, 22320, US

(21) Appl. No.: 09/848,202

(22) Filed: May 4, 2001

Related U.S. Application Data
(60) Provisional application No. 60/201,761, filed on May 4, 2000.

(51) Int. Cl. G09G 5/00

(52) U.S. Cl. 345/700

(57) ABSTRACT

A tree-structured workflow control and a tree-structured report selection control allow users to easily display data and generate reports, without having to actively determine the various measures and dimensions to be displayed in various interactive views of the data and various simple and advanced reports. By linking predetermined sets of dimensions, measures and views to predetermined workflow control entries and report selection entries in a tree structure having labels on the branches and leaves that are logically related to the associated predetermined sets, the user can immediately obtain a data visualization perspective or a report without having to actively select the particular dimensions and measures for display, and without having to actively arrange the selected dimensions into a multi-dimensional view. The user can also alter the particular dimensions and/or measures being displayed and associate the user's selection with a new predetermined entry in the tree-structured workflow and report selection controls.

### BACKGROUND OF THE INVENTION

1. Field of Invention

This invention relates to visualizing multiple-dimension data obtained from web site activity logs.

2. Description of Related Art

One of the most exciting trends of our time is the explosive growth of the Internet, web sites, and e-commerce. This trend has manifested itself with the creation of millions of web sites, the widespread emergence of e-commerce sites, the birth of a huge number of “dot coms”, and the merging of brick and mortar and cyberspace business models. As web technology has matured, web sites have progressed from static “information distribution” sites to hugely complex portals providing rich, highly customized services.

For many companies, e-commerce web sites have become a significant, if not the primary, distribution channel for a company's products and services. With this transition from a traditional brick and mortar economy to a new self-service economy, web sites are becoming a focal point for customer interactions. Customer relationships must be formed, personalized, and managed through this new medium.

Although the technology, channel, and medium have changed, the underlying business problems, such as: “How do I identify new prospects?” “Create offers that excite and satisfy them?” “Retain existing customers and sell them more?” “Understand what is selling?” “Maximize return on advertising expenditures?” “Manage profit by product and product line?” have not. What is new is that these business functions are now being conducted via the Internet instead of using traditional means.

Translated into e-business, the key questions become: “How do we drive profitable traffic to our site?” “Which banner ads were most successful?” “How do we target customers in Germany?” “How do I sell more products during evening hours when my site has spare capacity?” “What is the traffic flow through my site?” “Which sections of my site are customers bypassing?” “How long do customers linger?” “How do I increase site stickiness?”

Perhaps the most significant difference between the old brick and mortar and the new e-business is richer instrumentation. The e-business challenge is then how best to exploit this exceedingly rich new information source. The first problem, capturing site activity, is conceptually simple but practically difficult. There are various strategies for instrumenting sites, but the most common source of site activity data is web site activity logs. These contain a record of every page request.

With the decreasing cost of storage and increased bandwidth of networks, storing large volumes of the fine grain data contained in web site activity logs has become technically feasible and cost effective. In e-business environments, this fine grain data in web site activity logs typically includes, among other things, the date and time on which the activity occurred; the user name and Internet service provider (ISP) of the user who accessed this server; the action the client was trying to perform; the resource accessed; the query, if any, the client was trying to perform; the browser used on the client; the content of the cookie, if any, sent or received; and the site on which the user clicked on a link that brought the user to this site. When properly analyzed, web site activity logs provide a rich analysis source for understanding e-customer behavior.

There are numerous commercial systems that produce web reports that describe site activity. B. Huberman et al., “Strong regularities in world wide web surfing,” Science, 280:95-97, 1997, and S. Lawrence et al., “Accessibility of information on the web,” Nature, 400(6740):107-109, 1999 outlines what is known about paths and web browsing patterns. A significant fraction of the previous research, such as that described in A. Wexelblat et al., “Footprints: History-rich tools for information foraging, “CHI '99 Conference Proceedings, ACM Press, 1999, has focused on helping browser navigate through sites more easily. Other research, such as that described in J. Borges et al., “Data mining of user navigation patterns,” and R. Cooley et al., “Websift: the web site information filter system,” each in Proceedings 1999 KDD Workshop on Web Mining, San Diego, Calif., 1999, Springer-Verlag, has mined web data to determine common browsing patterns. However, the web site activity data visualization systems and methods according to this invention are the first to use an interactive workspace for web site analysis.

Thus, a brick and mortar department store might know that a customer purchased a tie in the Men's Department and, by matching credit card transactions, perhaps also purchased a portable drill in the tools department. In the equivalent e-business scenario, web site activity logs indicate where the customer came from, when and where the customer entered the web site, what the customer searched for, which other web pages the customer visited, what items the customer put in the shopping basket, and if the customer abandoned the purchase because the checkout was too complicated.

### SUMMARY OF THE INVENTION

However, processing web site activity logs quickly becomes non-trivial. The transaction volumes may be huge, sites may be geographically dispersed for reliability, likely include multiple components such as ad, content, and personalization engines, and are routinely distributed across server farms. The next level of problem, performing effective analyses, involves collecting and coalescing this dispersed information set into a coherent schema, correlating site activity with related attributes, and linking it with enterprise information.

First generation web site reporting tools focus on data collection and reporting. These tools typically include a scalable parsing/mining engine for web server log files, or perhaps a sniffer that captures site activity by monitoring TCP/IP packets. These tools aggregate site statistics, either raw clicks or assembled sessions, and store the aggregate site statistics in a fast database. The engineering challenge that these tools address is how to collect, process, store, and report on high-volume web site activity. When sites were first deployed, the servers, platforms, and web infrastructure were much less standardized than today. It was a huge problem just to cope with all the different web log formats and assemble the information into a coherent schema.

The data collection problem, although still complex, has been somewhat mitigated both as the standards bodies have formalized web site activity log formats and as packaged solutions directed to these standard formats have become available. The next generation of web server suites will further solve the back end problem by automatically collecting web statistics and depositing them into an associated database. The “reporting engine” for first generation tools would produce literally hundreds of fixed reports showing site activity by time of day, uniform resource locator (URL), browser, and page errors, etc. Initially, customers were thrilled—the reports answered simple questions like “What's happening on my site?” “How many hits did I have yesterday?”

Transactions collected by operational systems are frequently stored in relational tables. For a variety of reasons, including data cleanliness, scalability, efficiency of the relational method, difficulty in building schemas, and computational complexity, analyzing, understanding, and making business decisions using raw relational tables is difficult. Unfortunately, the relational model and the standard interface of the structured query language (SQL) used to manipulate relational tables, as described in A Guide to the SQL Standard, C. J. Date et al, Addison-Wesley, Reading, Mass., 1997, are not well-suited for analysis tasks.

Furthermore, the textual reports and static graphics, such as bar or pie charts, generated from such parsed web site activity logs are hard to understand, particularly for large tables. Users usually find it difficult, if not impossible, to see patterns, discover trends, and/or find relationships between various web site activity measures. Seemingly simple analysis tasks, such as identifying the three largest cells, locating the two rows with the smallest totals, or finding the biggest growth trends, are time consuming and tedious.

This invention provides interactive web site activity data visualization systems and methods that allow a user to dynamically interact with various graphical data displays generated from the parsed web site activity logs.

This invention separately provides web site activity data visualization systems and methods that include a web site activity log filter that adds session identifiers to the web site activity data stream stored in the web site activity log. These session identifiers allow a single visit to be tracked as the visitor navigates through the web site.

This invention further provides web site activity data visualization systems and methods that include a web site activity log miner that extracts both sessions and hits from the web site activity log

This invention separately provides web site activity data visualization systems and methods that include a click stream data warehouse including analysis cubes.

This invention separately provides web site activity data visualization systems and methods that include a plurality of dozens of management reports that can be distributed throughout the enterprise represented by the analyzed web site.

This invention separately provides web site activity data visualization systems and methods that include a visual workspace that provides a rich, iterative, ad hoc environment for web site analysis.

This invention separately provides web site activity data visualization systems and methods that include a workflow control that structures web site analysis sessions.

This invention separately provides web site activity data visualization systems and methods that include paths analyses, promotions analyses, errors analyses, and other web site specific analyses.

This invention separately provides web site activity data visualization systems and methods that include specific visual metaphors that support and facilitate click stream analysis.

This invention separately provides web site activity data visualization systems and methods that include a rich environment that helps users convert insights and decisions into action that creates value.

Various ones of these features of the web site activity data visualization systems and methods according to this invention are capable of working together to provide a powerful environment for web site analysis.

Various ones of these features of the web site activity data visualization systems and methods according to this invention are capable of working together to allow users to understanding visitor demographics, i.e., who is visiting the analysed web site and when, what the visitors are doing within the web site, and the like.

Various ones of these features of the web site activity data visualization systems and methods according to this invention are separately capable of working together to allow users to analyzing promotional activity to understand which promotions drive profitable traffic to the analyzed web site.

Various ones of these features of the web site activity data visualization systems and methods according to this invention are capable of working together to allow users to improving web site effectiveness to improve the customer experience, avoid abandoners, increase site stickiness, and provide up-selling opportunities.

Various exemplary embodiments of the web site activity data visualization systems and methods according to this invention provide a number of tools for visual discovery. Each of the tools of the web site activity data visualization systems and methods according to this invention target different aspects of visually analyzing web site activity data.

The analysis approach for each of these applications is essentially the same. Reports provide high level trends. Successively relating the trends to different attributes using the workspace of the web site activity data visualization systems and methods according to this invention leads to insights. This process involves seeing patterns, formulating hypotheses, subsetting to confirm the trends, and successively drilling down to individual transactions. Converting the insights and thus gaining value involves taking action. The action might be exporting visitor lists to an operational system for target emails, tuning the web site personalization engine, simplifying images on web pages that download slowly and cause abandonment, or redesigning overly complex web sites. The analysis approach as embodied in the web site activity data visualization systems and methods according to this invention is both ad hoc and iterative.

In various exemplary embodiments of the web site activity data visualization systems and methods according to this invention, these tools are organized into a number of different perspectives. A perspective is a set of linked visual components, or “views”, that are displayed together on the same graphical user interface screen. The views in a perspective work together to enable a particular type of visual analysis.

In various exemplary embodiments of the web site activity data visualization systems and methods according to this invention, the data displayed in each of the views forming a perspective is selectable to allow the user to focus the analysis of the displayed perspective on the selected data, or to allow the user to exclude the selected data from that analysis.

In various exemplary embodiments of the web site activity data visualization systems and methods according to this invention, a tree structure is provided to display an organized outline of predefined web site activity reports. Each report includes at least a pair of pre-selected dimensions of, and a pre-selected measure for, the web site activity data.

In various exemplary embodiments, the tree structure allows the user to select a predefined class of reports, one or more predefined subclasses, sub-subclasses, etc., if any, and a particular predefined report in the selected class, subclass or sub-subclass. In response, one of the perspectives is displayed using two or more of the pre-selected dimensions and the pre-selected measure. The user can then select another one of the perspectives.

In various exemplary embodiments, some of the views of the displayed perspective include list boxes that allow the user to change the pre-selected dimension or measure to another dimension. In various exemplary embodiments, the list boxes include only a limited number of the possible dimensions, usually (but not always) those dimensions that are functionally or logically related to the pre-selected dimension.

These and other features and advantages of this invention are described in or are apparent from the following detailed description of various exemplary embodiments of the systems and methods according to this invention.

### BRIEF DESCRIPTION OF THE DRAWINGS

Various exemplary embodiments of this invention will be described in detail, with reference to the following figures, wherein:

FIG. 1 is a block diagram outlining one exemplary embodiment of the web site activity data visualization system according to this invention;

FIG. 2 is a block diagram outlining one exemplary embodiment of the multi-dimensional data structure visualizing systems according to this invention;

FIG. 3 is one exemplary embodiment of the tree structure according to this invention;

FIG. 4 is an first exemplary embodiment of a tree-structured single measure, multi-dimensional perspective according to this invention;

FIG. 5 is one exemplary embodiment of a tree-structured textual data perspective according to this invention;

FIG. 6 is a second exemplary embodiment of a tree-structured single measure, multi-dimensional perspective according to this invention;

FIG. 7 is a first exemplary embodiment of the tree-structure multiple measures multi-dimensional perspective according to this invention;

FIG. 8 is a first exemplary embodiment of a navigation toolbar according to this invention that is usable to navigate through the tree structure and the various perspectives according to this invention;

FIG. 9 is a second exemplary embodiment of a navigation toolbar according to this invention that is usable to navigate through the various multiple measures views of the multi-dimensional perspective according to this invention;

FIG. 10 is a third exemplary embodiment of a navigation toolbar according to this invention that is usable to alter the single measure view according to this invention;

FIG. 11 is a fourth exemplary embodiment of a navigation toolbar according to this invention that is usable to alter the single dimensional views of the multi-dimensional perspective according to this invention;

FIG. 12 illustrates the application of the “top view” function according to this invention on the exemplary tree-structure single measures perspective of FIG. 4;

FIG. 13 illustrates the application of the “side view” and “turn” functions according to this invention on the exemplary tree-structure single measures perspective of FIG. 4;

FIG. 14 illustrates the application of the “maximum” function according to this invention on one of the exemplary single dimensional views of the exemplary tree-structure single measures perspective of FIG. 4;

FIG. 15 illustrates the application of the “normalized” function according to this invention on the maximized exemplary single dimensional view of the exemplary tree-structure single measures perspective of FIG. 4;

FIG. 16 illustrates applying a visual query according to this invention to one of the exemplary single dimensional views of the exemplary tree-structure textual data perspective of FIG. 5;

FIG. 17 illustrates changing the scale of the textual data view of the exemplary tree-structure textual data perspective of FIG. 16 from “full” to “fit to window” according to this invention;

FIG. 18 illustrates changing the scale of the textual data view of the exemplary tree-structure textual data perspective of FIG. 16 from “full” to “single pixel per line” according to this invention;

FIG. 19 illustrates applying another visual query according to this invention to a second one of the exemplary single dimensional views of the exemplary tree-structure textual data perspective of FIG. 5, with the scale of the textual data view of the exemplary tree-structure textual data perspective changed “fit to screen” according to this invention;

FIG. 20 illustrates applying a third visual query according to this invention to the second one of the exemplary single dimensional views of the exemplary tree-structure textual data perspective of FIG. 19 according to this invention;

FIG. 21 illustrates changing the scale of the textual data view of the exemplary tree-structure textual data perspective of FIG. 20 from “fit to window” to “single pixel per line” according to this invention;

FIG. 22 illustrates applying the “parallelized lines” function according to this invention on the first exemplary embodiment of the tree-structure multiple measures multi-dimensional perspective of FIG. 7;

FIG. 23 illustrates applying a complex visual query according to this invention comprising the intersection of a first visual query and a second visual query on the exemplary embodiment of the tree-structure multiple measures multi-dimensional perspective shown in FIG. 22;

FIG. 24 is a third exemplary embodiment of a tree-structured single measure, multi-dimensional perspective including a color legend view according to this invention;

FIG. 25 shows one exemplary embodiment of a “reports” graphical user interface screen according to this invention displayable upon selecting a corresponding menu item of the “reports” drop down menu;

FIG. 26 shows one exemplary embodiment of a simple report generated in response to selecting the create widget of the graphical user interface screen shown in FIG. 25;

FIG. 27 shows one exemplary embodiment of a complex report generated in response to selecting the create widget of the graphical user interface screen shown in FIG. 25;

FIG. 28 shows one exemplary embodiment of a “create pivot table” graphical user interface screen according to this invention displayable upon selecting a corresponding menu item of the one of the drop down menus;

FIG. 29 is a flowchart outlining one exemplary embodiment of the data visualization methods according this invention;

FIG. 30 is a flowchart outlining in greater detail one exemplary embodiment of a method of selecting an entry of a tree structure of FIG. 29;

FIG. 31 is a flowchart outlining in greater detail one exemplary embodiment of a method of changing the displayed measure of FIG. 29;

FIG. 32 is a flowchart outlining in greater detail one exemplary embodiment of a method of updating the totals of FIG. 31;

FIG. 33 is a flowchart outlining in greater detail one exemplary embodiment of a method of changing the color mapping used to color the current dimensions and measures of FIG. 29;

FIG. 34 is a flowchart outlining in greater detail one exemplary embodiment of a method of changing the displayed multi-dimensional view of FIG. 29;

FIG. 35 is a flowchart outlining in greater detail one exemplary embodiment of a method of arranging and display the single measure view of FIG. 34;

FIG. 36 is a flowchart outlining in greater detail one exemplary embodiment of a method of arranging and displaying the textual data view of FIG. 34;

FIG. 37 is a flowchart outlining in greater detail one exemplary embodiment of a method of arranging and displaying the multi-measures view of FIG. 34;

FIG. 38 is a flowchart outlining in greater detail one exemplary embodiment of a method of generating a worksheet of FIG. 29;

FIG. 39 is a flowchart outlining in greater detail one exemplary embodiment of a method of changing the data selection of FIG. 29;

FIG. 40 is a flowchart outlining in greater detail one exemplary embodiment of a method of generating a report of FIG. 29; and

FIG. 41 is an exemplary web site activity log.

### DETAILED DESCRIPTION OF EXEMPLARY EMBODIMENTS

The conditioned data visualization systems and methods of this invention are described in summary above and in detail below using exemplary embodiments that are directed to visualizing web site activity log data. However, it should be appreciated that, the conditioned data visualization systems and methods of this invention are more generally directed to visualizing any previously conditioned data. In general, raw data is “conditioned” by parsing and/or mining the raw data to place, i.e., condition, the raw data into a database structure. In general, the database structure conditions the parsed and/or mined data by storing measure data for different dimensions into database fields associated with those dimensions, and by organizing the various dimension fields for a defined unit of the data into a database record.

As discussed above, the first generation web site reporting tools focused on data collection and reporting. These first generation tools produced literally hundreds of fixed reports showing site activity by time of day, uniform resource locator (URL), browser, and page errors, etc. Initially, customers were thrilled—the reports answered simple questions like “What's happening on my site?” “How many hits did I have yesterday?”

Soon, however, problems emerged. It is exceedingly difficult to make delicate business decisions using just raw reports. Fixed reports have a number of problems. In particular, fixed reports: capture one point in time and thus are quickly outdated; miss important trends and outliers that are summarized in the data; are not effective for multi-dimensional problems; require significant people and information technology (IT) resources if the reports are to be customized to the user's particular e-business; provide no ad hoc interactivity; and do not permit the user to drill down to access details.

Most importantly, fixed reports report only on what the vendor believed to be important to the user. This problem with reports is well known within the data mining community and is called “assumptive-based analysis.” The reports assume what is reported upon, and thus deliver fixed answers to pre-specified questions. Inevitably, the questions are not quite right and the particular case of interest to the user is slightly but significantly different from what is reported upon. This leads to a “report explosion”, where the vendors provide hundreds of reports hoping to answer all important questions using a “shotgun” approach. What goes wrong with this approach is that it become increasingly difficult to find the specific report that is designed to answer a particular question.

A final problem with fixed reports is that it is impossible to correlate between different variables. A report-based correlation analysis involves printing several different reports and manually trying to infer the relationships between the reports by mentally comparing the data in each report. The net result is that the first generation tools were exciting initially but insufficient for all but the most simple web sites.

The inventors have determined that these first generation tools are inadequate because analyzing web site activity logs presents analysis problems that are dynamic, interactive, and iterative. Addressing these analysis problems involves correlating trends, making comparisons, and performing richer analyses. These tasks are impossible with fixed reports.

The web site activity data visualization systems and methods according to this invention are useable to implement an e-business performance analysis system and include a visual workspace and analysis engine that supports ad hoc discovery, correlation, and analysis; workflow to guide a user through the analysis process; a web log miner; a session and hit-based click stream schema and data store for web site activity; a number of static HTML reports that can be scheduled, browsed, and emailed to decision makers and acted upon to convert analysis insights into business value; and result sets that can be exported based upon the analysis insights.

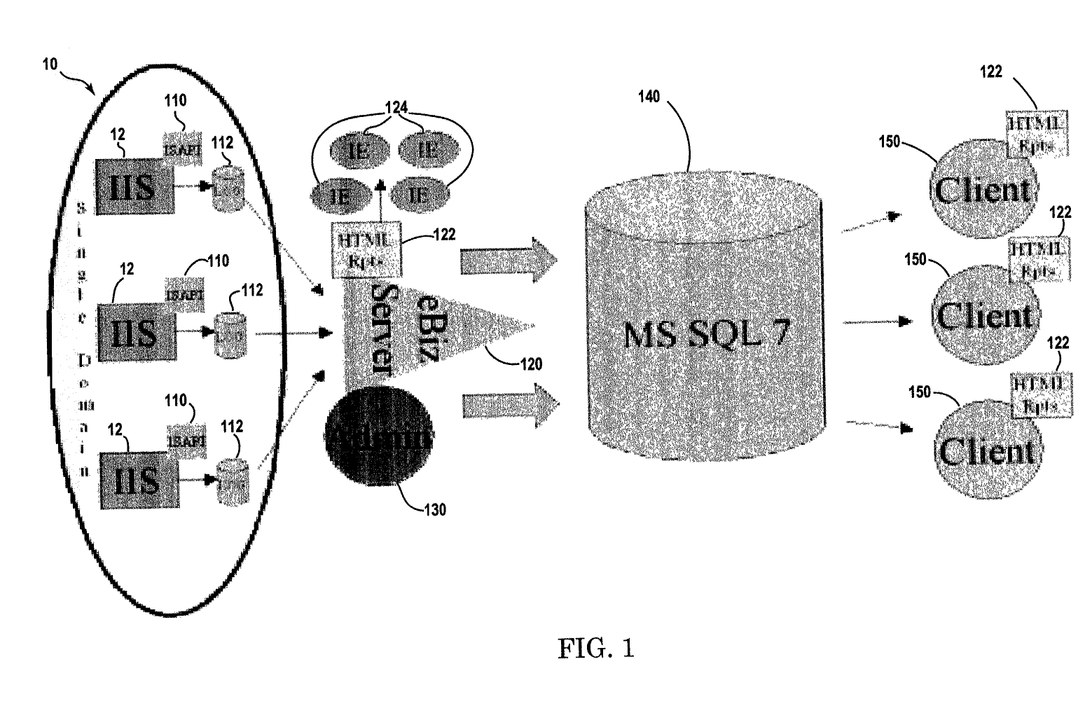

FIG. 1 shows one exemplary embodiment of the system architecture of the web site activity data visualization systems and methods according to this invention. In particular, as shown in FIG. 1, in this exemplary embodiment, the system architecture includes four significant components: an Internet Information Server application programming interface (ISAPI) filter that attaches to the e-business's web server for sessionization, a server, a conditioned data warehouse, and a number of analysis clients. In various exemplary embodiments, the conditioned data warehouse is implemented as a relational database using the Microsoft SQL Server 7.0 database application program. In the exemplary embodiment shown in FIG. 1, the web site uses the Microsoft Internet Information Server, that is, Microsoft's web server software. However, it should be appreciated that, in other exemplary embodiments, the ISAPI filter can attach to an known or later developed web server software using any other known or later developed different format for the web site activity log. Similarly, it should be appreciated that, in other exemplary embodiments, the conditioned data warehouse can be implemented using any other known or later developed relational database.

In operation, the ISAPI filter, described below, generates session numbers for HTTP requests that allow the sequence of pages followed by a given client to be tracked. The server parses the IIS log files, shown on the left, mines the parsed IIS log file data, and deposits the results in MS SQL Server 7.0 tables. After parsing and mining is complete, the server-reporting module creates dozens of static HTML reports that are distributed and published throughout the enterprise. Clients running the visual workspace portion of the web site activity data visualization systems and methods according to this invention connect directly to the SQL Server 7.0 database for click stream data access. The SQL Server 7.0 warehouse may be hosted on a machine running the server. Alternatively, the SQL Server 7.0 warehouse may be hosted on its own machine for increased scalability.

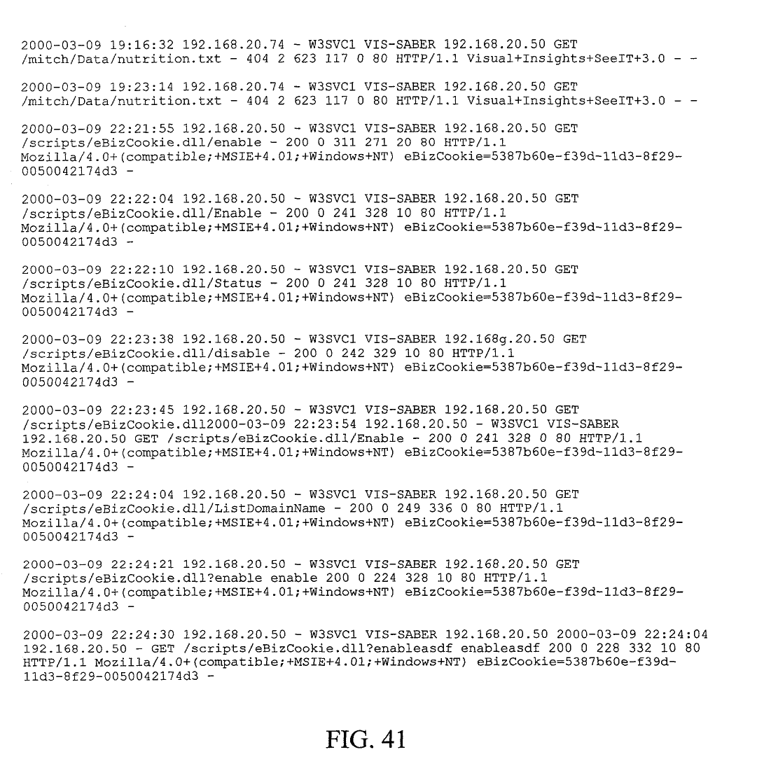

In particular, as shown in FIG. 1, a particular single domain web site 10 includes one or more web servers 12. In particular, the servers 12 are executing the Microsoft Internet Server software. Accordingly, the exemplary embodiment of shown in FIG. 1 web site activity data visualization system 100 according to this invention shown in FIG. 1 includes an equivalent number of Internet information Server Application Programming Interface filters (ISAPI filters) 120. As indicated above, as the web servers 12 interact with the client software of visitors visiting the web server 10, the web site server generates web activity log data which is stored in a corresponding number of web site activity log files 112. As set forth above, the ISAPI filters 110 generate session numbers for each of the HTTP requests so that the sequences of pages accessed by a given visitor can be tracked. Thus, each of the web log entries, such as those shown in FIG. 41, have an ISAPI filter session number appended them.

In particular, when a new visitor to the web site is first logged, that visitor does not have any information associated with that visitor that allows the movement of that visitor within the web site to be tracked. Conventionally, when the first web page requested by this visitor is forwarded to that new visitor, tracking information, usually in the form of a “cookie”, is transmitted with the requested first web page. As a result, assuming this visitor has not disabled the use of cookies at the client machine of that user, each time that new visitor moves within the web site by sending web page requests to the web site, this visitor's client machine transmits the tracking information back to the web site along with the request.

Thus, all requests subsequent to the first requested web page by this visitor, i.e., the various web log entries generated by such requests, can be associated together to track this visitor's movement within the web site. However, using this technique, the first web page requested by that user cannot be associated with the subsequent requests, because the tracking information does not exist when the first web site activity log entry for this visitor is created. Unfortunately, this first web page is often the only way to determine how the visitor got to the web site and thus is the only way to determine how different promotions and the like are affecting traffic to the web site.

In contrast to this conventional web site tracking technique, in the web site activity data visualization system 100, each time one of the servers 12 receives a web site page request that does not have tracking information containing an embedded session number and does not have an originating IP address within the web site, the associated ISAPI filter 110 recognizes that request as originating from a new visitor. As a result, the ISAPI filter 110 generates a session number, embeds that session number in the web site activity log data for that first page number before it is added as a new entry in the associated the web site activity log 112, and embeds that session number into the tracking information that is sent back to the new visitor with the requested first web page.

As indicated above, the ISAPI filters 110 recognize a new visitor, and thus create a new session, when two conditions are met. First, if a web page request already has tracking information containing an embedded session number, then the ISAPI filters can positively identify that web page request as part of a current ongoing session of a current visitor. Thus, only web page requests that do not have tracking information with an embedded session number can be from a new visitor.

However, many visitors, due to privacy concerns, prevent their client machines from accepting or returning cookies. Thus, many web page requests are received that do not have tracking information, and thus cannot have embedded session numbers. However, only new visitors will be moving from a current web page that is outside of this web site. That is, current visitors, because they are already in this web site, will be moving from a current web page that is within this web site. Thus, only web site page requests that do have a referring uniform resource location (URL) outside of this the web site truly reflect new visitors.

It should also be appreciated that, while the ISAPI filters 110 allow the first web page requests of such visitors to be identified, any subsequent page requests from such visitors will not meet the second condition. In such cases, when later parsing the web site activity log entries resulting from web page requests by such visitors, because those web site activity log entries do not have session numbers, those web site activity log entries are discarded in their entireties.

Whenever a user of the web site activity data visualization system 100 wishes to analyze the web site activity logs 112, the user invokes an administration module 130 of the web site activity data visualization system 100. The administration module 130 allows the user to input the various web logs 112 into a web site activity log miner 120. Based on the configuration information entered by the user through the administration module 130, the web site activity log miner 120 parses the web logs 112, and mines the parsed web log data to extract web site activity data corresponding to various dimensions and measures selected by the user. The parsed web site activity data is then stored by the web site activity log miner 120 in a Microsoft SLQ server 7.0 data warehouse. Alternatively, as indicated above, any other known or later developed database system can be used in place of the Microsoft SLQ server 7.0 data warehouse.

Additionally, as shown in FIG. 1, in the administration module 130, the user can generate one or more HTML reports 112 and distribute them to end users 124.

As shown in FIG. 1, one or more client modules 150 of the web site activity data visualization system 100 can also be launched. Each of these client modules 150 can access the parsed web site activity logs stored in the conditioned data warehouse 140 to visually explore the parsed web site activity data and to generate HTML reports 122, pivot tables and the like.

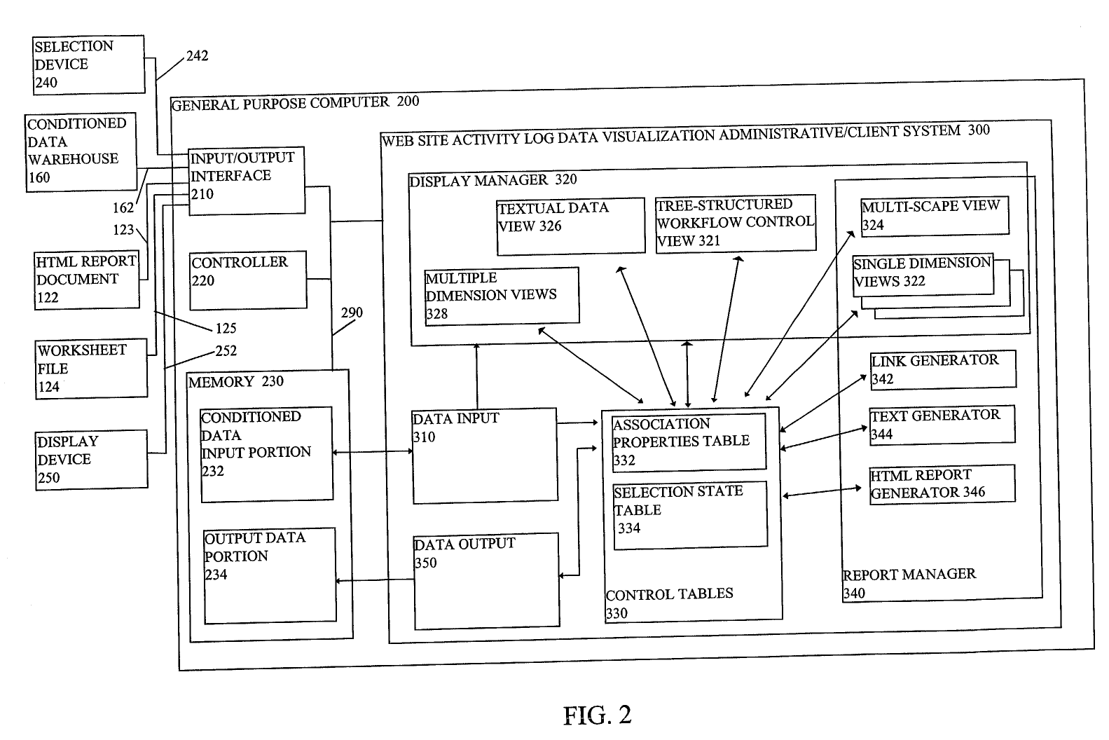

FIG. 2 is a block diagram outlining one exemplary embodiment of the web site activity data visualization system administration or client modules 120 and 150 according to this invention. In particular, as shown in FIG. 2, the web site activity data visualization administration and client modules 120 and 150 according to this invention can be implemented using a general purpose computer 200. In the exemplary embodiment shown in FIG. 2, the general purpose computer 200 includes an input/output interface 210, a controller 220, a memory 230, a selection device 240 and a display 250. In particular, the input/output interface 210 is connected to the selection device 240 and the display device 250 using links 242 and 252, respectively. The input/output interface 210, the controller 220 and the memory 230 are each connected to an internal data/control bus 290.

The memory 230 includes a conditioned data input portion 232 and an output data portion 234. The conditioned data input portion 232 stores conditioned data, such as the parsed and mined web site activity data, obtained from a conditioned data warehouse 160, such as a database stored on the SQL Server 7.0 140. The output data portion 234 can store HTML report documents 122 generated using the web site activity data visualization administration or client modules 130 or 150 and/or an output multi-dimensional data structure, such as a Microsoft Excel™ worksheet or any other known or later developed multi-dimensional data structure, such as an OLAP data cube.

As indicated above, in general, the conditioned data stored in the conditioned data input portion 232 will be obtained by the general purpose computer 200 by inputting conditioned data from the conditioned data warehouse 160 over a link 162 and through the input/output interface 210. However, it should be appreciated that the conditioned data stored in the conditioned data input portion 232 could have previously been obtained from the conditioned data warehouse 160 and stored locally at the general purpose computer 200 in a non-volatile portion of the memory 230 or in a file stored on a distributed network to which the general purpose computer 200 is connected through the input/output interface 210. Similarly, the output data stored in the output data portion 234 can be output through the input/output interface 210 as an HTML report document 122 over a link 123 to a recipient or as a worksheet output through the input/output interface 210 to a worksheet file 124 accessed over a link 125.

The links 123, 125, 162, 242 and 252 can each be any known or later developed structure for connecting the general purpose computer 200 to the corresponding remotely located element, such as a direct cable connection, a connection over a local area network or a wide area network, a connection over any other known or later developed distributed network, such as the Internet, an intranet, an extranet, or the like. It should also be appreciated that the HTML report document 122 and the worksheet file 124 can be output to any non-volatile storage device implemented within the general purpose computer 200 and directly connected to the data bus 290, such as a large-scale floppy disk and disk drive, such as a ZIP™ or a JAZ™ drive system or the like, a hard drive, a writtable optical disk and disk drive, flash memory, or any other large-scale data storage device.

The selection device 240 connected to the input/output interface 210 can be any known or later developed device for allowing various elements of the various perspectives displayable on the display 250 to be selected. Thus, the selection device 240 can be implemented using a mouse, a trackball, a touch pad, a touch screen, or any other known or later developed device usable to interact with the graphical user interfaces according to this invention. The display device 250 can be any known or later developed device capable of displaying a graphical user interface and a selection-device-controllable cursor or other pointing element.

In particular, the general purpose computer 200 can be any known or later developed device capable of inputting data from the conditioned data warehouse 160 and selection and control inputs from the selection device 240, capable of generating and displaying graphical user interfaces on the display device 250 and capable of implementing the web site activity data visualization administration and/or client modules 130 and 150. In particular, the general purpose computer 200 includes a conditioned data visualization administration/client system 300 according to this invention. In general, the conditioned data visualization administration/client system 300 will be implemented as one or more software routines, modules and/or programs executing on the general purpose computer 200.

In various exemplary embodiments, the conditioned data visualization administration/client system 300 according to this invention is a web site activity data visualization administration/client system 300. Thus, the following detailed description will refer to the data visualization administration/client systems 300 according to this invention as a web site activity data visualization administration/client system 300. However, it should be appreciated that the following detailed description applies to all data visualization systems 300 according to this invention.

As shown in FIG. 2, the web site activity data visualization administration/client system 300 according to this invention includes a data input circuit or routine 310, a display manager circuit or routine 320, one or more control tables 330, a report manager circuit or routine 340, and a data output circuit or routine 350. The data input circuit or routine 310 reads data from the conditioned data stored in the conditioned data input portion 232 into the web site activity data visualization administrative/client system 300. Similarly, the data output circuit or routine 350 outputs web site activity visualization data, such as the various views and perspectives discussed herein, generated HTML report data and generated worksheet data as discussed herein, to the output data portion 234 of the memory 230.

As shown in FIG. 2, the display manager circuit or routine 320 is used to generate a tree structure workflow control view 321, a number of single dimension views 322, a multiscape view 324, a textual data view 326 and a number of multiple dimension views 328 based on the state of the data/color/selection state table 330 and the input parsed web site activity data stored in the input parsed web site activity data portion 232 and input using the data input circuit or routine 310.

The one or more control tables 330 include an association properties table 332 and a selection state table 334. The association properties table 332 stores both predetermined and user created association data that associates a particular one of the entries of the tree structure workflow control view 321 with particular ones of the available dimensions and measures, and associates various ones of those particular ones of the available dimensions and measures with various ones of the number of single dimension views 322, the multiscape view 324, the textual data view 326 and the number of multiple dimension views 328. This is described in greater detail below, and in U.S. Provisional Patent Application Nos. 60/201,737, and 60/201,761, and U.S. Non-Provisional Patent Application No.______(Attorney Docket Number 106131, cofiled herewith), each incorporated herein by reference in its entirety.

The selection state table 334 stores selection data representing the conditioned data associated with the currently selected entry of the tree structure workflow control view 321, the currently displayed portion of the associated conditioned data to be displayed by the display manager circuit or routine 320, and the currently selected portion of the associated conditioned data displayed by the display manager circuit or routine 320.

The display manager circuit or routine 320 generates these views, combines them to generate one of the various perspectives discussed herein based on the association properties table 332 and the selection state table 334, and outputs the generated perspectives using the data output circuit or routine 350 to the output data portion 234 of the memory 230. The generated perspectives are then output by the controller 220 through the input/output interface 210 to the display device 250 for viewing by the user.

In response, the user, using the selection device 240, inputs data selection data and/or control function data over the link 242 and through the input/output interface 210. The display manager circuit or routine 320 alters the selection state data in the selection state table 334 based on the data selection data and/or the control function data input by the user using the selection device 240. The display manager circuit or routine 320 then updates one or more of the tree structure workflow control view 321, the single dimensional views 322, the multiscape view 324, the textual data view 326 and/or the multiple dimensional views 328 based on the updated selection state table 330. The display manager circuit or routine 320 next generates a new one, or updates an old one, of the various views and perspectives discussed herein. The display manager circuit or routine 320 then outputs the new or updated views or perspectives to the output data portion 234 using the output data circuit or routine 350. The controller 220 outputs the new or updated views or perspectives to the display device 250 through the input/output interface 210 and over the link 252.

It should be appreciated that the web site activity data visualization administration/client system 300 can be instead implemented using the systems and methods of U.S. Provisional Patent Application No. 60/206557, incorporated herein by reference in its entirety.

In operation, the web site activity data visualization administration/client system 300 begins upon launching a data visualization session. At this time, the web site activity data visualization administration/client system 300 initializes the internal states and/or flags of the association properties table 332 and the selection state table 334 and the display manager circuit or routine 320. In particular, as discussed herein, based on previously defined configuration data input using the administration module 130, as well as the predefined and user-created associations stored in the association properties table 332, the tree structure workflow control view 321 is initialized to define one or more predetermined tree structure classes, subclasses and/or entries or items. The data input circuit or routine 310 begins loading data by first determining the source of the conditioned data to be used. For example, the display manager circuit or routine 320 could prompt the user to identify the location or file name of the mined web site activity data. This could be a file stored in the conditioned input data portion 232, or data to be obtained from the conditioned data warehouse 160 and then stored in the input parsed web site activity data portion 232.

During operation, the display manager circuit or routine 320 is driven by user interface events and operations. These events and operations may occur in any order based on control functions input from the user. These events and operations may be interspersed with other events and operations that are non-essential to the main operation of the web site activity data visualization administration/client system 300 and thus are not discussed herein. Of course, should the user input a stop command or the like, the display manager circuit or routine 320 will deallocate any resources that it has allocated during operation. Then, the general purpose computer 200 will remove the web site activity log data visualization administration/client system 300 from the list of executing processes.

Should the user select an entry of the tree structure workflow control view 321 to display an associated set of perspectives, views, dimensions and measures, the display manager circuit or routine 320 will execute a tree structure entry selection routine. In particular, the display manager circuit or routine 320 will identify the particular perspectives, views, dimensions and measures associated by the association properties state table 332 with the tree entry or item selected by the user. The display manager circuit or routine 320 will update the various perspectives and views to display the particular perspectives, views, measure and dimensions that correspond to the selected tree structure entry or item, as well as associated any secondary dimensions and/or measures with various drop-down list boxes enabled in the various views and toolbars described below.

Should the user generate an input to change the particular measure being displayed or change the particular dimension to be used to weight the various views and perspectives, the display manager circuit or routine 320 will execute a change measure routine or a change color routine, respectively. This is discussed in greater detail below. In general, in this case, the display manager circuit or routine 320 will set a “weight-by” or “color-by” property for the various views and perspectives to the “weight-by” dimensions selected by the user. The display manager circuit or routine 320 will then update the various perspectives and views to reflect the change in the displayed information. Similarly, the display manager circuit or routine 320 will associate a range of color values with a range of data values for the selected dimension. Specifically, the display manager circuit or routine 320 will set the “color-by” property of the selection state table 334 to the selected dimension.

The selection state table 334 will then construct a new mapping between the data values for the selected dimension and a predetermined color range. Any changes within the selection state table 334 will be recognized by the display manager circuit or routine 320 for the various displayed views and perspectives. The display manager circuit or routine 320 will in turn update the various displayed views and/or perspectives.

The user may generate an input to change the particular multi-dimension view or the single dimensional views being displayed on the display device 250. In response, the display manager circuit or routine 320 will set an internal flag to indicate the perspective or view to be displayed or will update the selection state table 334 to reflect the change in the displayed single dimensional views and/or the displayed multi-dimension view. The flag is used to determine the perspective or view to be displayed when the display 250 needs to be subsequently updated. When the display 250 needs to be updated, the display manager circuit or routine 320 will then access the flag to determine the current state of the flag. Based on the state of the flag, the display manager circuit or routine 320 will output the appropriate data for the indicated perspective or view to the output data portion 234 for subsequent display on the display device 250.

Should the user generate an input to change the dimension displayed in one of the single dimensional views, the display manager circuit or routine 320 will update the selection state table 334 to change the dimension associated with each of the various views and perspectives. The selection state table 330 will then construct a new mapping between the data values for the new dimension and the predetermined color range. The changes within the selection state table 330 will be recognized by the display manager circuit or routine 320 to update the various displayed perspectives and views displayed on the display device 250.

Should the user generate an input indicating the selection state of some number of data items within the currently displayed views and/or perspectives is to be changed, the data controller circuit or routine 320 will execute a data selection change routine. It should be appreciated that the data selection routine executed by the display manager circuit or routine 320 will be, to some degree, specific to each particular view of each particular perspective. Moreover, the particular data items over which the user can make a selection will also be determined by the particular views and/or perspectives currently being displayed.

In response, the selection state table 334 will set the selection state of the particular measure and dimensions of the central data table field for the currently displayed views and perspectives to either selected or unselected based on the data value contained in a subset of user-selected items. Then, the selection state table 334 will indicate to the display manager circuit or routine 320 that the selection state of the selection state table fields in the selection state table 334 have changed.

In response, the display manager circuit or routine 320 will update the other views and perspectives displaying fields within this table by redrawing the view or perspective to reflect the change of the selection state. The display manager circuit or routine 320 will also response by updating the totals displayed on the currently displayed view. It should be appreciated that any type of selection operation, such as additions, subtractions, replace, intersect, union, select all, unselect all and toggle, as well as any other known or later developed selection operation, could be indicated by the input generated by the user.

Should the user generate an input indicating that one or more reports are to be generated, the input is forwarded by the data input circuit or routine 310 to the report manager circuit or routine 340 rather than to the display manager circuit or routine 320. The report manager circuit or routine 340 includes a link generator 342, a text generator 344 and an HTML report generator 346. The input generated by the user may indicated that a plurality of reports are to be generated. In this case, the link generator will generate a corresponding number of links to be embedded by the HTML report generator 346 into an interactive HTML report that allows the user to interactively switch between the plurality of reports within a single HTML report. Similarly, the text generator obtains and arranges textual data for each of the one or more reports to be generated. When the HTML report has a plurality of associated reports, the text for each report will be displayed when the data for that report is displayed. This text is obtained from the association properties table 332 by the text generator 344.

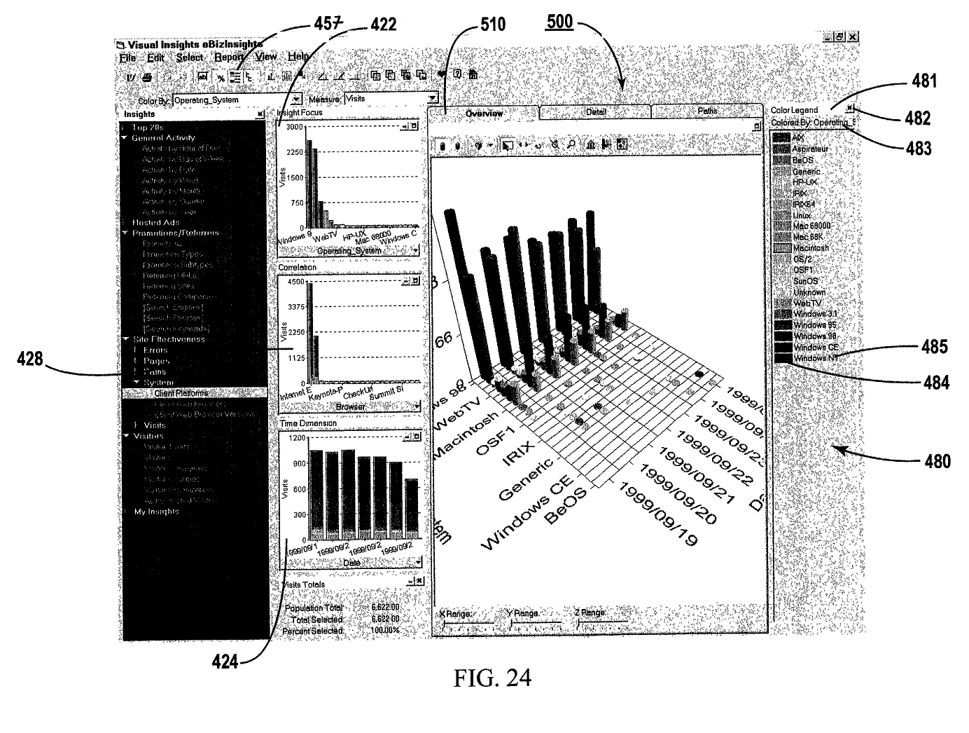

The HTML report generator 346 generates an HTML report document containing either a simple report or an advanced report for each indicated report based on an input from the user. In various exemplary embodiments of the HTML report generator 346, when the user generates an input for a simple report, the HTML report generator 346 accesses the single dimension views 322 to generate a bitmap shot of each of the one or more of the single dimension views and generates one or more legend views for each indicated report to be generated. In particular, the bitmap shot captures the current selection state and the current exclude from view state of the data displayed in each one or more single dimensional views. The HTML report generator 346 then inputs the links, if any, generated by the link generator 342 and the text for each generated report from the text generator 344 and builds an HTML document for the indicated reports. FIG. 24 shows one exemplary embodiment of a simple report, and will be discussed in greater detail below.

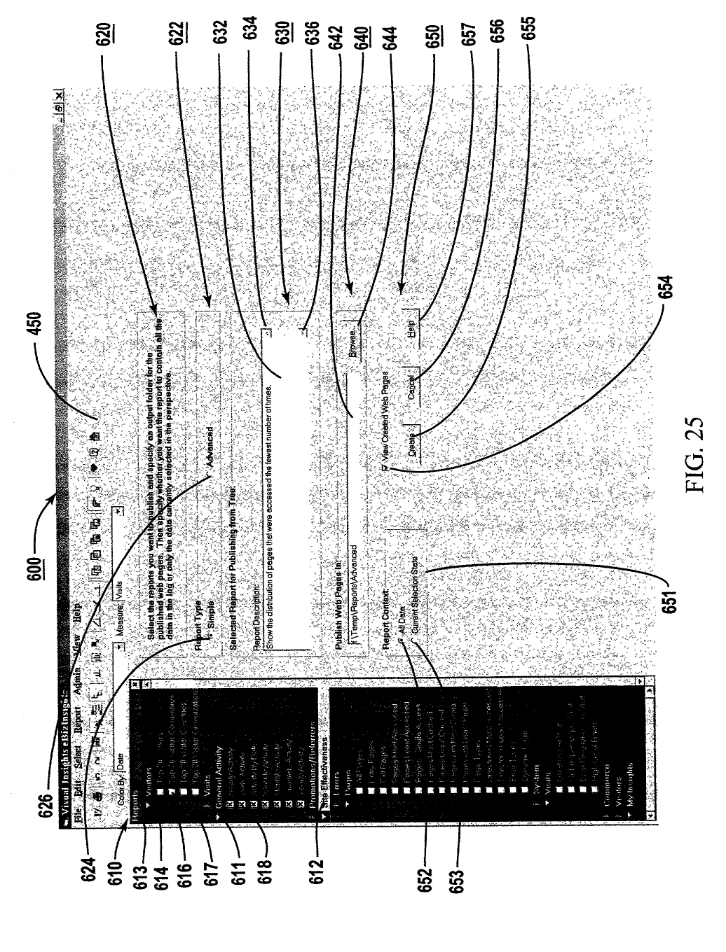

In various exemplary embodiments of the HTML report generator 346, when the user generates an input for an advanced report, the HTML report generator 346 accesses the single dimension views 322 to generate a bitmap shot of one or more of the single dimension views and generates one or more legend views for each indicated report to be generated. The HTML report generator 346 also accesses the multiscape view 324 to generate bitmap shot of the multiscape view. In particular, the bitmap shot captures the current selection state and the current exclude from view state of the data displayed in each one or more single dimensional views, and in the multiscape view. The HTML report generator 346 then inputs the links, if any, generated by the link generator 342 and the text for each generated report from the text generator 344 and builds an HTML document for the indicated reports. FIG. 25 shows one exemplary embodiment of an advanced report, and will be discussed in greater detail below.

Should the user generate an input indicating that a currently displayed subset of data is to be written back into a new multi-dimensional data structure or worksheet, such as a pivot table or an OLAP data cube, the display manager circuit or routine 320 outputs a form to the display 250 to allow the user to input a name for the data to be written and to identify the destination for the subset of the data to be written back. Once the user indicates the data is acceptable, the data output circuit or routine 240 will output, either to the output data portion 234 or to the HTML report document 122 or the worksheet file 124, the names specified by the user to allow that storage device to either select storage with that name or to create a new storage with that name. The data output circuit or routine 350 can retrieve a reference to this named data storage area, if necessary to facilitate transferring data into that named data storage area.

The data output circuit or routine 350 will then extract data from the selection state table 334 based on the subset of the data indicated by the user to transfer the data field name and data type to the data storage device. Then, the data output circuit or routine 350 outputs the actual data values based on the subset of data selected by the user and transfers the extracted data values to the storage device.

In particular, the web site activity log data visualization administrative/client system 300 has been optimized using the tree structure workflow control 321 in view of the finite numbers of dimensions and measures that are obtained upon parsing the web site activity log and mining the parsed web site activity log data. Accordingly, the scope of the information contained in a web site activity log should be appreciated.

In a web site activity log, for each “hit”, i.e., for each page request or image download, an entry, as illustrated in FIG. 41, is appended to the web site activity log. The World Wide Web consortium, W3C, has published a standard for log file formats that most vendors support. Table 1 shows some of the field definitions commonly used in web site activity logs.

TABLE 1
Fields and descriptions of log file information.

| | |
|---|---|
| Date | date on which the activity occurred |
| Time | time the activity occurred |
| ClientIP Address | IP address of the client that accessed your server |
| User Name | name of the user who accessed your server |
| Service Name | Internet service that was running on the client |
| | computer |
| Server Name | name of the server on which the log entry was |
| | generated |
| Server IP | IP address of the server on which the log entry |
| | was generated |
| Server Port | port number the client is connected to |
| Method | action the client was trying to perform (for |
| | example, a GET command) |
| URI Stem | resource accessed: for example, an HTML page, |
| | a CGI program, or a script |
| URI Query | query, if any, the client was trying to perform; |
| | that is, one or more search strings for which the |
| | client was seeking a match |
| Http Status | status of the action, in HTTP terms |
| Win32 Status | status of the action, in terms used by Windows |
| | NT |
| Bytes Sent | number of bytes sent by the server |
| Bytes Received | number of bytes received by the server |
| Time Taken | length of time the action took |
| Protocol Version | protocol (HTTP, FTP) version used by the |
| | client; for HTTP this will be either HTTP 1.0 or |
| | HTTP 1.1 |
| User Agent | browser used on the client |
| Cookie | content of the cookie sent or received, if any |
| Referrer | site on which the user clicked on a link that |
| | brought the user to this site |

The web site activity data visualization systems and methods according to this invention include a web site activity log miner. In various exemplary embodiments, the web site activity log miner is a W3C log file parser and parsed web site activity log data miner. In other exemplary embodiments, the web site activity log miner is capable of parsing the proprietary native log file formats for Apache and Netscape web log servers, as well as mining the resulting parsed web site activity log data.

At a logical level, the web site activity log miner scans the web site activity log and discards lines corresponding to images and other unimportant requests. This is done because, when requesting a web page, each image in the page automatically triggers a subsequent http request that is recorded in the log file. Next, the web site activity log miner identifies the session using the session number, which was embedded in the tracking information transmitted with the web page request that generated that entry. The web site activity log miner then updates the entry/exit times for the user associated with that session number. Various translations and table lookups are done before the web site activity log miner records the information in database tables of the conditioned data warehouse using stored procedures.

Conceptually, parsing and mining is easy. However, parsing and mining becomes practically difficult in a production environment. The largest production web servers generate tens of millions of hits per day. To cope with scale, multiple instances of the web site activity log miner may be run in parallel on different machines, each processing different logs or sections of a single log file.

Web farms include a large number of processors that function as a single web server. Web farms are more scalable, handle bursts of traffic, and more reliable since there are fewer single points of failure. Various load balancing and fail over strategies are used to distribute traffic across the web farm. Subsequent page requests, sessions, and even transactions may be split up and handled by different servers, each of which produces its own log file. Thus, in the web site activity data visualization systems and methods according to this invention, the web site activity log miner knits this information back together to assemble a coherent view of site activity.

Session tracking involves collapsing hits generated by a particular user into a related sequence of page requests generated by that user. However, hits generated by a single user are interspersed among those generated by all other users and may even be scattered across several different logs generated by the servers in the web farm. These must be pieced back together and assembled into a consistent pattern. In the web site activity data visualization systems and methods according to this invention, session tracking is performed by an ISAPI filter that runs as an add-on to Microsoft IIS web server, as discussed above.

For the first page request for every user session, the ISAPI filter inserts a cookie having a unique session identifier. As part of normal operations, this cookie and session number are propagated among future requests coming from this user, even if the requests are serviced by different machines in a farm.

Dynamically generated pages are fast becoming a standard among production web sites. For these sites, cgi-bin programs, Active Server Pages (ASPs), and other technology are used to dynamically create web pages as they are requested. The parsing/mining problem then becomes how to map these pages back into the business function that they represent. In the web site activity data visualization systems and methods according to this invention, this problem is resolved using a configurable translation tool that dynamically maps the generated pages into logical entities.

The web site activity log miner of the web site activity data visualization systems and methods according to this invention translates IP addresses, such as, for example, “63.80.116.251”, into the corresponding full domain name, such as, for example, “visfile1.visualinsights.com”, and extracting the top level domain name, which is, in this case, “visualinsights.com”. This is known as domain name mapping or a DNS lookup. This process may be slow depending on network loads, because each lookup accesses the network DNS server.

In the web site activity data visualization systems and methods according to this invention, the web site activity log miner collapses related uniform resource locations (URLs) into a single entity. This is known as URL translation.

In the web site activity data visualization systems and methods according to this invention, parallel processing and writing to the database leverages the sophisticated database servers that are now becoming available to increase the parsing and mining performance and eliminate database loading bottlenecks.

An efficient schema is important for fast database loads and accesses. In the web site activity data visualization systems and methods according to this invention, the conditioned data warehouse is organized as a star with two fact tables: Hits and Sessions. The Hits table contains one record for each page request with columns corresponding approximately to the fields in the web site activity log. The column entries are either variable values or indices into associated tables containing the unique values. In the web site activity data visualization systems and methods according to this invention, keys are used to minimize storage usage by avoiding having to store redundant variables. The Sessions table organizes data similarly with one record for every session.

The advantages to keeping data in a relational warehouse include, among other things, fast responses to new queries, drill-downs, or other operations; subsetting by date ranges to support date-based analysis and query by date ranges; support for richer analysis by having a fixed schema that known analysis algorithms can be applied against; having a platform for integrating enterprise data with click stream data; and scalability through OLAP, cubing, and other data reduction techniques, as described in E. F. Codd, “Extending the database relational model to capture more meaning,” Association for Computing Machinery, 1997, and Erik Thomsen, OLAP Solutions, John Wiley & Sons, Inc., New York, N.Y., 1997.

The web site activity data visualization systems and methods according to this invention provide a wide variety of reports. These reports are generated in HTML format and can be distributed throughout the enterprise, published on a web server, or embedded in presentations.

There are a number of classes of predefined reports, which can be divided into any number of groupings in the work flow control:

1 Activity reports show site activity by a selected time period. This time period can be hours, days, weeks, months, quarters, and/or years.

2. Visitors reports present visitor demographics. The demographics on the visitors can include the visitors' number of visits, country, domain, organization, browser, and the like.

3. Site effectiveness reports identify what pages and site resources are most heavily used. They also present error analyses showing errors by client, pages, server, and the like.

4. Promotional reports organize visitors by referring sites, companies, pages, search engines, and/or promotions.

The web site activity data visualization systems and methods according to this invention, unlike the first generation web log reporting tools, allows the user to then change the measure or one or more of the dimensions of the selected report to generate a custom report. The custom reports can then be saved by the user for later use. This is described in greater detail below.

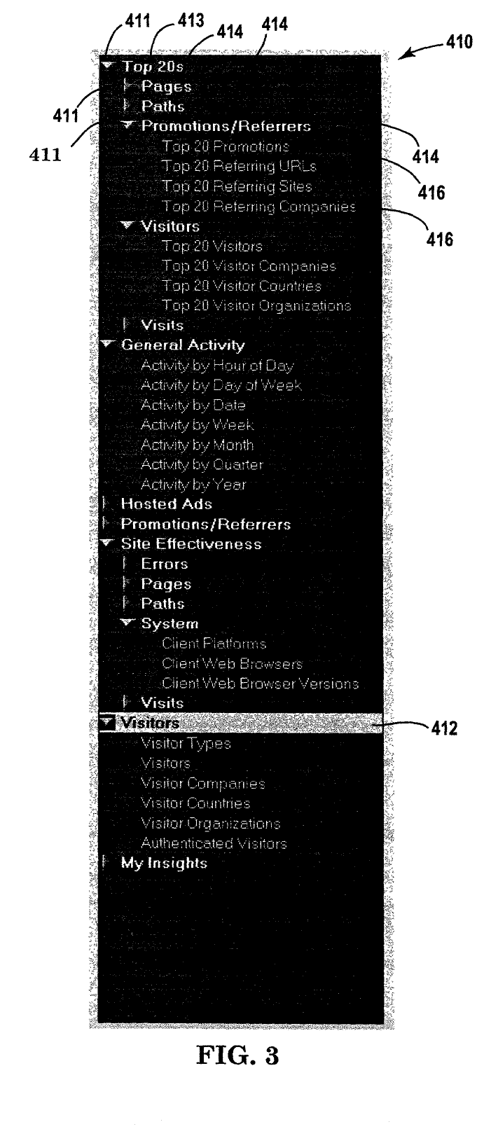

To overcome the inherent problems with report-based analysis present in the first generation web log reporting tools, the web site activity data visualization systems and methods according to this invention use, in place of these static reports, an interactive workspace, or perspective, for visual discovery, analysis, and correlation. As shown in at least FIGS. 3-7, there are three significant parts to the workspace or perspective: a workflow control portion, a dimensional view portion, and a multi-dimensional view portion. Other system components include a color legend, navigation controls, and selection control. Each of the workflow control portion, the dimensional view portion, and the multi-dimensional view portion includes one or more interactive data display and analysis tools.

In particular, in the various exemplary embodiments of the web site activity data visualization systems and methods according to this invention, the interactive data display and analysis tools displayed in the interactive workspace are organized into a number of different perspectives. A perspective is a set of linked, interactive visual components, or “views”, that are displayed together on the same graphical user interface screen. The linked, interactive views in a perspective work together to enable a particular type of visual analysis.

In various exemplary embodiments of the web site activity data visualization systems and methods according to this invention, such as those shown in FIGS. 3-7, the workflow control portion includes a tree-structured workflow control view. This tree-structured workflow control view contains selectable items or entries that identify predefined and user-defined sets of dimensions and measures of the data obtained by parsing the web site activity logs and mining the parsed web site activity log data. The tree-structured workflow control view organizes the predefined and user-defined sets of dimensions and measures into a number of distinct classes having selectable entries and/or icons.

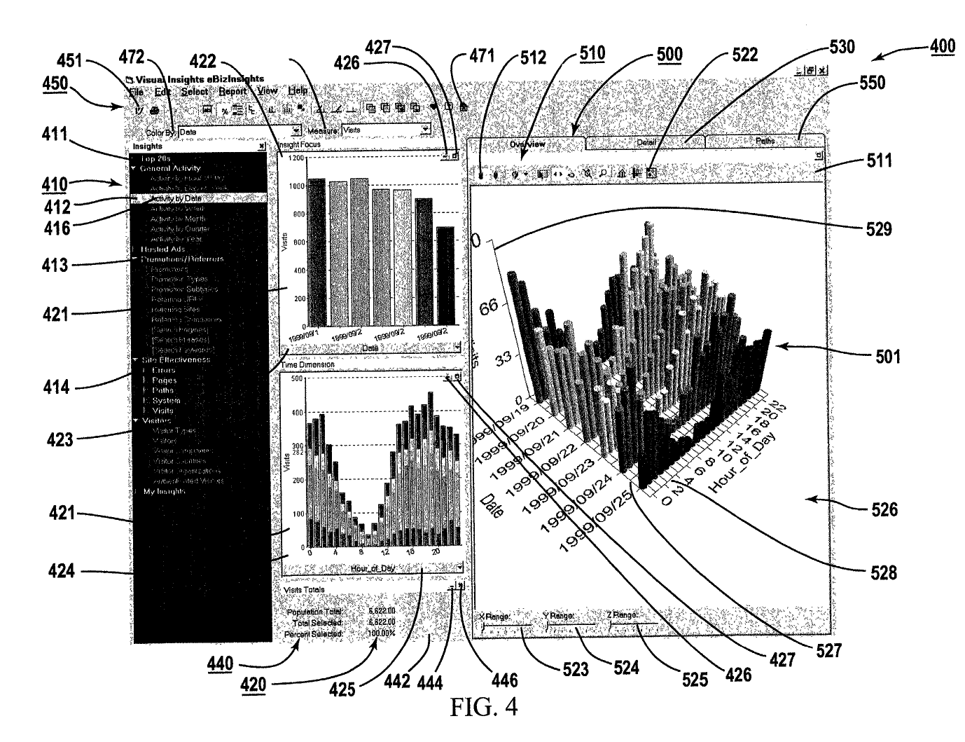

In various exemplary embodiments of the web site activity data visualization systems and methods according to this invention, the dimensional view portion includes one or more interactive single dimensional views. In the particular exemplary embodiments shown in FIGS. 4-7, the dimensional view portion includes one or more interactive bar charts. However, it should be appreciated that the dimensional view portion can include one or more of any other known or later developed interactive single dimensional view in place of, or in addition to, the one or more interactive bar charts.

In various exemplary embodiments of the web site activity data visualization systems and methods according to this invention, such as those shown in FIGS. 4-7, the multi-dimensional view portion includes one or more interactive multi-dimensional views. These interactive multi-dimensional views can include a single measure view, any of a number of different embodiments of a multiple measures view, which can include various desired combinations of dot strip views, bubble views, and/or parabox views, textual views, or the like. Various exemplary embodiments of the single measure and the various multiple measures views are described in detail in U.S. patent application No. 09/415,923, which is incorporated herein by reference in its entirety. Various exemplary embodiments of the textual views are described in detail in U.S. patent application No. 08/992,408, which is incorporated herein by reference in its entirety.

In various exemplary embodiments of the web site activity data visualization systems and methods according to this invention, the multi-dimensional view portion includes an analysis pane having a plurality of tabs, where one particular multi-dimensional view is associated with each tab for each particular set of dimensions and measures. In the particular multi-dimensional view portions shown in FIGS. 4-7, the analysis pane includes three tabs. In these particular exemplary embodiments, the tabs are labeled “Overview”, “Details”, and “Paths”, where, for each predefined or user-defined set of dimensions and measures, a single measures view is associated with the “Overview” tab, a textual view is associated with the “Details” tab, and one or more multiple measures view are associated with the “Paths” tab.

FIG. 3 shows one exemplary embodiment of a tree-structured workflow control portion 410. As indicated above, there are finite numbers of dimensions and measures that can be obtained when mining parsed web sit activity log data. Accordingly, the workflow control portion 410 includes a tree structure workflow control that organizes a large number of predetermined sets of dimensions and measures that are commonly used when analyzing web site activity. By providing these predetermined sets of dimensions and measures, and organizing these predetermined sets of dimensions and measures into a tree structure, the user can avoid the tedious job of determining which dimensions and which measures should be displayed and thus can immediately begin analyzing the web site activity data. At the same time, the user is provided with menu and other control widgets that allow the user to easily change the various dimensions and measures once any particular set of predetermined dimensions and measures are displayed and to save the altered sets of dimensions and measures into the tree structure workflow control.

As shown in FIG. 3, the tree structured workflow control is displayed in the workflow control portion 410. The tree structure workflow control divides the large number of predetermined sets of dimensions and measures into a number of class elements 413, including a “Top 20's” class, a “General Activity” class, a “Hosted Ads” class, a “Promotions/Refers” class, a “Site Effectiveness” class, a “Visitors” class and a “My Insights” class. Each of these classes 413 has associated with it a selection icon 411. When a particular selection icon 411 is first selected, the subclasses 414 and/or selectable tree entries or items 416 are displayed underneath the corresponding class tree entry 413. When that selection icon 411 is again selected, the subclasses 414 and/or selectable tree entries or items 416 are removed from the display of, i.e., no longer displayed as part of, the tree structured workflow control is displayed in the workflow control portion 410.

As shown in FIG. 3, in some of these class elements 413, the sets of dimensions and measures of the tree-structured workflow control are further grouped into subclasses and sub-subclasses, which also have selection icons 411. Selecting a selection icon 411 for a class element 413 causes the subclass elements 414 for any subclasses of that class, and any workflow control entry 416 (i.e., set of dimensions and measures) organized directly in that class, to be displayed. Selecting a subclass or sub-subclass element 414 also causes further subclass elements 416 for any subclasses of that subclass, and any workflow control entries 416 organized directly in that subclass, to be displayed.

As shown in FIG. 3, when a class element 413 is closed, such that for as the class “Hosted Ads”, the selectable icon 411 is in a first state. In the particular exemplary embodiment of the tree structured control view 410 shown in FIG. 3, the selectable icon is a right triangle having the right angle pointing at the class label when that class element 413 is closed. When the selectable icon 411 is selected to open the corresponding class element 413, the selectable icon 411 is changed to a second state so that the angle previously pointing at the class label 413 points down the tree structure. In the particular exemplary embodiment of the tree structure workflow control view 410 shown in FIG. 3, the triangle icon is rotated 90° to point down when the corresponding class element 413 is opened.

As shown in FIG. 3, each of the subclass elements 414 under a particular opened class element 413 also include instances of the selectable icon 411. As with the class elements 413, when the subclass elements 414 are closed, the selectable icon 411 is in the first, or closed, state. Then, when one of the subclass elements 414 is opened, as shown in FIG. 3, the selectable icon 411 for that subclass element 414 is altered to the second, or open, state. Additionally, as shown in FIG. 3, the tree structured workflow control view 410 uses an indentation scheme to make the subclass and the workflow control entries 416 distinguishable from the class and subclass elements 413 and 414, respectively. Additionally, as shown in FIG. 3, the workflow control entries 416, corresponding to particular predetermined sets of dimensions and measures, are shown in a different font and/or a different color than the class and subclass elements 413 and 414.

The workflow control view 410 also includes a selection bar 412 that highlights a particular selected class element 413, subclass element 414 or workflow control entry 416.

Selecting a workflow control entry 416 causes the particular interactive single dimensional views and the various multidimensional views associated with the selected set of dimensions and measures corresponding to that selected workflow control entry 416 in the tree structure workflow control view 410 to be automatically populated with the corresponding data from the conditioned data warehouse 160. At the same time, the elements of the interactive work space or perspective associated with data of the selected set of dimensions and measures and are displayed to the user.

Specifically, the populated associated interactive single dimensional views are displayed in a dimensional view portion, while the predetermined one of the various populated associated multidimensional views is displayed in the multidimensional view portion. As outlined above, selecting, or more colloquially, “clicking”, on any workflow control entry in the tree-structured workflow control view 410 automatically populates the bar chart and sets the analysis pane to the most useful data and display for that particular set of dimensions and measures.

In the initial configuration of the tree-structured workflow control view 410, the tree-structured workflow control view 410 organizes the predefined and user-defined sets of dimensions and measures into seven high level classes. The “Top 20s” class includes predefined sets of dimensions and measures designed to provide a quick view of the top page, path, promotion, visitor and visits statistics. The “General Activity” class includes predefined sets of dimensions and measures designed to display data on site activity by time, either by hours, days, weeks or years. A “Hosted Ads” class includes predefined sets of dimensions and measures designed to display data on click-through rates and other advertising effectiveness attributes for web sites displaying banner ads. The “Promotions” class includes predefined sets of dimensions and measures designed to display data on which web sites, URLs, search engines and the like are most effective at driving traffic to the web site being analyzed. The “Site Effectiveness” class includes predefined sets of dimensions and measures designed to display data on site-oriented statistics, such as errors, paths through the web site, entry and exit pages, page stickiness, and the like.

The “Visitors” class includes predefined sets of dimensions and measures designed to display data on e-commerce site visitors. In general, the various visitors to a particular e-business web site are classified into separate groups based on how the user interacted with the web site. These “Visitor” sets of dimensions and measures can then be used to support visitor analysis based on the visitors' organization, country, Internet service provider, originating top-level domain type and the like.

The particular names for each group and the particular criteria for signing each visitor to one of the defined groups can be entered and set through a configuration option in one or more corresponding configurations screens. In particular, in one exemplary embodiment, these configuration options and screens are accessible through the administration module 130, but are not available through the client module 150.

In the specific exemplary embodiments shown in at least FIGS. 4-7, the visitors to the particular web site being analyzed have been grouped into “browsers”, “abandoners”, and “buyers”. These groups are used, because, for an e-business retailer, it is often most important to know which visitors merely browse the web site, which users selected for purchase at least one item offered by the e-business retailer, and which visitors actually bought at least one item. It should be appreciated, that, for other types of e-businesses or for any other reason, different types of visitor groupings can be used.

FIG. 4 shows one exemplary embodiment of a data visualization graphical user interface 400 generated by and usable with the web site activity data visualization systems and methods according to this invention. As shown in FIG. 4, the data visualization graphical user interface 400 includes the workflow control portion 410, a single dimension view portion 420 and a multi-dimension view portion 500. The data visualization graphical user interface 400 also includes a first navigation toolbar 450. The navigation and control toolbar 450 includes navigation or control widgets 451-479. The navigation and control toolbar 450 is discussed in greater detail below with respect to FIG. 9. As shown in the FIG. 3, the workflow control view portion 410 includes a tree structure workflow control comprising a number of the class elements 413, the subclass elements 414, the workflow control entries 416, the selection icons 411 and the selection bar 412. Accordingly, the workflow control portion 410 will not be further discussed.

In the data visualization graphical user interface 400 shown in FIG. 4, the “activity by date” workflow control entry 416 has been selected using the selection bar 412. In the particular exemplary embodiments of the web site activity data visualization systems and methods according to this invention, the “activity by date” workflow control entry 416 is associated with the dimensions “date” and “hour of day” and the measure “visits”. In particular, the date dimension is the primary, or “focus”, dimension, while the hour of day dimension is a secondary, or “time”, dimension. Additionally, the single measure view or “multiscape” view 510, is indicated as the primary multi-dimension view for the multi-dimensional perspective shown in the multi-dimension portion 500.

The web site activity data visualization systems and methods according to this invention, when mining the parsed web site activity log data, provide several different analysis measures that can be used with the various dimensions. In the web site activity data visualization systems and methods according to this invention, the measure can be selected using a measures selection box. In various exemplary embodiments of the web site activity data visualization systems and methods according to this invention, the measures selection box is located at the top of the workspace or perspective graphical user interface.

The most commonly used measure when analyzing web site activity logs for e-business web sites is “visits”. Visits generally refers to the number of unique site visitors. “Visits” are useful for understanding site activity from an advertising or promotional point of view. However, other measures implemented in various exemplary embodiments of the web site activity data visualization systems and methods according to this invention include “hits”, “bytes_transferred”, and “hits with errors”. “Hits” and “bytes_transferred” are useful for understanding raw site activity, because these measures correlate to machine performance. It should be appreciated that any other known or later developed measure that can be obtained by mining parsed web site activity log data, either in its current forms or in later developed forms, can be used with the web site activity data visualization systems and methods according to this invention.

In the specific exemplary embodiments of the web site activity data visualization systems and methods according to this invention shown in at least FIGS. 4-7, the single dimension view portion 420 contains at least two dimensional views 422 and 424. In particular, these single dimensional views 422 and 424 in the specific exemplary embodiments are displayed using bar charts. While the following discussion is directed to the particular single dimensional views 422, 424 and 428 shown in at least FIGS. 4-7, it should be appreciated that the dimensional view portion 420 of the web site activity data visualization systems and methods according to this invention is not limited to these particular single dimensional views. Rather, any number of single dimensional views, of any type, can be displayed in the dimensional view portion 420, as discussed in the incorporated 923 application.

In the specific exemplary embodiments of the web site activity data visualization systems and methods according to this invention shown in at least FIGS. 4-7, the primary dimension associated with one of the selectable workflow control entries 416 is referred to as the “focus” dimension. In particular, in the particular exemplary embodiments shown in at least FIGS. 4-7, the “focus” dimension is displayed in the top-most single dimensional view 422 of the various single dimensional views 422 et al. displayed in the single dimension view portion 420 of the data visualization graphical user interface 400. Moreover, as shown in the “color by” portion 474 of the navigation toolbar 450, the various views are initially colored based on the “focus” dimension. The primary dimension is called the “focus” dimension because the primary dimension is assumed to be the dimension of the parsed web site activity log that the user wishes to focus the current analysis on.

The secondary dimension associated with the selected activity icon is almost always a time dimension, as web site activity logs are usually analyzed to determine how activity on the web site has changed over time. Accordingly, the secondary, or “time”, dimension is plotted in the bottom-most single dimensional view 424 of the dimensional view portion 420. However, it should be appreciated that the secondary dimension is not limited to only time dimensions.

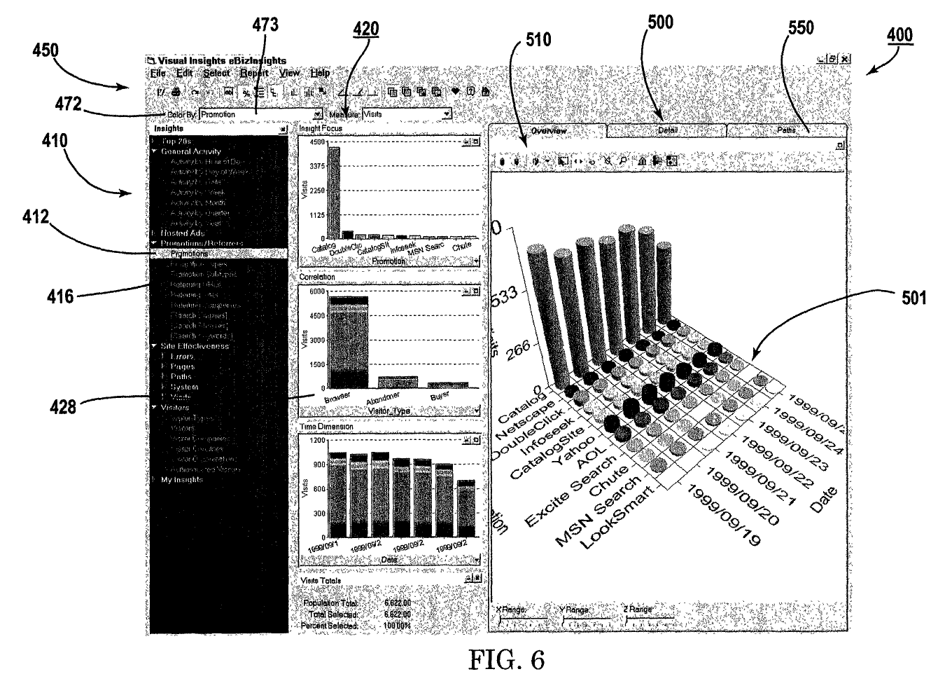

If a third or a fourth single dimensional view is to displayed as well, such as in the exemplary embodiment shown in FIG. 6, these additional dimensions are displayed between the top-most “focus” dimension and the bottom-most “time” dimension.

As shown in FIG. 4, each of the single dimensional views 422 and 424 are displayed using bar charts. However, it should be appreciated, as outlined above, that any known or later developed method or technique for graphing a single dimension against a single measure can be used in place of the bar charts shown in FIG. 4.

In each of the single dimensional views 422 and 424 shown in FIG. 4, the bar chart is plotted in a plot portion 421, where the range of the dimension is plotted along the x-axis and the selected measure is plotted along the y-axis. Each of the single dimensional views 422 and 424 includes a drop-down list box 423 and 425, respectively, as well as a minimize button 426 and a maximum button 427. Selecting either the drop-down list box 423 or the drop-down list box 425 allows the user to change the primary and secondary dimensions, respectively. Each of the title bars 423 and 425 display the name of the currently displayed dimension in that single dimensional view. The drop-down list box will include a predetermined list of other dimensions that can be displayed in place of the currently-displayed dimension for the currently-selected measure.

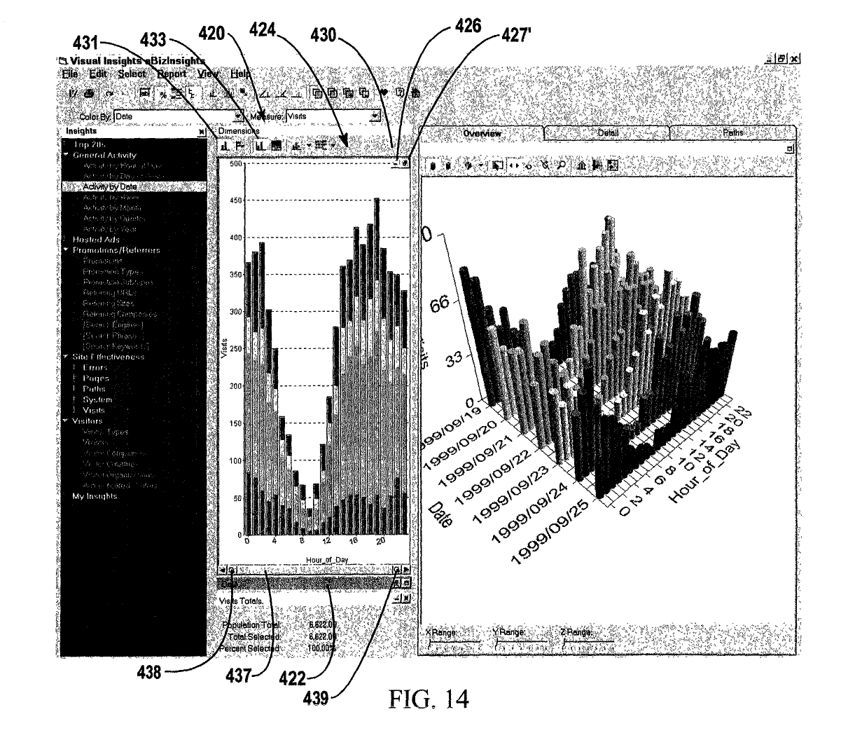

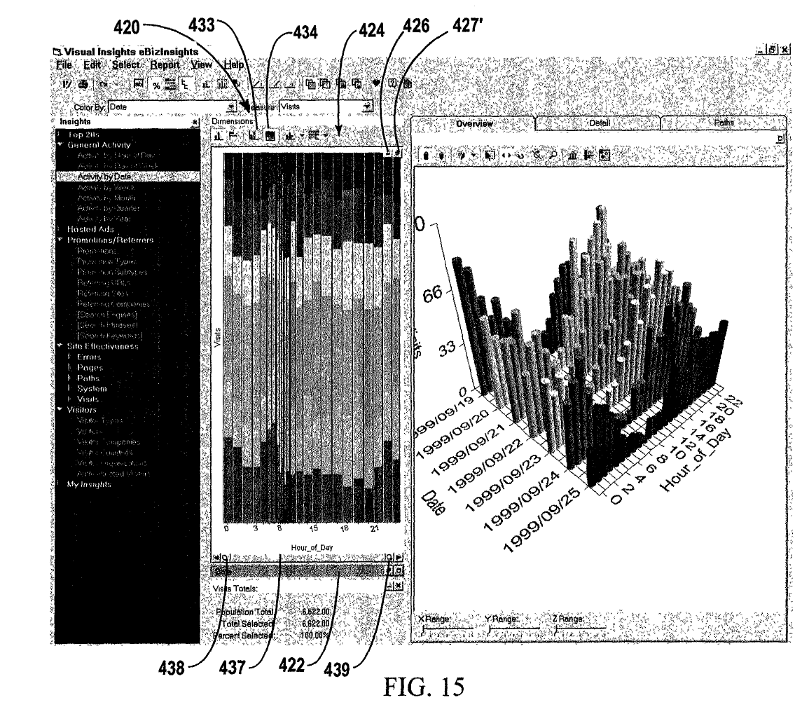

Selecting the minimize button 426 of either single dimensional view 422 or 424 minimizes that single dimensional view 422 or 424 to a single line, as shown in FIGS. 14 and 15. Additionally, if there is only one other minimized single dimensional view, that remaining single dimensional view is automatically maximized, as shown in FIGS. 14 and 15. In contrast, selecting the maximize button 427 of any of the displayed single dimensional views 422 or 424 causes that corresponding single dimensional view to be maximized, and all of the other single dimensional views to be minimized as described above.

The dimensional view portion 420 also includes a total portion 440. The total 440 portion displays the total value for the selected measure, the total value for any selected portion of the displayed data and the percentage the selected portion represents of the total value for the selected measure. This is displayed in the totals values portion 442. The totals portion 440 also includes a minimize button 444 and a close button 446. Selecting the minimize button 444 minimize the totals portion 440 to a single line. Selecting the closed button 446 removes the totals portion from the dimensional view portion 420.

The single dimensional views 422, 424 and 428 both show results and serve as an input environment for user selections, as discussed in greater detail below and in the incorporated 923 application. The single dimensional views are richly parameterized and can be oriented, zoomed and labeled and sorted as discussed below with respect to FIGS. 9, 14 and 15.

The single dimensional views all function similarly. Initially, the user selects one of the items or entries in the tree-structured workflow control view. As outlined above, each item or entry in the tree-structured workflow control view has at least two dimensions and at least one measure associated with it. Thus, selecting an item or entry in the tree-structured workflow control view automatically sets which single dimensional views will be displayed in the dimensional view portion, which dimensions will be displayed in the displayed single dimensional views, and which measure the displayed dimensions will be graphed against.

As shown in FIG. 4, the multi-dimensional view portion 500 includes a single measure, or multiscape, view portion 510, a textual view portion 530 and a multiple dimensional view portion 550. In particular, FIG. 4 shows one exemplary embodiment of a tree-structured, single measure multi-dimensional perspective according to this invention. As shown in FIG. 4, the single measure, or multiscape, view 510 of the multi-dimensional view portion 500 shows correlations between the primary, or “focus”, single dimensional view 422 and the secondary, or “time”, single dimensional view 424 using a three-dimensional multiscape element 501 as the single measure view element. The three-dimensional multiscape element 501 is described in greater detail below and in the incorporated 923 application.

In the particular exemplary embodiments of the multi-dimensional view portion 500 shown in FIG. 4, the single measure view 510 is associated with a tab labeled “Overview”. However, it should be appreciated that this is arbitrary, and the single measure view 510 can be accessed using any appropriate known or later developed graphical user interface widget, toolbar item, and/or menu item. Additionally, it should be appreciated that the single measure view 510 can use any known or later developed multi-dimensional landscape element, and thus is not limited to displaying only the three-dimensional multiscape 501 element or only two dimensions and one measure. In particular, the incorporated 923 application discusses in detail how to enable, manage and display three or more dimensions using the three-dimensional multiscape element 501.

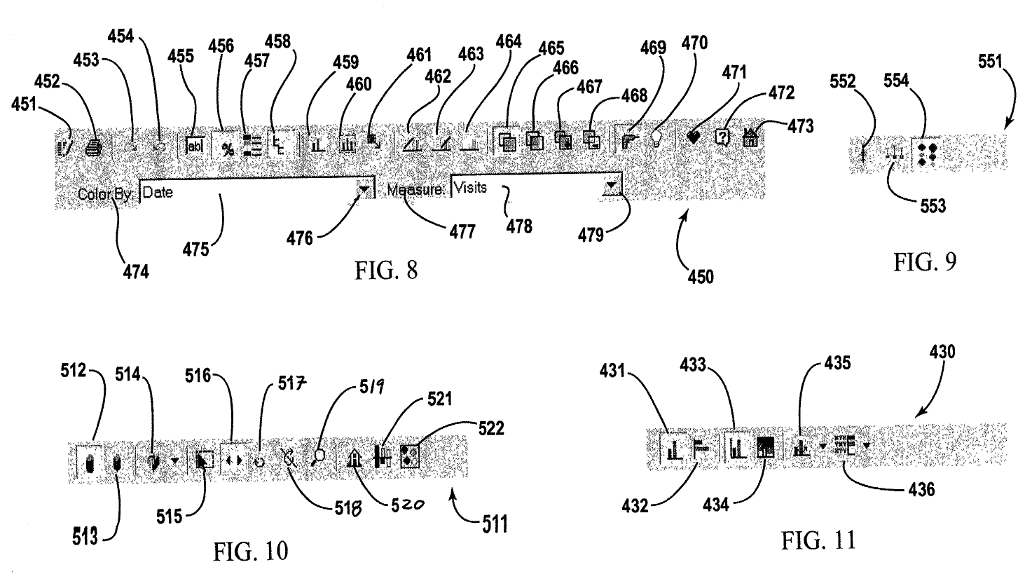

The particular exemplary embodiment of the single measure view 510 shown in FIG. 4 includes a single measure toolbar 511 comprising buttons 512-522, a number of range sliders 523-525 and window 526. The single measure toolbar 511 is discussed in greater detail below with respect to FIG. 8, which shows one exemplary embodiment of the single measure toolbar 511 particularly usable with the three-dimensional multiscape element 501 shown in FIG. 4. The single measure toolbar 511 provides navigation controls for zooming, rotating and symbol choice and includes several fixed but useful viewpoints.

In the particular exemplary embodiments shown in at least FIGS. 4 and 6, the multiscape element 501 plots the primary, or “focus”, dimension along the x-axis 527, the secondary, or “time”, dimension along the y-axis 528 and the measure along the z-axis 529. The x, y and z sliders 523-525, respectively, can be used to change the scale of the x, y and z axes. The three-dimensional multiscape element 501 used in the exemplary embodiments of the single measure view shown in FIGS. 4 and 6 provides a broad overview of the information and is particularly powerful for showing time-oriented data. Clicking on a viewpoint control of the toolbar 511 causes the three-dimensional multiscape element 501 to animate smoothly to the new position. The smooth animation is used to help the user maintain context.

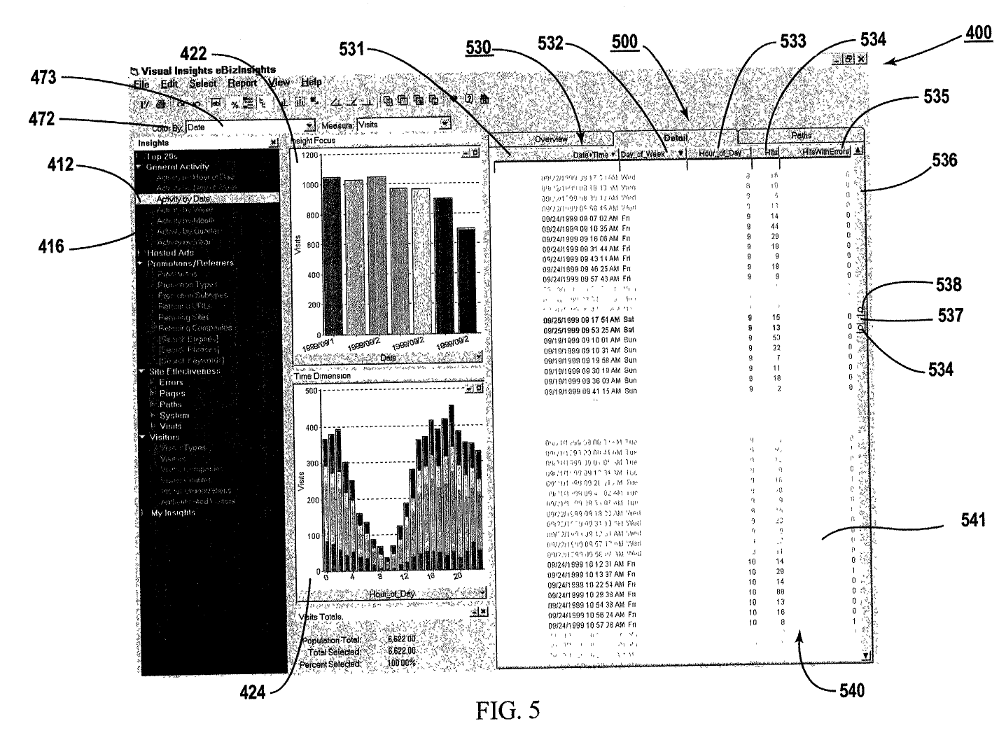

FIG. 5 shows one exemplary embodiment of a tree-structured textual data perspective according to this invention. As shown in FIG. 5, the textual data view 530 of the multi-dimensional view portion 500 allows the user to interactively view textual data obtained from mining the parsed web sit activity log data. Various exemplary embodiments of the textual data view 530 is described in great detail in the incorporated 408 application. In the particular exemplary embodiment of the textual view 530 shown in FIG. 5, the textual data view 530 is associated with a tab labeled “Details”. However, it should be appreciated that this is arbitrary, and the textual data view 530 can be accessed using any appropriate known or developed graphical user interface, widget, toolbar item, and/or menu item.

In the particular exemplary embodiments of the web site activity data visualization systems and methods according to this invention discussed herein, the textual data view 530 is also called the “Data Sheet” view. However, it should be appreciated that the textual data view 530 can use any known or later developed structure or metaphor for displaying textual data. It should also be appreciated that the textual data view 530 uses both standard and novel windowing techniques to allow the entire data set to be scrolled and viewed, so that if any desired portion of the data set can be viewed in the window 540.

As shown in FIG. 5, the textual data view 530 of the multi-dimensional view portion 500 displays a predetermined set of dimensions arranged in columns, with each row corresponding to one measure element, such as one visit. Additionally, the textual data view 530 includes a selectable title bar for each column, such as the title bars 531-535. The textual data view 530 also includes a scroll bar 536 having a scroll bar element 537 having selectable elements 538 and 539. As in all scroll bars, the position of the scroll bar element 537 corresponds to the portion 541 of the data that is viewable through the window 540.

Each row of the textual data displayed in the textual data view 530 is color-coded according to the dimension displayed in the selection box 475 of the Color By portion 474 of the toolbar 450. While the dimensions displayed in the textual data view 530 will include the dimensions displayed in the single dimension views 422, 424 and 428 displayed in the dimension view portion 420 and in the single measure view portion 510, in most cases, the textual data view 530 will also include additional predetermined dimensions associated with the selected workflow control entry 416.

Additionally, each dimension in the textual data view 530 is sortable, selectable and searchable. In particular, as shown in FIG. 5, each of the title bars 531-535 can be selected to make that dimension the primary sort value. If another dimension is selected, that next dimension becomes the primary sort value, while the previously selected dimension becomes the secondary sort value. If yet another dimension is selected, the last selected dimension becomes the primary sort value, the immediately preceding selected dimension becomes the secondary sort value, while the third dimension becomes the tertiary sort value, and so on. This is represented by the color and shape of the sort icons displayed in the title bar portions 531 et al. of the textual data view 530.

In particular, the exemplary embodiment shown in FIG. 5, the title bar 533, corresponding to the “hour of the day” dimension, has been selected as is the primary sort value. This is represented by the white triangle sort icon in the title bar 533. The dimension associated with the title bar 532, the “day of week” dimension, is the secondary sort value. This is represented by the solid large triangle sort icon in the title bar 532. The dimension associated with the title bar 531, the “date+time” dimension, is the tertiary sort value. This is represented by the small solid colored triangle sort icon in the title bar 531.

The sort icons displayed in the title bar portions 531 et al. also indicate how the sort is being performed. A downward pointing icon indicates the sort is performed with the value increasing as the row number increases. An upward pointing icon indicates that the sort value decreases as the row number increases. For dimensions having only numerical values, such as the “hour of day” dimension associated with the column title bar 533, the values can only be sorted according to numerically ascending or descending values. For dimensions having only alphabetical values, such as the “day of week” dimension associated with the column title bar 532, the dimensions can only be sorted in alphabetical or reverse alphabetical order. For dimensions having both numerical and alphabetical values, the dimension can be sorted using a numerically ascending sort, a numerically descending sort, an alphabetical sort or reverse alphabetical sort.

Additionally, for the primary dimension associated with the primary or “focus” single dimensional view 422, that dimension can also be sorted based on the sort order that is currently being used in that single dimensional view. This is represented by a bar chart icon rather than an upwardly or downwardly pointing triangle icon.

In the exemplary embodiment shown in FIG. 5, the textual data view 530 has been sorted first on the hour of the day, then on the day of the week, then on the day and time. In particular, the specific portion 541 of the textual data shown in the textual data view 530 corresponds to the hour of the day having the lowest number of visits. Thus, the window 540 shows the portion 541 of the textual data extending from the end of the 8AM values to the beginning of the 10AM values.

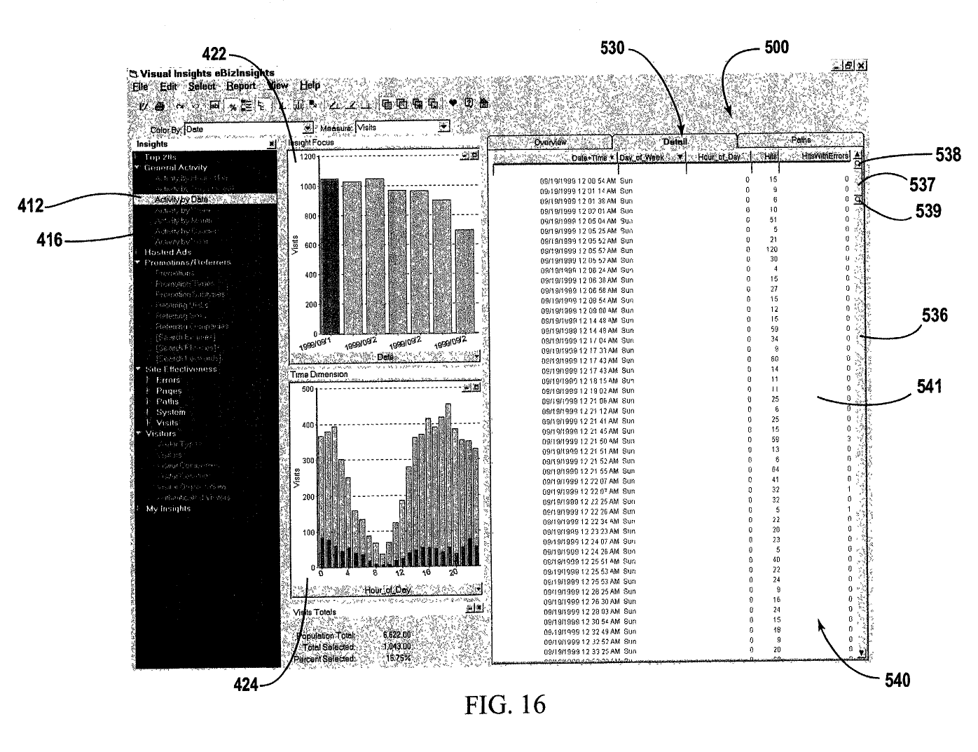

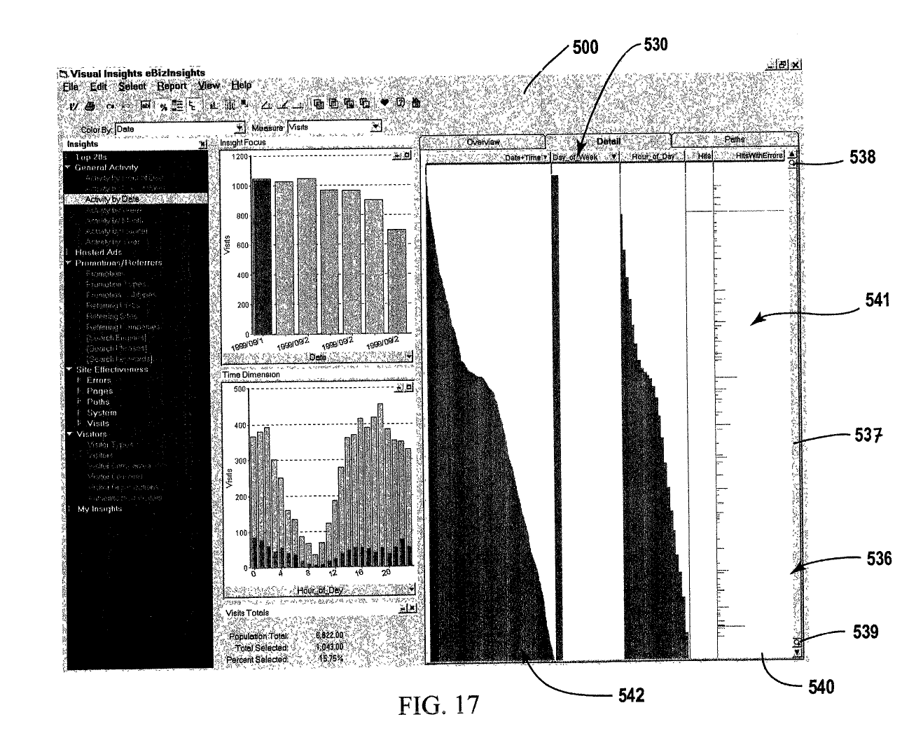

The portion 541 of the textual data displayed in the window 540 is controlled using standard windowing techniques, by moving the scroll bar element 537 within the scroll bar 536. The scroll bar element 537 can also be used to change the proportion of the textual data 541 displayed in the window 540. This will be discussed in greater detail below with respect to FIGS. 16-21.

FIG. 6 shows a second exemplary embodiment of the tree-structured, single measure, multi-dimensional perspective according to this invention. In particular, in the exemplary embodiment of the tree-structured workflow control shown in FIG. 4, the selected workflow control entry 416, “activity by date”, does not enable the multi-dimensional view portion 550. In contrast, the workflow control entry 416 selected in the exemplary embodiment shown in FIG. 6, “promotions”, enables the multi-dimension view portion 550. Additionally, the “promotion” workflow control entry 416 also has a third single dimension associated with the single dimension view portion 420.

In particular, the exemplary embodiment of the web site activity data visualization system and methods according to the invention includes, for some of the workflow control entries 416, a third, or “Correlation”, single dimensional view that is used to display the correlation between the primary, or “focus”, dimension and the different classifications that currently selected measure may have been grouped into, as discussed above.

Thus, for the promotions workflow control entry 416 of the tree structure shown in the tree-structured workflow control view 410, the third, or “Correlation”, dimensional view 428 displays the visitor-type dimension against the visits measure.

Additionally, by changing the selected entry from “activity by date” to “promotions”, the color-by value indicated in the selection box 473 of the color-by portion 472 has been changed to “promotion” from “data”. Similarly, the primary, or “focus”, dimension graphs the type of promotion versus the number of visits each promotion type generated, while the secondary, or “time”, dimension shows the number of visits that occurred each calendar date. Finally, the single measure view 510 shows the three-dimensional plot of the promotion against the date and the number of visits.

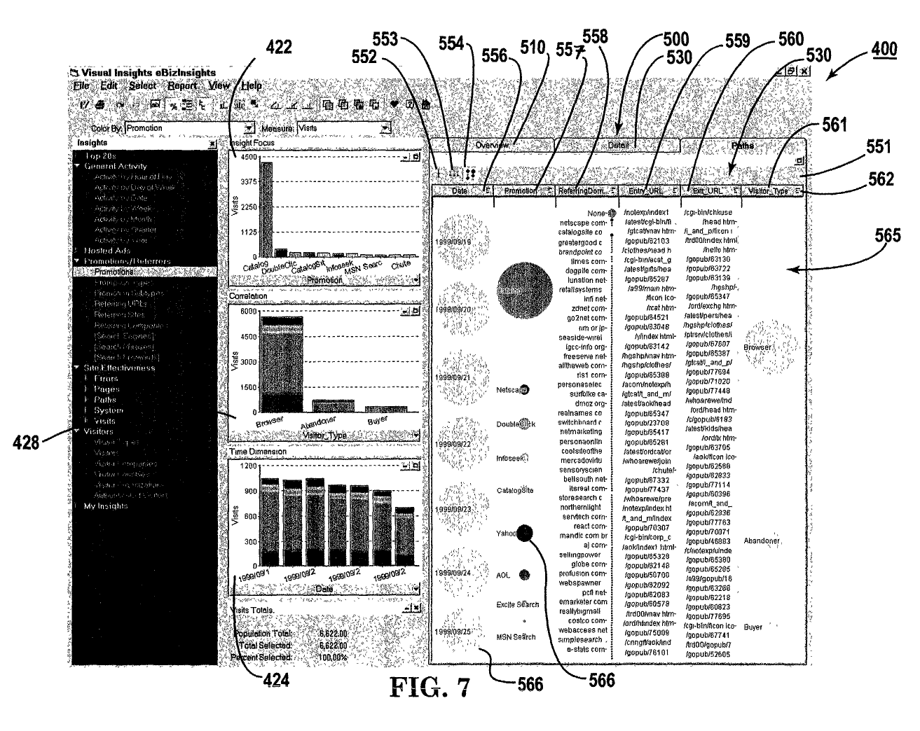

FIG. 7 shows one exemplary embodiment of the tree-structured multiple dimension perspective according to the invention. In particular, in FIG. 7, the various types of multiple dimension views displayable in the multiple dimensional view portion 550 allow the user to perform a path analysis on the parsed web site activity log. Path analysis is a technique for understanding how customers navigate through a web site, for identifying trouble spots within the web site, and for what optimizing web site logical layout. The various multi-dimension views that can be combined in the multiple dimension perspective shown in FIG. 7 support path analysis by showing flow among pages.

In the particular exemplary embodiment shown in FIG. 7, the various multiple dimension views displayable in the multi-dimension view portion 550 are associated with the tab labeled “Path”. However, it should be appreciated that this is arbitrary, and the various multiple dimension views of the multiple dimension view 550 can be accessed using an appropriate known or later developed graphical user interface widget, tool bar item, and/or menu item. As shown in FIG. 7, a first one of the various combinations of multiple dimension views displayable in the multiple dimension view 550 uses a bubble plot view to represent the various displayed dimensions. In particular, in this exemplary embodiment of the multiple dimension view 550, the various dimensions are represented in columns, while the rows corresponding to the different values within the range of each dimension. The measure value for each element of a particular dimension is represented by the size of the bubble for that element and dimension.

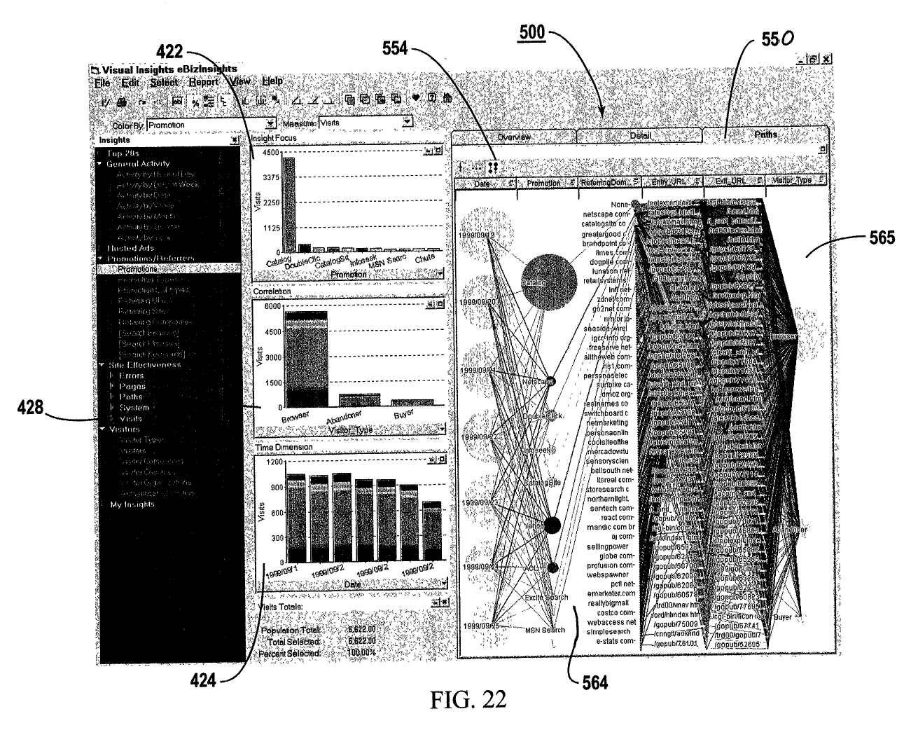

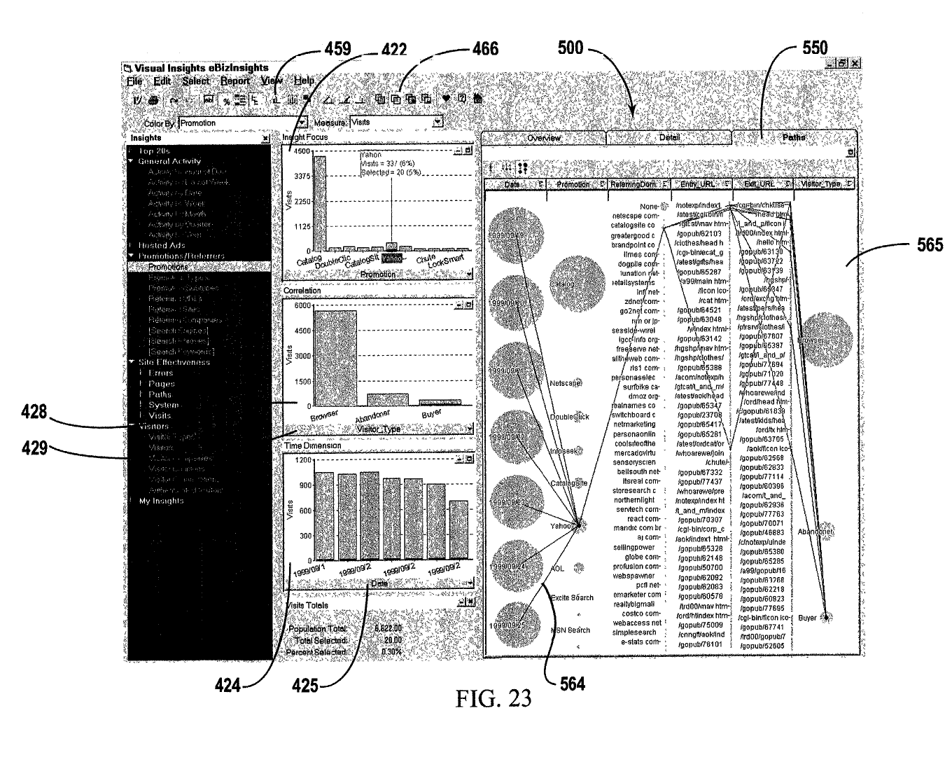

In the specific exemplary embodiment shown in FIG. 7, the multiple dimensions include “date”, “promotion”, “referring dom(ain)”, “entry URL”, “exit URL”, and “visitor type”. Within each of these columns, the bubbles are sized to encode the number of visits with each attribute. Thus, the bubbles in the “date” dimension are all about the same size, indicating that the visit traffic was steady for the displayed time period. As discussed in greater detail below with respect to FIGS. 22 and 23, parallel axis lines can be drawn between the bubbles shown in various columns to link combinations of dimensions by visits.

In particular, as shown in FIG. 7, the multi-dimension view 550 includes a view selection toolbar 551. FIG. 11 shows the view selection toolbar 551 in greater detail. The multiple dimensions selection toolbar 551 includes a dot strips view selection button 552, a box plot view selection button 553 and a bubble plot view selection button 554. In the exemplary embodiment shown in FIG. 7, the bubble plot view selection button 554 has been selected to display the bubble plot view 565.

Like the textual data view 530, in each of the various views of the multiple dimensions view 550, each dimension has a column title bar 556-561 arranged in a title portion 555 of the multiple dimension view 550. Like the column title bars 535 et al. shown in FIG. 5, the column title bars 556 et al. can also be used to sort and resort the columns based on ascending or descending numerical or alphabetical order or based on the original sort order of the corresponding dimension. The original sort order state is represented by the bar chart icon 562 displayed in each of the column title bars 556 et al.

In particular, in FIG. 7, the date dimension is sorted in ascending order. Thus, the earliest date is at the top, while the latest date is at the bottom. Each of the bubbles 566 of the date dimension are roughly the same size. However, the bubble 566 for the last date is smaller than the others, corresponding to the bar chart bar for the date dimension of the single dimensional view 424 for the last date being smaller than all of the others. Similarly, the promotion dimension is sorted in the original order of the promotion dimension for the single dimension view 422 of the dimension view portion 420. However, the single dimension view 422 has itself been reordered in numerically descending order. Thus, while the bar corresponding to Yahoo is the second bar from the left in the single dimension view 422, the bubble 566 corresponding to Yahoo is not the second bubble from the top.

When the user selects the dot strips view selection button 552, any numeric dimensions, such as a combined “Date+Time” dimension, that was previously shown using the bubble plot view or the box plot view is altered to show the measure values using a conventional dot strip. Similarly, when the user selects the box plot view selection button 553, any numeric dimensions, such as a combined “Date+Time” dimension, that was previously shown using the bubble plot view or the dot strips view is altered to show the measure values using a conventional box plot view. The incorporated 923 application illustrates various exemplary embodiments of the conventional box plot view.

FIG. 8 shows one exemplary embodiment of the navigation and control bar 450 in greater detail. As shown in FIG. 8, the navigation and control bar 450 includes a write-back function selection button 451, a print button 452, a undo selection button 453, a redo selection button 454, a write query function selection button 455, a display totals table toggle button 456, a display color legend view toggle button 457, a display workflow control view toggle button 458, a select all items function button 459, a unselect all items function button 460, a toggle selected items function button 461, an exclude unselected items function button 462, an exclude selected items function button 463 a restore excluded items function button 464, a replace selected items function button 465, an intersect selected items function button 466, an add selected items function button 467, a subtract selected items function button 468, a drill down function button 469, an add new tree entry function button 470, a preferences menu access button 471, a help menu access button 472 and a home function selection button 473. The navigation and control toolbar 450 also includes a Color-By portion 474 that includes a display box 475 that displays the currently selected dimension used to color the various views and a list box access button 476 that displays a list box of available dimensions for selection. The navigation and control toolbar 450 also includes a Measure portion 477 that includes a display box 478 that displays the currently selected measure and a list box access button 479 that displays a list box that includes all the currently selectable measures.

FIG. 8 shows just one exemplary embodiment of the navigation and control bar 450. It should be appreciated that any combination of the buttons and other toolbar controls or widges described below can be used, as many, if not all, of the functions associated with these toolbar buttons, controls and widgets are associated with menu items of the various drop-down control menus provided according to standard windowing techniques. Thus, it should be appreciated that the following description of this exemplary embodiment of the navigation and control bar 450 is illustrative only. For example, the toolbars 450 shown in FIGS. 4-7 and 12-24 use another exemplary embodiment of the navigation and control toolbar 450 that does not include the drill down and add new tree entry function buttons 469 and 470. Similarly, other exemplary embodiments of the navigation and control toolbar 450 delete the replace selected items function button 465, the intersect selected items function button 466, the add selected items function button 467, and the subtract selected items function button 468. In this exemplary embodiment, these functions are accessed using the drop-down control menus.

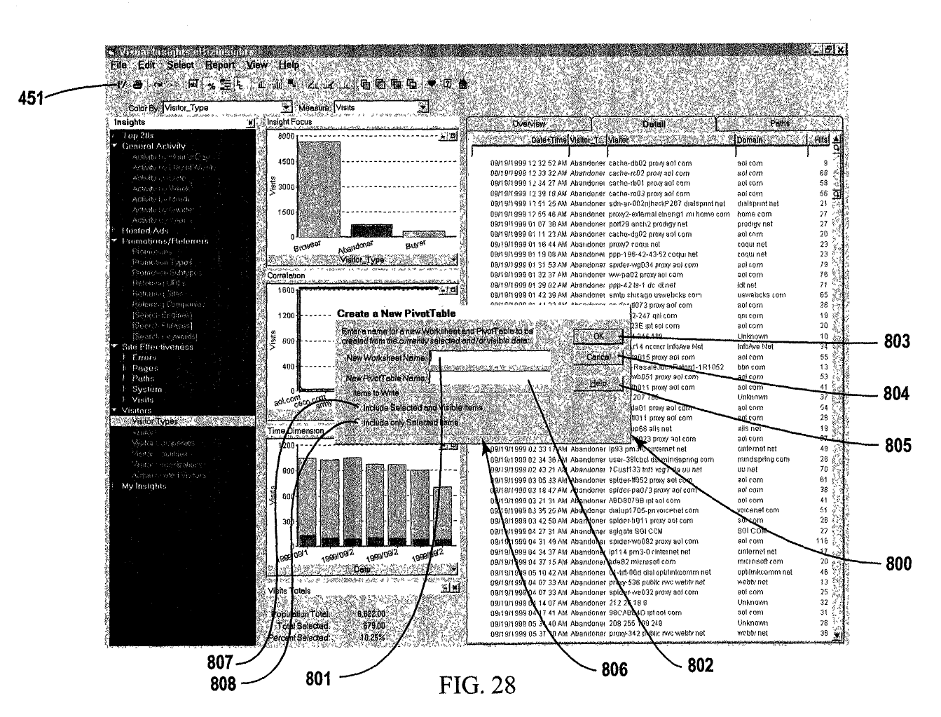

In particular, the write-back function selection button 551 accesses the write-back function and displays the write-back dialog box, which is shown in FIG. 28. The write query function selection button 455 allows the user to access the write query function and displays a write query dialog box. The display totals table toggle box 56 allows the user to display or close the totals table portion 440 and indicates whether the totals table portion 440 is currently displayed. The color legend view toggle button 457 allows the user to display or close the color legend view 480, as shown in FIG. 24 and indicates whether the color legend view 480 is currently being displayed. The workflow control view toggle button 458 allows the user to display or close the workflow control view 410 and indicates whether the workflow control view 410 is currently being displayed.

The select all function button 459 causes all of the data to be selected, while the unselect all causes all the current data to be unselected. The toggle selection button 461 unselects all the currently selected elements while selecting all the currently unselected elements.

The exclude unselected function button 462 excludes all unselected items from the current display. In contrast, the exclude selected button excludes all the currently selected elements from view. The restore excluded function button 464 restores any excluded elements from view. The exclude function buttons 462 and 463 are used to eliminate certain elements from view to allow other elements to be more easily analyzed. For example, in FIGS. 6-9, the catalog element of the promotions dimension totally dominates the “Focus” dimension view 422 and the various multiple dimension views 550. By unselecting or selecting the catalog element of the promotions dimension and then using either the exclude unselected or exclude selected function button 462 or 463, respectively, the catalog element of the promotions dimension can be excluded to allow the user to better see which non-catalog promotions generated the most traffic. In particular, by excluding the catalog element of the promotions dimension, the other bars of the bar charts shown in the single dimension views 422 will be rescaled.

The replace selection function button 465 replaces any previously selected items with the currently selected items. The intersect selection function button 466 selects only those elements of the current selection that intersect the previous selection. The add selection function button 467 adds the currently selected elements to the previously selected elements. The subtract selected elements function button 468 subtracts the currently selected elements from the previously selected elements.

The drill down function button 469 allows the user to drill down into the data, as described in detail in the incorporated 923 application. The add new tree entry function button 470 adds a new entry 413 to the tree-structured workflow control 410, as well as adding a new entry 413 to the association properties table 332. In particular, these new entries 413 are displayed in the “My Insights” class 412 of the tree-structured workflow control 410.

In operation, a user will have previously selected one of the current entries of the tree-structured workflow control 410. As a result, the display manager circuit or routine 320 will read the corresponding entry from the association properties table 332. The display manager circuit or routine 320, based on the read entry, will display in each of the single dimension views 422, 424 and/or 428 a primary dimension associated with that single dimension view 422, 424 or 428 and the measure associated with those single dimension views 422, 424 and/or 428 by the read entry. Similarly, the display manager circuit or routine 320, based on the read entry, will associate two or more dimensions with each multiple dimensional view 510, 530 and 550 of the multi-dimension portion 500, and, based on the read entry, will display an identified primary one of the multiple dimensional views 510, 530 and 550 of the multi-dimension portion 500, relative to the associated measure. Finally, based on the read entry, the display manager circuit or routine 320 will associate zero, one or more secondary dimensions with each of the color-by list box accessed through the list box access button 476, and the drop down list boxes associated with the title bars 423, 425 and/or 429, and zero, one or more secondary measures with the measure list box accessed through the list box access button 478.

In many cases, the user may determine that different primary dimensions for one or more of the list boxes associated with the color-by control portion 474 or the title bars 423, 425 and/or 429 are more appropriate for the analysis that user wished to perform. Similarly, the user may determine a different measure and/or a different primary one of the multiple dimensional views 510, 530 and 550 of the multi-dimension portion 500 are more appropriate for the analysis that user wished to perform. In this case, the user will, of course, alter one or more of the dimensions shown in the single dimensions views 422, 424 and/or 428, the color-by dimension, the selected measure and/or the primary multiple dimensional view 510, 530 or 550.

The user can then select the add new tree entry function button 470 to add a new tree entry for the currently displayed set of views, dimensions and measures, and the like. As a result, a new entry is added to the association properties table 332. This new entry captures the displayed set of views, dimensions and measures as the primary views, dimensions and measures, and the like. This new entry further captures any non-displayed but associated views, dimensions, measures and the like as the secondary views, dimensions, measures and the like. Then, the tree-structured workflow control 410 is updated to associate a new entry 413 in the tree structured workflow control 410 with the new entry in the association properties table 332. When this new entry 413 is selected, the user's desired primary and secondary views, dimensions, measures and the like are used by the display manager circuit or routine 320 to generate the user's desired perspective.

FIG. 10 shows the single measure view toolbar 511 in greater detail. As shown in FIG. 10, the single measure toolbar 511 includes a display elements as cylinders selection button 512, a display elements as rectangular prisms selection button 513, a sort order selection button 514, a select tool enable button 515, a pan multiscape function button 516, a rotate multiscape function button 517, a turn multiscape function button 518, a zoom multiscape function button 519, a home position function button 520, a side view function button 521 and a top view function button 522. In particular, the display elements as cylinders button 512 causes the bars of the multiscape element 501 to be displayed as cylinders, while the display elements as rectangular prisms button 513 causes the bars of the multiscape element 501 to be displayed as rectangular prisms. The sort order drop down menu button 514 causes a drop down menu providing sort order options for the x and y axes 527 and 528 of the multiscape element 501.

The pan multiscape function button 516 allows the user to pan the multiscape element 501 within the window 526. Panning is accomplished by using the selection device 240 to place the cursor in the window 526 and then pressing a button of the selection device 240. The rotate and turn multiscape function buttons 517 and 518 operate similarly to allow the user to rotate the multiscape element 501 about the x and z axes 527 and 529 respectively. The zoom multiscape function button 519 operates similarly to allow the user to zoom in and out on the multiscape element 501.

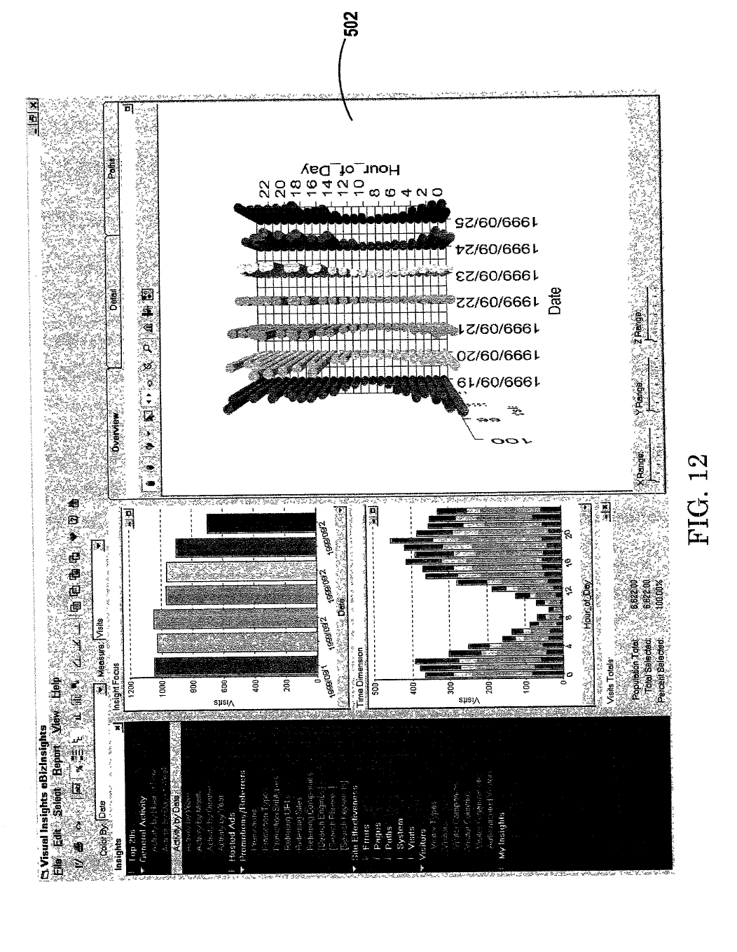

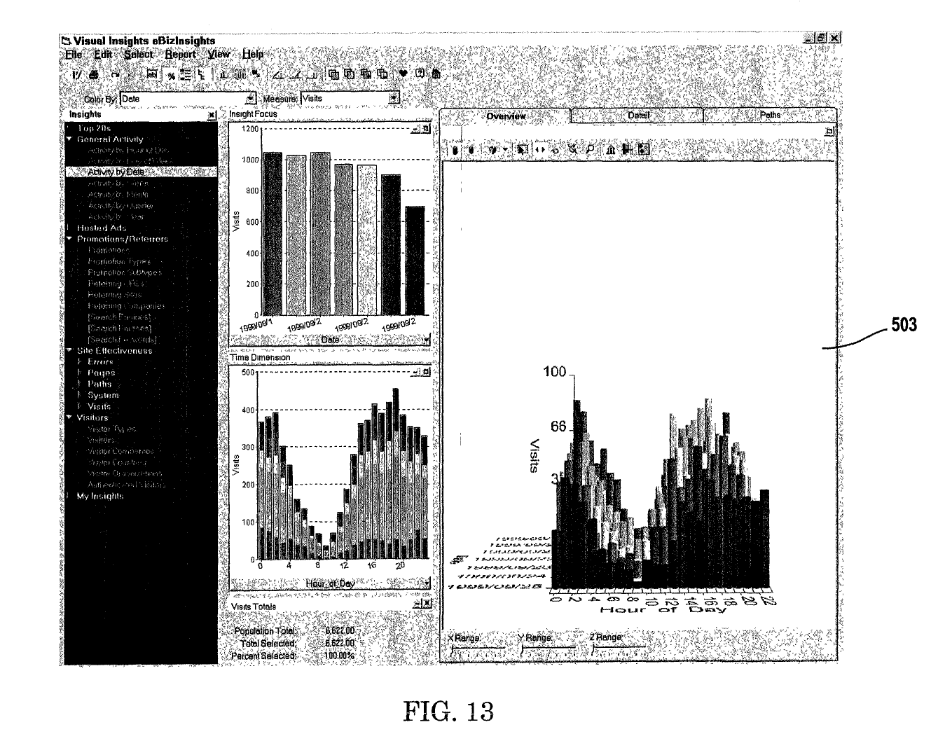

The home position function button 520 allows the user to automatically return the multiscape element 501 to the home position after it has been panned, rotated, turned and/or zoomed. The top view function button 522 turns the multiscape element 501 from its current position to a top view, such as the top view 502 shown in FIG. 12. The side view function button 521 turns the multiscape element 501 from its current position to a side view. This side view initially displays the x axis 527 at the front of the window 526. The pan, rotate, turn and zoom buttons 516-519 can then be used to further modify the position of the multiscape element 501. FIG. 13 shows one exemplary side view 503. The pan, rotate, turn and zoom buttons 516-519 can also be used to further alter the position of the multiscape element 501 after it has been set to the top view.

FIG. 11 shows one exemplary embodiment of the single dimension view toolbar 430 displayed when a single dimension view 422, 424, 428 or the like is maximized. As shown in FIG. 11, the toolbar 430 includes a display vertical bar toggle button 431, a display horizontal bar display toggle button 432, a normal bar display toggle button 433, a normalized bar display toggle button 434, a sort order menu button 435 and a label display style menu button 436. When the display vertical bar toggle button 431 is selected, as shown in FIG. 11, the dimension values are arranged along the x axis, while the measure values are arranged along the y axis, as shown in FIG. 14. In contrast, when the display horizontal bar toggle button 432 is selected, the dimension values are arranged along the y axis, while the measure values are arranged along the x axis. When the display normal bars toggle button 433 is selected, as shown in FIG. 11, normal bars are used, as shown in FIG. 14. In contrast, when the display normalized bars toggle button 434 selected, normalized bars, such as those shown in FIG. 15, are used.

The display sort order menu button 434, when selected, causes a drop-down sort order menu to be displayed. The sort order menu can include any known or later developed sort order. In general, the sort order menu will be predetermined. By selecting an available sort order using the sort order menu, the user can change the sort order of the corresponding single dimensional view. At the same time, the sort order associated with that dimension in the multiscape view 510 is also changed to that selected sort order. Similarly, in the textual view 530 and the multiple dimensional view 550, for the dimensional column corresponding to the reordered single dimensional view, the sort order associated with the bar chart icon 562 is updated.

The label display style menu button 436, when selected, causes a drop-down label display style menu to be displayed to the user. The label display style defines how textual labels for some or all of the elements of a dimension will be displayed in the corresponding single dimensional view. The label display style menu can include any known or later developed label display style. In general, the label display style menu will be predetermined. By selecting an available label display style using the label display style menu, the user can change the label display style of the corresponding single dimensional view. At the same time, the label display style associated with that dimension in the multiscape view 510 is also changed to that selected sort order. Similarly, in the textual view 530 and the multiple dimensional view 550, for the dimensional column corresponding to the reordered single dimensional view, the label display style associated with bubbles, box plots or dot strips of the bubble, box plot or dot strip view is updated.

In contrast to the random browsing pattern that individuals use when navigating around the World Wide Web, e-commerce sites, just like brick-and-mortar stores, are designed for efficient traffic flows. In well designed stores, whether brick-and-mortar or web-based, customers can find the desired product easily and check out efficiently. As with a brick-and-mortar store, another challenge for web site designers is to provide customers with impulse purchase opportunities on the way out. A further challenge for web site designers is to attract profitable repeat customers back to the web site using ads and other promotions.

The various single measure, textual data and multiple dimension views 510, 530 and 550 displayable in the multi-dimensional portion 500, in conjunction with the single dimension views shown in the dimensional view portion 420 and the tree-structured workflow control view 410 shown in the workflow control portion, allows a user to quickly and interactively analyze the parsed web site activity log to determine if these challenges have been met, where the web site is failing to meet these challenges, and how the web site can be improved.

In particular, the web site activity data visualization systems and methods according to this invention implement the workflow control portion 410, the dimensional view portion 420, and the multi-dimensional view portion 500 using interactive, dynamic graphics. Dynamic graphics is the capability of the visual metaphors, that is, the various views shown in the workflow control portion 410, the dimensional view portion 420, and the multi-dimensional view portion 500, to change in response to user inputs on these views. In general, such user inputs are provided by the user manipulating a user input device, such as a mouse, a track-ball, a light pen, a touch screen and the like, over one of the displayed views to select subsets of the displayed data. This dynamic capability is difficult to illustrate in a static medium such as a patent application, but is an extremely powerful tool for interactive visual discovery.

There are several different classes of interactive operations, including “brushing”, “viewport manipulation via pan, zoom, and orientation controls”, “data layering via color”, “sorting and ordering”, “selecting to identify subsets”, “excluding to focus on subpopulations”, and “interactively changing the correlation variable”.

“Brushing” or touching any graphical object with the selection device to reveal details. For example, brushing a particular date on the date bar chart shown in FIGS. 4-8 reveals the number of visitors on that particular day.

“Viewport manipulation via pan, zoom, and orientation controls”makes it easy to see patterns that might otherwise be obscured. As illustrated in FIG. 11, the multiscape navigation toolbar controls provide a rich environment for a three-dimensional object.

“Data layering via color” shows additional information. Tying color to referring site, as shown in the single measures view shown in FIG. 7, indicates that most visitors came from catalog promotions.

“Sorting and ordering” are powerful sense-making operations that all of the visual metaphors support.

“Selecting to identify subsets” is useful to see how a subpopulation relates to the whole. For example, do the “Buyers” take different paths through a site than “Abandoners”?

“Excluding to focus on subpopulations” is a key technique for identifying micro-trends and other patterns that are obscured by averages.

“Interactively changing the correlation variable” facilitates add hoc analysis.

FIGS. 14 and 15 show two exemplary embodiments of the secondary, or “time”, single dimension view 424 has been maximized by selecting its maximize button 427. As shown in FIG. 14, the single dimension view 424 now occupies essentially all of the single dimensional view 420 and includes the toolbar 430 and a scroll bar 437. At the same time, the primary, or “focus” single dimension view 422 has been minimized. In particular, in FIG. 14, the single dimension view 424 is displayed with the display vertical bars and display normal bars toggle buttons 431 and 433 selected. In particular, in FIG. 14, while the horizontal axis has not changed its scale, in maximizing the single dimension view 424, the vertical axis has been rescaled to show finer divisions of the measure value.

The scroll bar 437 allows the scale of the vertical axis to be altered significantly. In particular, the end buttons 438 and 439 can be selected to change the scale of the x axis. By moving the right button 439 to the left or the left button 438 to the right, the amount of the x axis shown within the bounds of the lateral portions of the single dimension view 424 can be altered. At the same time, once the scale of the scroll bar 437 has been changed, the scroll bar can be scrolled left and right to view different portions of the expanded x axis scale.

It should also be appreciated that the maximize button 427 is now a restore button 427′. When selected, the restore button 427′ returns the maximized single dimension view 422, 424 or 428 to its standard size and restores the minimized single dimension views 422 and/or 428 to their standard size. In contrast, selecting the minimum button 426 causes the corresponding single dimension view 422, 424 or 428 to be minimized, while maximizing one of the minimized single dimension views 422, 424 or 428.

FIG. 15 generally corresponds to FIG. 14, except that, instead of the normal bars toggle button 433 being selected, the display normalized bars toggle button 434 has been selected. Accordingly, the single dimension view 424 now displays normalized bars in place of the normal bars shown in FIG. 14.

FIG. 16 shows the textual data view 530 displaying a different portion of the same textual data as is shown in FIG. 5. In particular, the portion of the textual data 541 shown in the window 540 is the top most portion of the textual data corresponding to the selected “activity by date” workflow control entry 416. In particular, in FIG. 16, the textual data is shown using a “full size” view. This is the standard view when the textual data view 530 is first displayed after one of the selectable workflow control entries 416 is initially selected. At full scale, the textual data view displays information using the color coded textual data displayed in a normally-sized font. However, at full size, while the font is clearly legible to a user, the user option cannot appreciate patterns and trends, because only a small fraction 541 of the text data can be viewed in the window 540 at any one time.

Accordingly, the web site activity data visualization systems and methods according to this invention provide two different ways for the user to alter the scale of the text data in the textual data view 530. In a first method, similarly to the scroll bar 437 which is displayed when one of the single dimensional views 422, 424 and 428 is maximized, the scroll bar buttons 538 and 539 can be used to continuously rescale the portion 541 of the text data shown in the window 540. In particular, to increase scalability, the user can begin zooming out by, for example, selecting the bottom selection button 539 and dragging it down towards the bottom of the scroll bar 536. As a result, the textual data view 530 will use progressively smaller fonts. As the user continues to zoom out by continuing to drag the button 539 down towards the bottom of the scroll bar 536, the columns of textual data in the textual data view 530 will switch from actual text to thin bars, where each bar represents one row of the textual data. This process is referred to as smashing. As the user continues to zoom out even further, the bars continue to thin out and the amount of space between the bars continues to decrease until each bar is a pixel high and there is no white space between the bars. If this is not yet sufficient to show the entire text file, the text will be further smashed by having each bar represent more than one line of text.

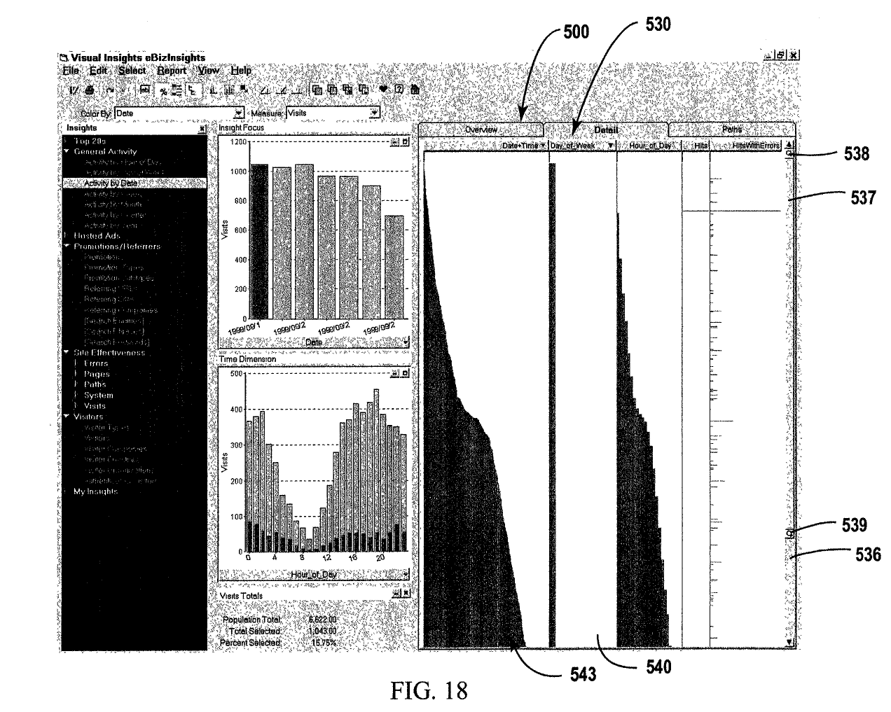

Alternatively, by placing the cursor in the window 540 and using the alternative button of the selection device 240, i.e., by “right-clicking”, a menu pop-up dialog will be displayed that allows the user to change the scale from the current scale to any one of a “full scale” option, a “one pixel per line”, a “fit to window” option or the like. Accordingly, in the exemplary embodiment shown in FIG. 16 of the textual data view 530, when the scale is changed from full scale to fit to window, the exemplary embodiment of the textual data view 530 shown in FIG. 17 is obtained. In particular, in FIG. 17, the textual data has been sufficiently smashed that more than one line of text data is represented by each one-pixel-high horizontal bar. The scroll bar buttons 538 and 539 being placed at the maximum top and bottom positions of the scroll bar 536 and the scroll bar element 537 otherwise completely occupies the scroll bar 536 demonstrates that the entire text data has been fit to the window 540. Thus, the window 540 includes the entire portion 542 of the textual data corresponding t the selected “activity by date” workflow control entry 416. In contrast, if the “one pixel per column” option is selected, the exemplary embodiment shown in FIG. 18 results. In particular, when the option is changed from the “fit to window” option to the “one pixel per row” option, the portion 543 of the text data viewable in the window 540 no longer includes the entire text data. This is demonstrated by the button 539 being placed at a position above the bottom of the scroll bar 536 while the top button 538 is at the top of the scroll bar 536. In addition, the scroll bar element 537 no longer occupies the entire scroll bar 536.

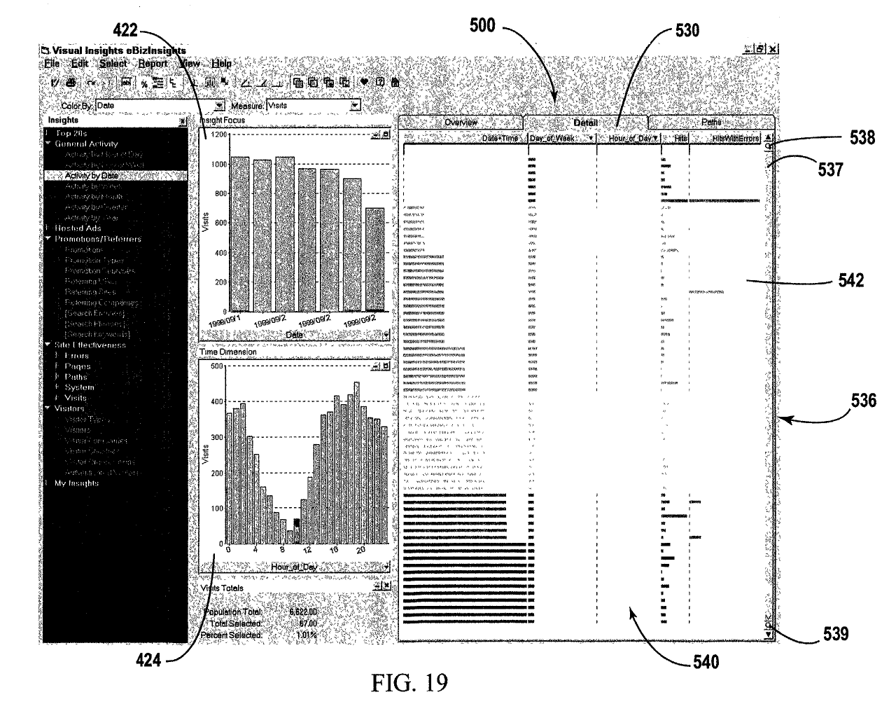

In the exemplary embodiment shown in FIG. 19, the selected data has been reduced to only a single hour of the day, by using the selection device 240 to select one of the bars of the bar chart shown in the single dimension view 424. As a result, all of the other bars of the single dimension view 424 have been grayed out and all of the data corresponding to the grayed out bars in the bar chart 422 has also been grayed out, leaving only the data corresponding to the selected bar shown in color. At the same time, the textual data displayed in the textual data view 530 is limited only to the rows corresponding to the selected bar. As a result, when the fit to window option is selected, an intermediate smashed display results with the bars and the spacing between the bars extending over more than a single pixel in the vertical direction.

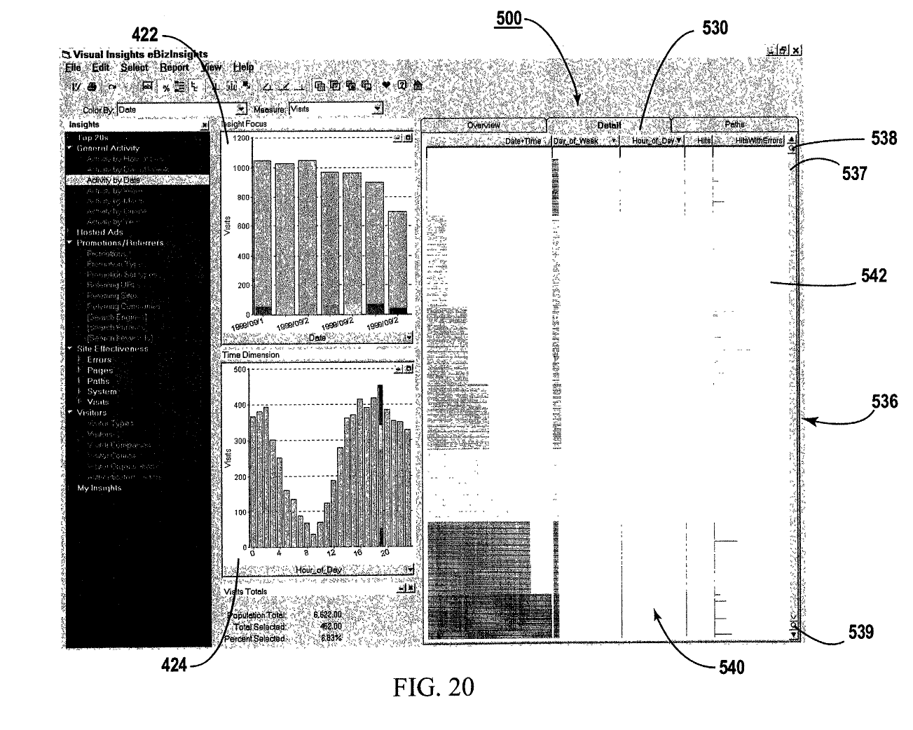

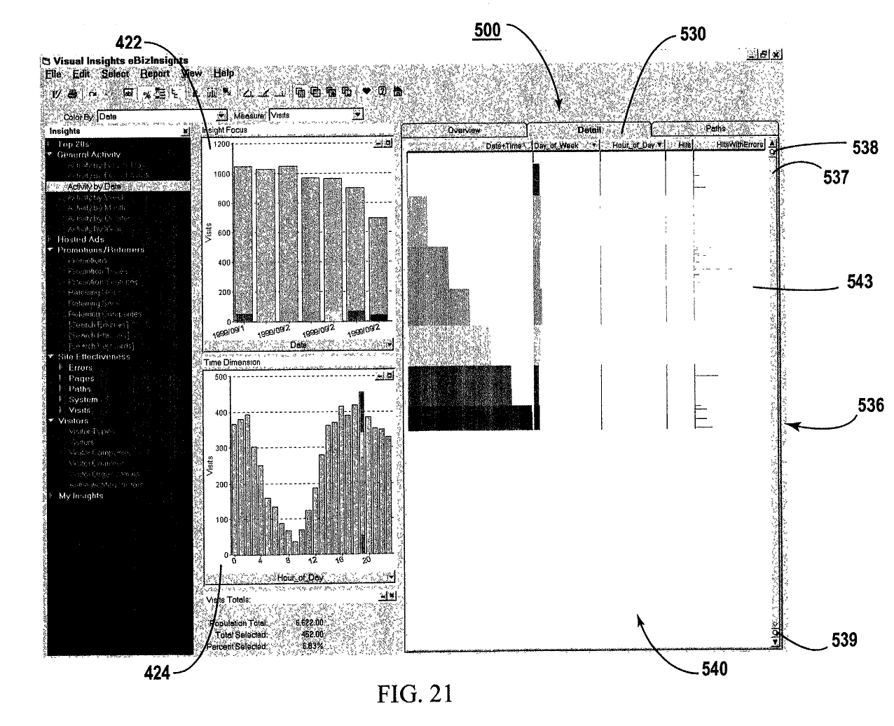

In contrast, when a bar of the single dimension view 424 having significantly more data is selected, as shown in FIG. 20, and the fit to window option is selected, the data is much more aggressively smashed. However, each row of the data still extends vertically over more than one pixel and there is still white space between each of the rows. If the exemplary embodiment shown in FIG. 20 is further altered by selecting the single pixel per row option, the exemplary embodiment shown in FIG. 21 is obtained. In particular, in FIG. 21, the textual data is overly aggressively smashed, such that it no longer fills the window 540.

FIGS. 16-21 also illustrate how interactive dynamic graphics allow the user to select, or more generally, perform visual querying on the displayed data. Rather than having to generate complex boolean text queries, the user can generate complicated queries simply by selecting various data sets and intersecting, adding or subtracting those selections from previous selections. For example, as shown in FIGS. 17 and 18, the user has selected the data corresponding to visits made on Sep. 19, 1999. As a result, while the Sep. 19, 1999 bar in the single dimension view 422 remains colored, the textual data displayed in the textual data view 530 is limited only to the textual data for Sep. 19, 1999. At the same time, the bar charts shown in the single dimensional view 424 show only the data corresponding to Sep. 19, 1999 in color, while the data for all other days has been grayed out. In contrast, merely by replacing the selection shown in FIGS. 16, 17 and 18 with the selection shown in FIG. 19, the user can see how the visits made at 10 o'clock during the week of Sep. 19-25, 1999 were distributed during the week. Similarly, by replacing the selection of the 10AM bar, by selecting the 7PM bar, the user can quickly see how the visits made at 7PM were distributed for the week of Sep. 19-25, 1999, as shown in FIGS. 20 and 21.

Static reports show various snap-shots on web site activity, such as, for example, how many visitors each promotion attracted to the web site. The deeper analysis task, however, involves figuring out which promotions stimulated the most buyers, when those buyers visited the web site, and what paths the buyers took through the web site in making and completing their purchases.

FIG. 22 shows the initial display for a promotional study, with color tied to promotion type. The data in this example is real and comes from the e-commerce site for a large catalog retailer. All names and identifiers have been changed for privacy. The large blue bar for the “catalog” item of the “promotion” dimension shown in the “focus” single dimension view 422 shows that the vast majority of the visitors to the web site came via the company's own catalog,. The “correlation” single dimension view 428 shows that most visitors were “browsers,” visitors who did not buy anything, a small fraction were “abandoners”, visitors who put items in their shopping basket but did not complete the checkout process, and the remaining visitors became “buyers”. The “time” single dimension view 424 shows visitors by day for the one week snapshot under study.

Additionally, in FIG. 22, the multiple dimension view 550 and the bubble plot view display button 554 are selected to display the bubble plot view in the bubble plot view window 565. In particular, in FIG. 22, the parallel axis option has been enabled to display parallel axis lines 564. In particular, each parallel axis line 564 represents the particular date, promotion, referring domain, entry page exit page and visitor type of each distinct visit to the web site during the week of Sep. 19-25, 1999. As a quick review of the exemplary embodiment shown in FIG. 22 will demonstrate, it is difficult to see any patterns in the parallel axis lines 564 because the parallel axis lines 564 are simply too dense in the right hand portion of the bubble plot window 565. The density of the parallel axis lines 564 can be reduced by first selecting the buyer bar in the third, or “correlation” single dimension view 428. The result of this selection is not shown. However, the selection remained too broad and the parallel axis lines 564 were still too dense to discern any patterns.

To further reduce the amount of data selected, in the exemplary embodiment shown in FIG. 23, the intersect selection function selection button 466 was first selected and then the “Yahoo” bar in the primary, or “focus”, single dimension view 422 was selected to select buyers who responded to promotions displayed on the Yahoo search engine. That is, the visual query has generated the intersection of the buyer selection and the Yahoo selection. To generate this query using a boolean text query would be quite complicated. However, it was simply performed with three selection events using the selection device 240 and the data visualization graphical user interface 400.

As a result, a user can quickly determine that the Yahoo search engine generated buyers on each day between Sep. 19 and 25, 1999, that all buyers from Yahoo entered through the same referring domain and most went to the same few entry pages and most, but not as many, buyers exited through the same exit page. By then changing the intersection to “Yahoo” and “abandoners”, the user can quickly determine at what point the Yahoo abandoners abandoned their purchases compared to the Yahoo buyers, thus determining if the web site checkout process or pages have a significant negative effect on the subpopulation of visitors who used the Yahoo search engine to access the user's e-business web site.

Similarly, by modifying the selected data, by selecting the select all function button 459 to reselect all of the displayed data, and then by selecting and excluding visitors who come from the catalog, the user can quickly and easily determine that the four top-producing banner ads were on Yahoo, FreeShop, DoubleClick, AOL. If the user proceeds user by changing the third, or “correlation” single dimension view to show “visits by country”, by selecting the dimension list box 429, and by selecting and excluding the dimension values “.com”, “.net”, and “.edu”, the user can quickly and easily determine that Canada and Italy generated the most foreign visitors to the users e-business web site. Next, by switching the time dimension to show “hits by hour”, by selecting the dimension list box 425, the user can quickly and easily determine that visitors followed a two-hump daily pattern. In particular, the user can determine that activity was lowest during the early morning hours, peaked around dinner time, decreased slightly in the evening and peaked again at two in the morning. This pattern suggests that many visitors are shopping early from work early in the afternoons and from home very late into the early morning. Alternatively, the surge of late-evening traffic may represent foreign shoppers in other time zones.

FIG. 24 shows a second exemplary embodiment of the data visualization graphical user interface 400 after the display color legend view toggle button 457 has been selected to display the color legend view 480. The color legend view 480 includes a title portion 481 and a close button 482. The color legend view 480 also includes a colored-by portion 483 that clearly identifies how the various single dimension views and multiple dimension views shown in the multi-dimension view portion 500 are colored. Finally, the color legend view 480 includes a color legend portion 484 that shows all of the different colors used in the various views and a label portion 485 that provides a text label for each of the colors of the color portion 484. The color legend view 480 is useful, for example, when the number of elements of the primary, or “focus” dimension shown in the single dimension view 422 is sufficiently large that it is impossible to display all of the text labels for all of the different dimension elements in either the single dimension view 422 or the single measure view 510.

FIG. 25 shows one exemplary embodiment of a report generation graphical user interface 600 displayed in response to the user selecting a “Generate Repots” menu item of a “Reports” drop-down control menu. The user uses the report generation graphical user interface 600 to generate static HTML reports. In particular, when the user selects the “Generate Repots” menu item, the data visualization graphical user interface 400 is replaced with the report generation graphical user interface 600.

As shown in FIG. 25, the report generation graphical user interface 600 includes a tree-structured report selection control 610, an instruction text portion 620, a report type selection portion 622, a report description portion 630, a destination portion 640 and a control widgets portion 650. The tree-structured report selection control 610 is similar to the tree structured workflow control 410, and also divides the large number of predetermined sets of dimensions and measures into a number of class elements 613. Thus, except as expressly noted below, the tree-structured report selection control 610 operates according to the description of the tree structured workflow control 410 outlined above.

In particular, in the tree-structured report selection control 610, each of these classes 613 has associated with it a selection icon 611. When the selection icon 611 is selected, the subclasses 614 or selectable tree entries or items 616 are displayed underneath the corresponding class tree entry 613. Selecting a selection icon 611 for a class element 613 causes the subclass elements 614 for any subclasses of that class, and any report selection entry 616 organized directly in that class, to be displayed. Selecting a subclass or sub-subclass element 614 also causes further subclass elements 614 for any subclasses of that subclass, and any report selection entries 616 organized directly in that subclass, to be displayed.

The tree-structured report selection control 610 also includes a selection bar 612 that highlights a particular selected class element 613, subclass element 614 or report selection entry 616.

As shown in FIG. 25, a check box 617 is associated with each selectable report selection entry 616. Selecting a check box 617 is associated with a report selection entry 616 indicates that a report for that report selection entry 616 is to be generated as outlined below. The tree-structured report selection control also includes a pop-up control box (not shown) that implements a number of selection functions. These selection functions can include a “sibling select” function, a “sibling deselect” function, a “select all” function, and a “deselect all” function, but can also, in place of or in addition to, these functions, any other known or later developed selection function.

Sibling report selection entries 616 that are those entries associated with the same parent node of the tree as the report selection entry 616 currently highlighted by the selection box 612. Upon invoking the “sibling select” or “sibling deselect” function, all of the sibling report selection entries 616 to the highlighted are, respectively, selected or deselected, by checking or un-checking their corresponding check boxes 617. Similarly, upon invoking the “select all” or “deselect all” function, all of the report selection entries 616 in the tree-structured report selection control 610 are, respectively, selected or deselected, by checking or un-checking their corresponding check boxes 617.

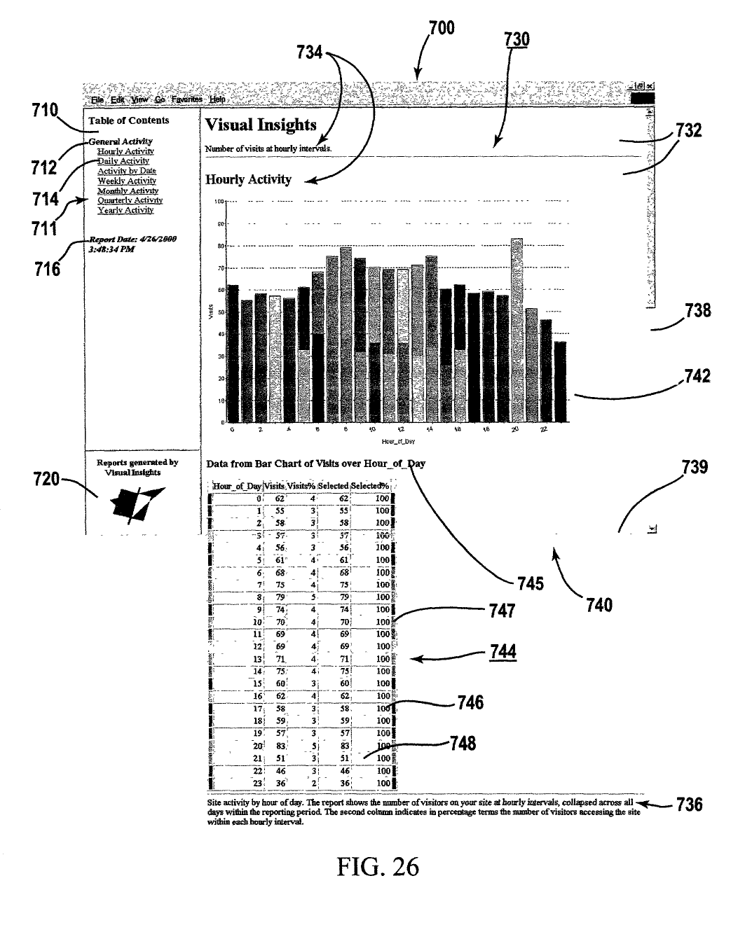

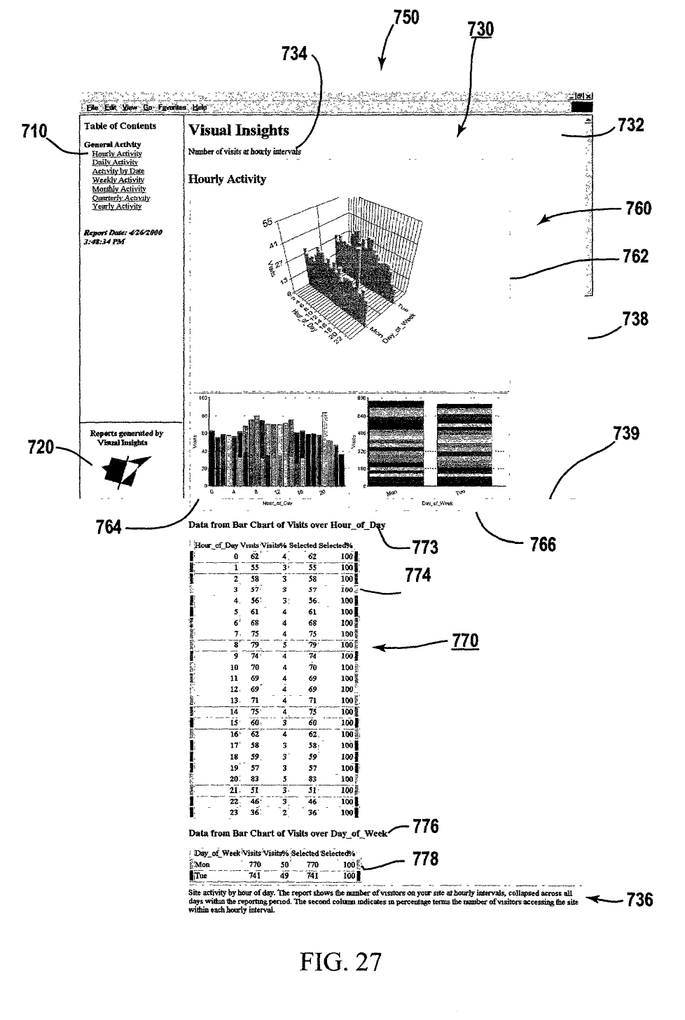

The instruction text portion 620 provides a short text portion instructing the user how to use the report generation graphical user interface 600. The report type selection portion 622 includes a simple report type selection radio button 624 and an advanced report type selection radio button 626. Selecting the simple report type selection radio button 624 deselects the advanced report type selection radio button 626 and instructs the report manager circuit or routine to generate simple reports, such as that shown in FIG. 26, for each selected report. In contrast, selecting the advanced report type selection radio button 626 deselects the simple report type selection radio button 624 and instructs the report manager circuit or routine to generate advanced reports, such as that shown in FIG. 27, for each selected report.

The report description portion 630 provides a textual description in a window 632 of each report as that report's report selection entry 616 is selected by checking its check box 617 or is pointed to using the selection device 240. The report description portion 630 also includes up and down scroll buttons 634 and 636 that allow the report descriptions to be scrolled through the window 632. The destination portion 640 includes a text box 642 that allows the user to identify the destination for the reports to be generated and a conventional browse button 644 that allows the user to browse through the tree structure of the destination device to identify the destination location for the selected reports.

It should be appreciated that, in various other exemplary embodiments, the report description portion 630 can omit the up and down scroll button 632 and 636, such that the report description portion 630 merely contains the window 632. Alternatively, the report description portion 630 can omit the window 632 as well, such that the report description text is merely displayed as static and unselectable text, such as in the instruction text portion 620.

In these exemplary embodiments, the report description text is fixed. Thus, the size of the report description portion 630 can be designed to be large enough to ensure that any of the fixed report descriptions will easily fit within the report description portion 630. Alternatively, if the user is provided with the ability and/or authority to alter the report descriptions or to provide report descriptions for custom reports organized under the “My Insights” section, the custom report description can have a fixed maximum length that will ensure that the customer report description will fit in the provided report description portion 630. Alternatively, the report description field can be unlimited in length. In this case, the up and down scroll button 634 and 636 and the window 632 would be most appropriately used.

The control widgets portion 650 includes a report context portion 651 and a number of control widgets 654-657. The report context portion 651 allows the user to identify whether all data or only the data corresponding to the selection currently made using the data visualization graphical user interface 400 should be used to generate the selected reports. The all data option or the current selection data option is selected using the radio buttons 652 and 653.

Alternatively, the report context portion 651 and the radio button 652 and 653 can be entirely omitted. In this case, the report context is predetermined. However, it should be appreciated that the predetermined report context can, in various exemplary embodiments, comprise the current selection state, while in other various exemplary embodiments, the predetermined report context can instead include all of the displayed data, or even all of the data for the displayed dimensions.

The check box 654 allows the user to view the web pages as they are created in response to the user selecting the create button 655. The cancel button 656 allows the user to cancel without generating any reports. The help button 655 allows the user to access the help function for generating reports.

FIG. 26 shows one exemplary embodiment of a simple report 700. As shown in FIG. 26, the simple report 700 includes a table of contents portion 710, an attribution portion 720, and a report information portion 730 wrapped around a report graphics portion 740. In particular, the table of contents portion 710 indicates a list 711 of reports that were generated with the displayed report. The list 711 includes class titles 712 and report titles 714. The table of contents portion 710 also includes a date and time stamp 716 indicating when the report 700 was created.

The attribution portion 720 is usable to indicate which organization and/or person generated the report.

The report information portion 730 surrounding the report graphics portion 740 includes a header portion 732, a footer portion 736 and a scrollbar 738. The header portion 732 includes a text portion 734 that provides a summary of the single dimensional view 742 displayed in the report graphics portion 740. The footer portion 736 provides a more detailed description of the information the report is designed to convey. It should be appreciated that, in various other exemplary embodiments, the text displayed in the footer portion 736 can be combined into the text portion 734 of the header portion 732. In this case, the footer portion 736 could be omitted. Alternatively, the text displayed in the text portion 734 can be combined into the footer portion 736. In this case, the text portion 734 could be omitted.

The report graphics portion 740 includes at least one single dimensional view portion 742 and, for each single dimensional view, a corresponding legend/data portion 744. In general, the report graphics portion 740 will include only one single dimensional view, but can include as many single dimensional views as there are dimensions associated with the displayed report in the association properties table 332. In various exemplary embodiments, when only one single dimensional view is displayed, the displayed single dimensional view will be the “focus” single dimensional view discussed above.

The corresponding legend/data portion 744 includes a title portion 745 and a data portion 746. The data portion 746 includes a color legend 747 and a number of data columns 748 that display the numerical data that is graphed in the corresponding single dimensional view portion 742.

When the size of the one or more single dimensional view portions 742 and the corresponding one or more legend/data portions 744 is too large to display on the display device 250, the user can use the scroll bar 738 to scroll the displayed portion of the report graphics portion 740 and the surrounding report information portion 730. For example, in the exemplary embodiment shown in FIG. 26, the report graphics portion 740 and the surrounding report information portion 730 extends below the bottom 739 of the window displayable on an exemplary display device 250. Thus, to view the portion of the report graphics portion 740 and the surrounding report information portion 730 below the bottom 739 of the window, the user would need to manipulate the scroll bar 738.

In various exemplary embodiments, the report titles 714 are selectable links that, when selected, replace the report currently displayed and discussed in the report graphics and information portions 740 and 730 with the report associated with the selected title 714. In various exemplary embodiments, the simple report 700 and the linking titles 714 are implemented using the hypertext markup language (HTML). However, any known or later developed method or programming language can be used to implement the simple report 700.

FIG. 27 shows one exemplary embodiment of an advanced report 750. As shown in FIG. 27, the advanced report 750 includes the table of contents portion 710, the attribution portion 720, and the report information portion 730 wrapped around a report graphics portion 760. In particular, the table of contents portion 710, the attribution portion 720, and the report information portion 730 operate as described above with respect to FIG. 26. Thus, a description of these portions of the advanced report 750 will not be repeated.

The report graphics portion 760 includes a multiple dimension view portion 762, a plurality of single dimensional view portions 764 and 766 and, for each single dimensional view 764 and 766, a legend/data portion 770 having a corresponding title portion 772 and 776, respectively, and a corresponding data portion 774 and 778. In various exemplary embodiments, the report graphics portion 760 will include the multiple dimension view portion 762 displaying a multiscape view, regardless of the primary multiple dimension view associated with the displayed report by the association properties table 332 or the currently displayed multiple dimension view 510, 530 or 550. However, in other exemplary embodiments, either the primary multiple dimension view associated with the displayed report by the association properties table 332 or the currently displayed multiple dimension view 510, 530 or 550 can be displayed in the multiple dimension view portion 762.

Similarly, in various exemplary embodiments, the plurality of single dimensional view portions 764 and 766 included in the report graphics portion 760 will include the primary “focus” and “date” single dimensional views as defined in the association properties table 332, regardless of the dimensions currently displayed in the “focus” and “date” single dimensional views. In these exemplary embodiments, to obtain a report for a new set of “focus” and “date” dimensions, the user will need to save that set of “focus” and “date” dimensions in a new tree entry using the add new tree entry function button 470.

However, in other exemplary embodiments, the dimensions used in the currently displayed “focus” and “date” single dimensional views can be used when generating the plurality of single dimensional view portions 764 and 766. Additionally, in even other exemplary embodiments, the displayed single dimensional views is not limited to the “focus” and “date” single dimensional views, but can also include, in addition to or in place of, the “correlation” single dimensional view, and may include other dimensions in addition to or in place of the “focus”, “date” and/or “correlation” single dimensional views. Thus, the report graphics portion 760 can include as many single dimensional view portions as there are dimensions associated with the displayed report in the association properties table 332.

As in the data portion 746 discussed above, the data portions 774 and 778 each includes a color legend and a number of data columns that display the numerical data that is graphed in the corresponding single dimensional view portion 764 and 766, respectively.

When the size of the report graphics portion 760 and surrounding report information portion 730 is too large to display on the display device 250, the user can use the scroll bar 738 to scroll the displayed portion of the report graphics portion 740 and the surrounding report information portion 730. For example, in the exemplary embodiment shown in FIG. 27, the report graphics portion 760 and the surrounding report information portion 730 extends below the bottom 739 of the window displayable on an exemplary display device 250. Thus, to view the portion of the report graphics portion 760 and the surrounding report information portion 730 below the bottom 739 of the window, the user would need to manipulate the scroll bar 738.

FIG. 28 shows a worksheet create dialog box 800 accessed by selecting the write back function selection button 451. The worksheet create dialog box 800 includes a text box 801 that allows the user to identify the new work sheet name and a text box 802 that allows the user to identify the name for the new worksheet. The create worksheet dialog box 800 also includes an OK button 803, a cancel button 804 and a help button 805.

Finally, the worksheet create dialog box 800 includes a data selection portion 806 that includes a pair of radio buttons 807 and 808 that allow the user to include only the actually selected items in the data visualization graphical user interface 400 or those selected items in the data visualization graphical user interface 400, as well as the unselected but still visible items in the data visualization graphical user interface 400.

Various exemplary embodiments of the web site activity data visualization systems and methods according to this invention can either use Microsoft Excel™ database files or connect directly to SQL Server™ 7.0. Web site activity data is pulled directly from the SQL Server. The web site activity log miner 120 and the administration and client modules 130 and 150 are built using Microsoft C++, Visual Basic, and SQL Server 7.0. The workspace is a Visual Basic container based on Stephen G. Eick, “Visualizing multi-dimensional data,” IEEE Computer Graphics and Applications, 34(1):61-67, February 2000, incorporated herein by reference. The workspace is a Visual Basic container hosts a rich set of custom visualization components embodied as ActiveX controls, as described in Stephen G. Eick, “Visual discovery and analysis,” IEEE Transactions on Computer Graphics and Visualization, 2000, incorporated herein by reference. The entries in the tree-structured workflow control are defined in a configuration database and specified using a language called Bargle™. This design enables on-line content updates. However, it should be appreciated that any other known or later developed appropriate language could be used to implement the web site activity data visualization systems and methods according to this invention discussed herein.

The visual components that make up the perspectives are implemented using ActiveX™ controls attached to a single data table. However, it should be appreciated that any other known or later developed set of rules that define components could be used to implement the visual components that make up the perspectives of the web site activity data visualization systems and methods according to this invention discussed herein.

It should be appreciated that any combination of the various perspectives discussed above can be used in the web site activity data visualization systems and methods according to this invention. It should further be appreciated that the web site activity data visualization systems and methods according to this invention can use any known or later developed single measure perspective in place of the single measure perspective shown in FIGS. 4 and 6 and any of one or more known or later developed multi-dimensional perspectives in place of one or more of the multi-dimensional perspectives shown in FIGS. 5 and 7. Similarly, any known or later developed single measure view or multiple dimension view can be incorporated into the single measure and/or the multi-measure perspectives of the web site activity data visualization systems and methods according to this invention.

Various exemplary embodiments of the multi-dimensional data visualization systems and methods according to this invention can accept data from Microsoft Excel™ or directly from the SQL Server. However, it should be appreciated that the multi-dimensional data visualization systems and methods according to this invention can be implemented to accept data in any other known or later developed format.

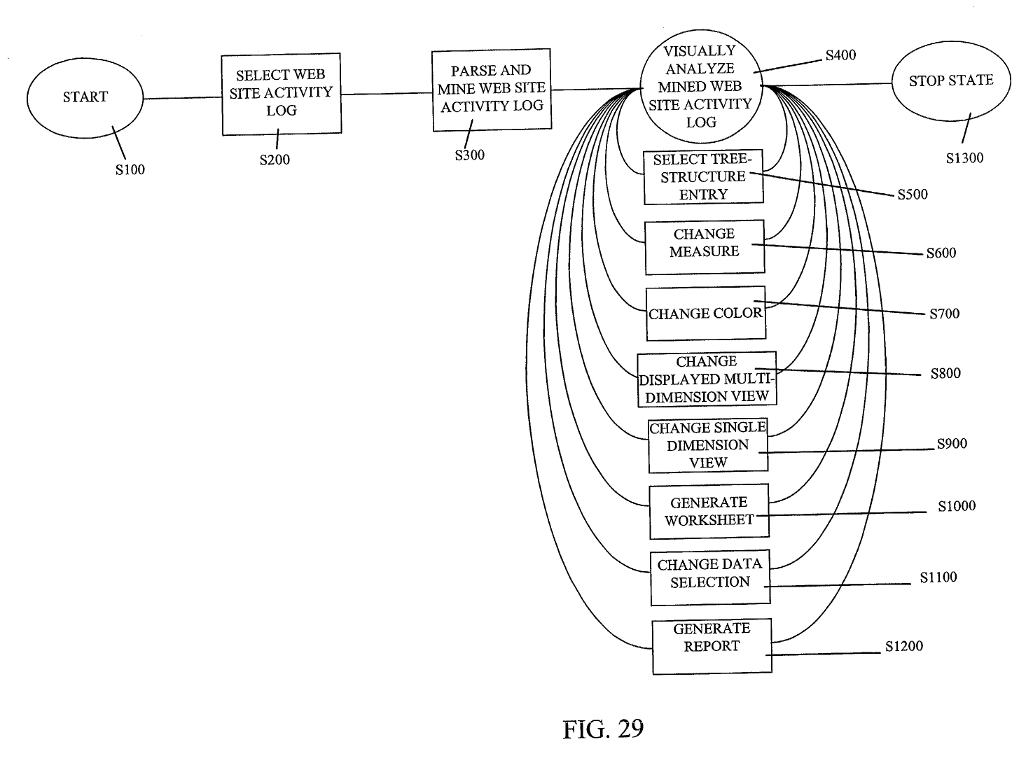

FIG. 29 is a flowchart outlining one exemplary embodiment of the data visualization methods according this invention. As shown in FIG. 29, control begins in step 100 and continues to S200, where the web site activity log to be analyzed is selected. Then, in step S300, the selected web site activity log is parsed. Control then continues to step S400. It should be appreciated that steps S200 and S300 are elemental and can be performed independently of each other or step S400. Thus, steps S200 and S300 can be performed without having to perform any other steps. Similarly, once steps S200 and S300 have been performed on a desired web site activity log, step S400 et al can be performed on the parsed web site activity data at any subsequent time without having to perform step S300.

In step S400, the parsed web site activity data is visually analyzed. In particular, step S400 is an operating state. In the exemplary embodiment of the data visualization methods according to this invention, once in the operating state S400, control is then based on events occurring in the user interface. These events can cause any one of steps S500-S1200 to be performed. Once the user no longer wishes to continue visualizing the current set of parsed web site activity data, control continues to step S1300, where the control process ends.

In particular, it should be appreciated that steps S500-1200 may occur in any order based on inputs received from the user. The events and operations of steps S500-1200 may be interspersed with other events and operations that are not essential to the data visualization methods according to this invention. Thus, such other events and operations are not discussed herein.

As shown in FIG. 29, when control is in the operate state S400, based on user input, control can jump to anyone of step S500, where an entry in the tree-structured workflow control can be selected, step S600, where the displayed measure can be changed, step S700, where the displayed color mapping can be changed, step S800, where the displayed perspective, or multi-dimensional view, can be changed, step S900, where the single dimensional view can be changed, step S1000, where a result set based on the currently selected data can be written back into a new multi-dimensional structure, step S1100, where the selected data can be changed, step S1200, where one or more simple or advanced reports are generated, or step S1200, where a worksheet is generated.

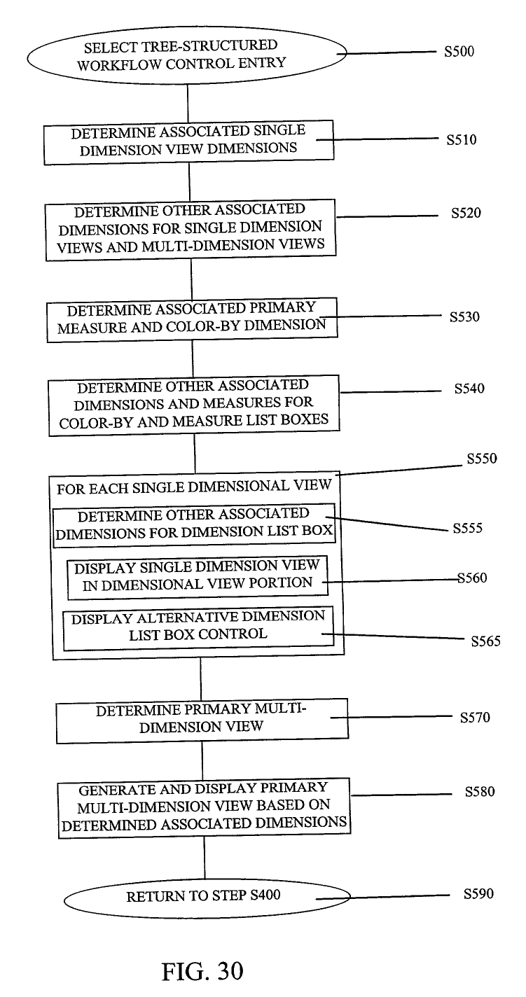

FIG. 30 is a flowchart outlining in greater detail one exemplary embodiment of a method of selecting an entry in the tree-structured workflow control of step S500. As indicated above, control continues from step S400 to step S500 when the user generates an input to select an entry in the tree-structured workflow control. Upon selecting a an entry in the tree-structured workflow control, control continues from step S500 to step S510.

In step S510, the displayed dimensions for the single dimension views that have been associated with the selected workflow control entry are determined. Then, in step S520, any other dimensions for the single dimension views and the multi-dimension views that have been associated with the selected workflow of control entry are determined. Next, in step S530, the primary measure and the primary color-by dimension associated with the selected workflow control entry are determined. Control then continues to step S540.

In step S540, any other dimensions and measures for the color-by and measure listboxes associated with the selected workflow control entry are determined. Next, in step S550, a control loop is established that selects in turn each single dimension view associated with the currently selected entry of the tree-structured workflow control. In step S555, for the currently selected single dimensional view, the other dimensions for the dimension list box associated with the selected workflow control entry are determined. Next, in step S560, the determined associated single dimension view dimensions determined in step S510 are displayed in the corresponding single dimension views in the dimensional view portion. Then, in step S565, the alternative dimension listbox control is displayed with the other associated dimensions determined in step S555 associated with that listbox control. Once all of the single dimension views have been selected, control continues to step S570.

In step S570, the primary multi-dimension view associated with the selected workflow control entry is determined. Then, in step S580, the primary multiple dimension view of the multi-dimension portion is generated based on the determined associated dimensions determined in step S520 and displayed. Then, in step S590, control returns to the operate step S400.

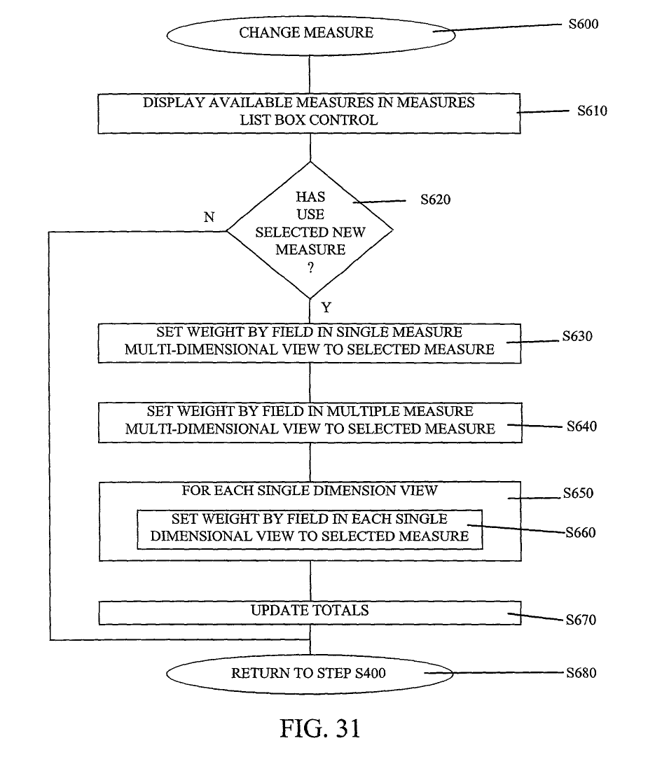

FIG. 31 is a flowchart outlining in greater detail one exemplary embodiment of a method of changing the displayed measure of step S600. In particular, control continues from the operate state S400 to the change measure step S600 when the user generates an input to change or select a particular measure field to be used to weight the display of the single dimensional views of the dimensional view portion, and used to weight the various views of the multi-dimension view portion.

Accordingly, beginning in step S600, control continues to step S610, where the available measures are displayed in a list box control. It should be appreciated that, in various exemplary embodiments, the available measures are predetermined and fixed based either on a preprogrammed set of measures or the set of measures that the systems and methods of this invention have been configured to use using the administration module 130. Alternatively, in various other exemplary embodiments, the available measures are determined based on the currently selected entry of the tree-structured workflow control. Control then continues to step S620.

In step S620, a determination is made whether the user has selected a new measure. If so, control continues to step S630. Otherwise, control jumps directly to step S680. In step S630, the field used to weight the single measures view of the multi-dimension view portion is set to the user selected field value. Then, in step S640, the field used to weight the textual data view and the various multipl measures views in the multi-dimension view portion is set to the user selected field value. Next, in step S650, a control loop is established to select in turn each single dimensional view. Then, in step S660, for the current single dimensional view, the field used to weight that single dimensional view is set to the user selected field value. Once all of the single dimensional views have been selected, control continues to step S670.

In step S670, the totals are updated to reflect the new measure and to display the information. Next, in step S680, control returns to the operate state S400.

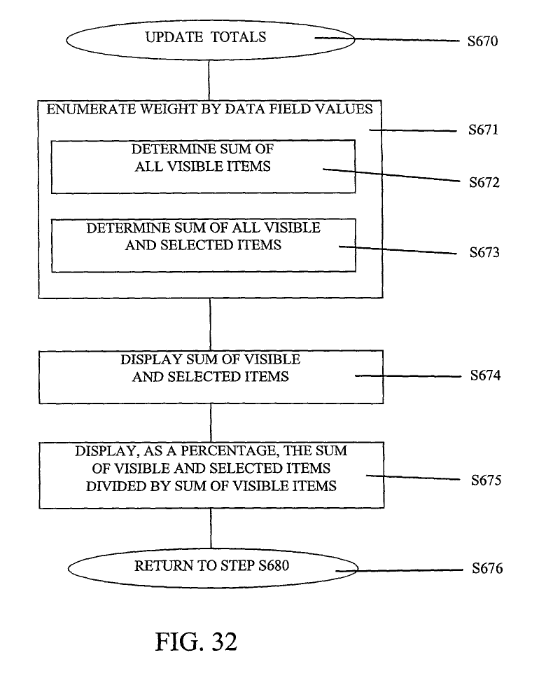

FIG. 32 is a flowchart outlining in greater detail one exemplary embodiment of a method of updating the totals of step S670. Beginning in step S670, control continues to step S671, where a control loop is established to select in turn each data field. Then, in step S672, the sum of all visible items is determined. Next, in step S673, the sum of all visible and selected items is determined. Once both of these sums are determined for each data field, control continues to step S674.

In step S674, the sums of the visible and selected items is displayed for each displayed dimension. Next, in step S675, the percentage of the visible and selected items of the sum of the visible items is displayed for each displayed dimension. Then, in step S676, control returns to step S680.

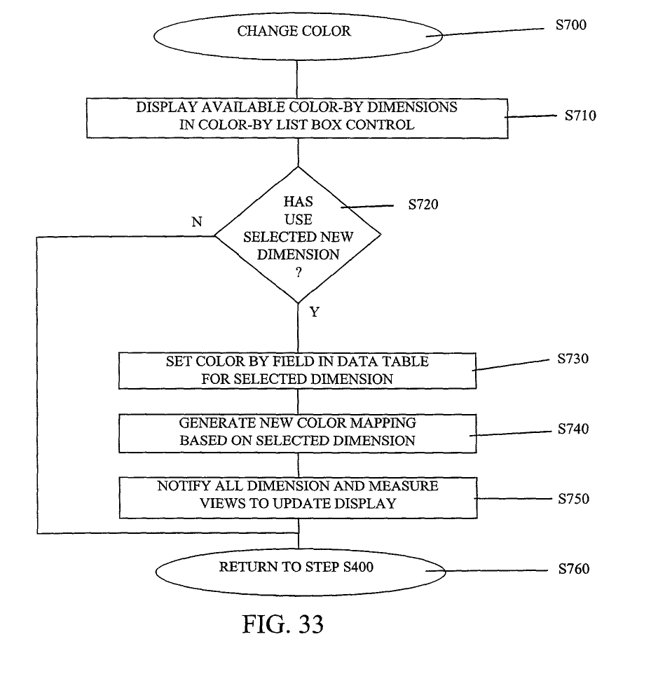

FIG. 33 is a flowchart outlining in greater detail one exemplary embodiment of a method of changing the color mapping used to color a particular dimension of step S700. When in the operate state S400, the user may generate an input to change the color mapping used to color a particular dimension or measure within the various views of the various perspectives, by associating a range of color values to the range of data values for the selected dimension or field. In response, control continues to step S700.

Beginning in step S700, control continues to step S710, where the available dimensions are displayed in a list box control. It should be appreciated that, in various exemplary embodiments, the available dimensions are predetermined and fixed based either on a preprogrammed set of dimensions or the set of dimensions that the systems and methods of this invention have been configured to use using the administration module 130. Alternatively, in various other exemplary embodiments, the available dimensions are determined based on the currently selected entry of the tree-structured workflow control. Control then continues to step S720.

In step S720, a determination is made whether the user has selected a new dimension. If so, control continues to step S730. Otherwise, control jumps directly to step S760. In step S730, the “color-by” field in the central data table for the user selected dimension is set. Then, in step S740, a new color mapping is generated between the data values for the user-selected dimension set in step S730 and a predetermined color range. Next, in step S750, all of the single dimensional views and the various views in the multi-dimensional view portion are updated based on this new color mapping. Then, control continues to step S760, where control returns to the operate state S400.

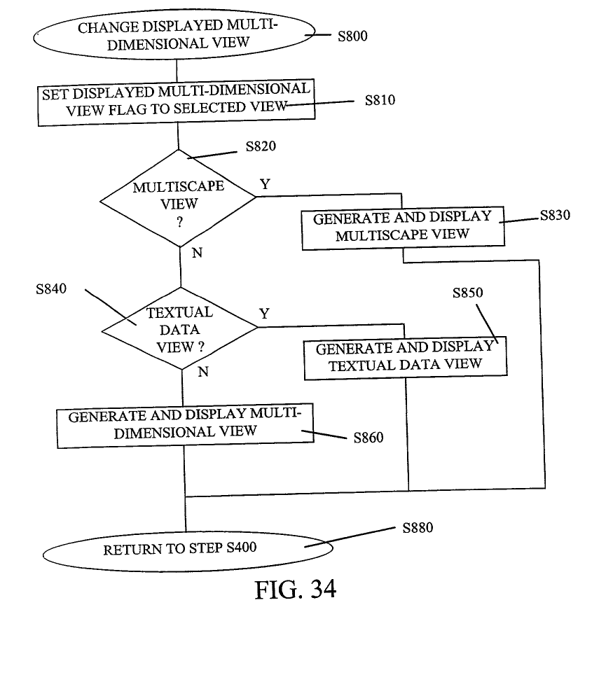

FIG. 34 is a flowchart outlining in greater detail one exemplary embodiment of a method of changing the displayed multi-dimensional view of step S800. In step S400, the user may generate an input to change the perspective being displayed. In response, control continues to step S800.

Beginning at step S800, control continues to step S810, where a display multidimensional view flag is set to the user-selected one of the various multi-dimensional views. Then, in step S820, a determination is made if the multi-dimension view flag is set to the multicape view, or any other three-dimensional view implemented in place of the multiscape view. If so, control continues to step S830. Otherwise, control jumps to step S840. In step S830, the multicape view, or any other three-dimensional view implemented in place of the multiscape view is generated and displayed based on the currently selected measure, the currently selected color-by dimension and the dimensions currently displayed in the primary, or focus, single dimensional view and the secondary, or time, single dimensional view. Control then jumps to step S880.

In contrast, in step S840, the multi-dimension view flag is checked to determine if the textual data view is selected. If so, control continues to step S850. Otherwise, control jumps to step S860. In step S850, the textual data view is generated and displayed based on the currently selected measure, the currently selected color-by dimension, the currently selected scale factor and the dimensions associated with the currently selected entry of the tree-structured workflow control, in view of any changes the user has made to the dimensions displayed in any of the single dimensional views of the dimensional view portion. Control then again jumps to step S880. In step S860, the multiple measures view is generated and displayed based on the currently selected measure, the currently selected color-by dimension, the currently selected scale factor and the dimensions associated with the currently selected entry of the tree-structured workflow control, in view of any changes the user has made to the dimensions displayed in any of the single dimensional views of the dimensional view portion. Control continues to step S880, where control returns to the operate state S400.

It should be appreciated that, if fewer multi-dimensional views are implemented in any particular implementation of the systems and methods of this inventions, one or more of steps S840-S880 may be omitted and/or revised to reflect the particular perspectives that are implemented. Similarly, if different ones of the various multi-dimensional views are implemented, one or more of steps S840-S880 may be revised to reflect the particular perspectives that are implemented. Finally, if additional multi-dimensional views are implemented in any particular implementation of the systems and methods of this inventions, additional steps corresponding to one or more of steps S840-S880 may be added to reflect the particular perspectives that are implemented.

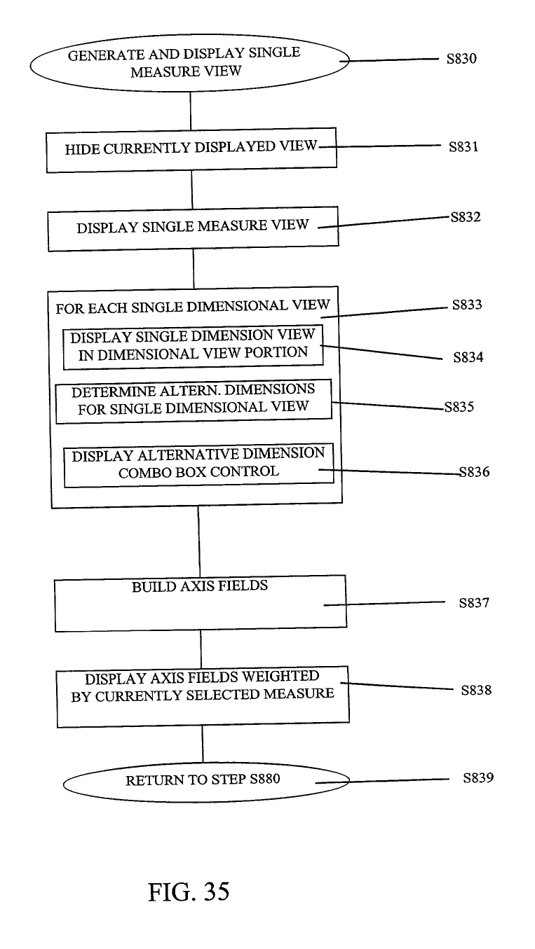

FIG. 35 is a flowchart outlining in greater detail one exemplary embodiment of a method of arranging and display the multicape view of step S830. Beginning is step S830, control continues to step S831, where the currently displayed view is hidden from display. Then, in step S832, the multicape view is displayed. Control then continues to step S833.

In step S833, a control loop is established that selects in turn each single dimension view associated with the currently selected entry of the tree-structured workflow control, in view of any changes the user has made to the dimensions displayed in any of the single dimensional views of the dimensional view portion. In step S834, for the currently selected single dimensional view, a single dimensional view is displayed in the dimensional view portion. Next, in step S835, the available alternative dimensions for the current dimension to be displayed in the current single dimensional view are determined. Then, in step S836, the determined alternative dimensions are associated with a combo box control displayed in the current single dimensional view. Once all of the single dimension views have been selected, control continues to step S837.

In step S837, the axis fields are built. In general, in the various exemplary embodiments of the web site activity data visualization systems and methods according to this invention, the multiscape view associates only a single dimension with each of the x and y axes. Thus, in this case, building the axis fields for the multiscape view is fairly simple. However, it should be appreciated that two or more dimensions can be associated with either or both of the x and y axes, as disclosed in the incorporated 923 application. In this case, the axis fields are built as described in the 923 application.

Next, in step S838, the resulting axis fields are used to build the multiscape view and the currently selected measure field is used to weight the displayed multiscape view. Then, in step S839, control returns to step S880.

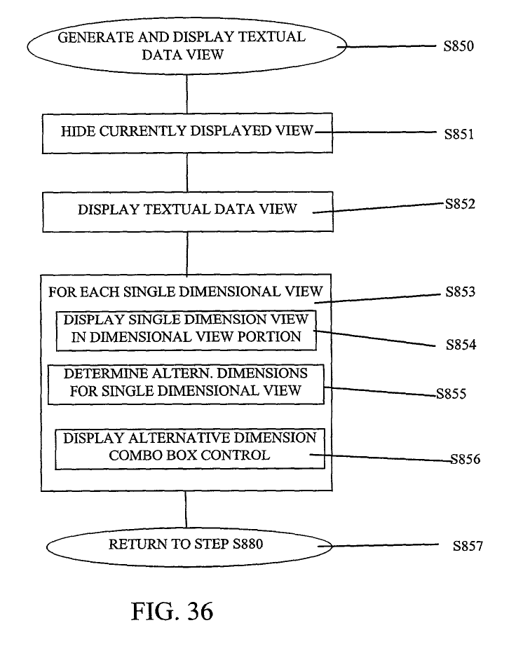

FIG. 36 is a flowchart outlining in greater detail one exemplary embodiment of a method of generating and displaying the multiple measures perspective of step S850. Beginning in step S850, control continues to step S851, where the currently displayed perspective is hidden. Next, in step S852, the textual data view is displayed. In particular, in the textual data view, the data for all the dimensions associated with the currently selected entry of the tree-structured workflow control are displayed based on the currently selected color-by dimension, the currently selected measure and the currently selected scale factor, and in view of any changes the user has made to the dimensions displayed in any of the single dimensional views of the dimensional view portion. Control then continues to step S853.

In step S853, a control loop is established that selects in turn each single dimension view associated with the currently selected entry of the tree-structured workflow control, in view of any changes the user has made to the dimensions displayed in any of the single dimensional views of the dimensional view portion. In step S854, for the currently selected single dimensional view, a single dimensional view is displayed in the dimensional view portion. Next, in step S855, the available alternative dimensions for the current dimension to be displayed in the current single dimensional view are determined. Then, in step S856, the determined alternative dimensions are associated with a combo box control displayed in the current single dimensional view. Once all of the single dimension views have been selected, control continues to step S857, which returns control to step S880.

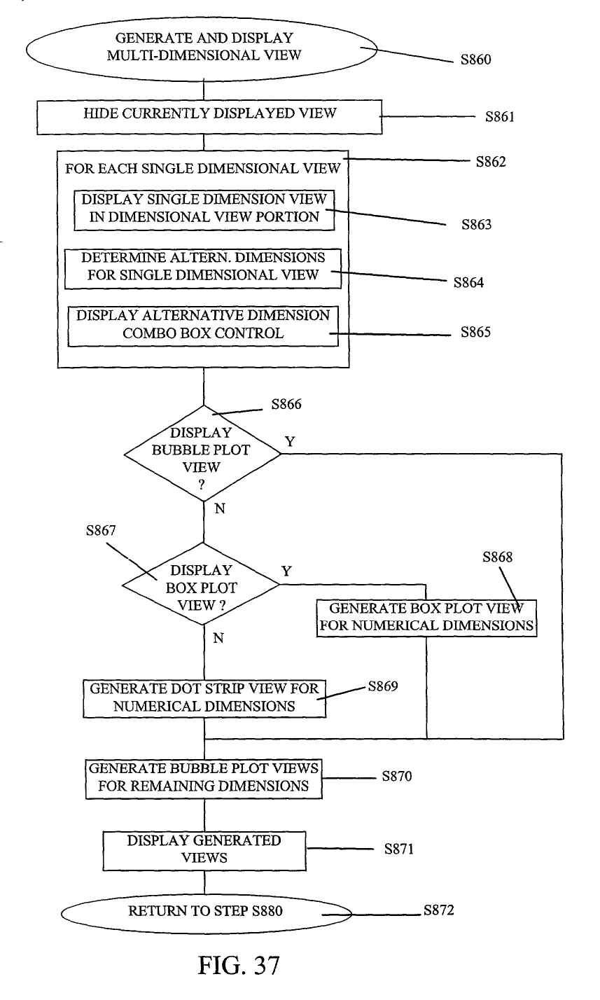

FIG. 37 is a flowchart outlining in greater detail one exemplary embodiment of a method of generating and displaying the multi-dimensional view of step S860. Beginning in step S860, control continues to step S861, where the currently displayed perspective is hidden. Next, in step S862, a control loop is established that selects in turn each single dimension view associated with the currently selected entry of the tree-structured workflow control, in view of any changes the user has made to the dimensions displayed in any of the single dimensional views of the dimensional view portion. In step S863, for the currently selected single dimensional view, a single dimensional view is displayed in the dimensional view portion. Next, in step S864, the available alternative dimensions for the current dimension to be displayed in the current single dimensional view are determined. Then, in step S865, the determined alternative dimensions are associated with a combo box control displayed in the current single dimensional view. Once all of the single dimension views have been selected, control continues to step S866.

In step S866, a determination is made whether the bubble plot view has been selected. If not, control continues to step S867. Otherwise, control jumps to step S870. In step S867, a determination is made whether the box plot view has been selected. If so, control continues to step S868. Otherwise, control jumps to step S869. In step S868, the box plot view is generated for each numerical dimension based on the currently selected measure, the currently selected color-by dimension, the currently selected scale factor and the dimensions associated with the currently selected entry of the tree-structured workflow control, in view of any changes the user has made to the dimensions displayed in any of the single dimensional views of the dimensional view portion. Control then jumps to step S870.

In contrast, in step S869, the dot strip view is generated for each numerical based on the currently selected measure, the currently selected color-by dimension, the currently selected scale factor and the dimensions associated with the currently selected entry of the tree-structured workflow control, in view of any changes the user has made to the dimensions displayed in any of the single dimensional views of the dimensional view portion. Control then continues to step S870.

In step S870, the bubble plot view is generated for any dimensions that do not yet have views generated based on the currently selected measure, the currently selected color-by dimension, the currently selected scale factor and the dimensions associated with the currently selected entry of the tree-structured workflow control, in view of any changes the user has made to the dimensions displayed in any of the single dimensional views of the dimensional view portion. Then, in step S871, the generated views are displayed. Next, in step S872, control returns to the step S880.

It should be appreciated that, if fewer multi-dimensional views are implemented in any particular implementation of the systems and methods of this inventions, one or more of steps S866-S872 may be omitted and/or revised to reflect the particular perspectives that are implemented. Similarly, if different ones of the various multi-dimensional views are implemented, one or more of steps S866-S872 may be revised to reflect the particular perspectives that are implemented. Finally, if additional multi-dimensional views are implemented in any particular implementation of the systems and methods of this inventions, additional steps corresponding to one or more of steps S866-S872 may be added to reflect the particular perspectives that are implemented.

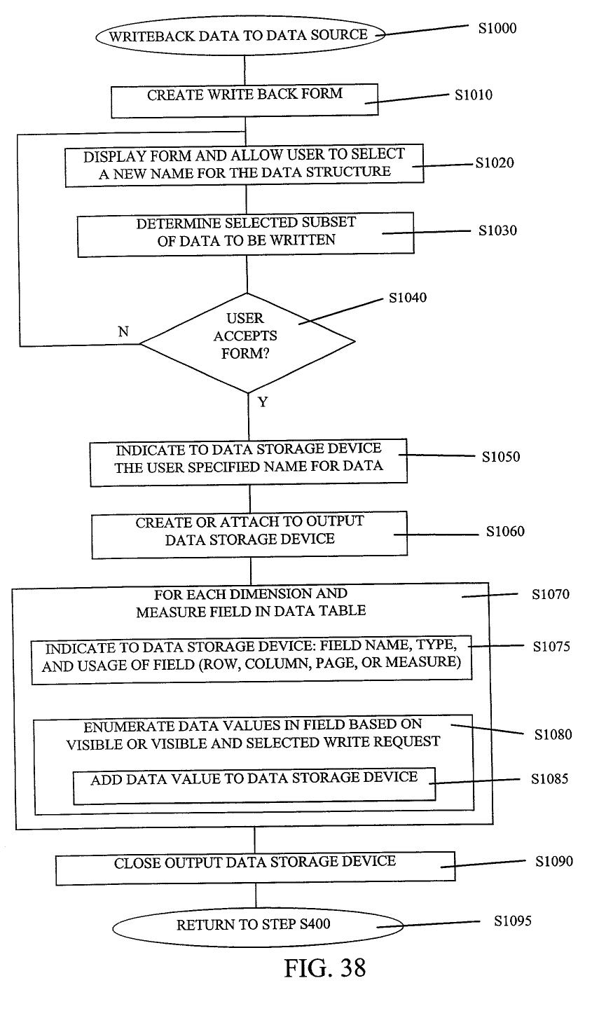

FIG. 38 is a flowchart outlining in greater detail one exemplary embodiment of a method of generating a worksheet of step S1000. In the operate step S400, the user may generate an input indicating that a worksheet generation operation is to be performed to write the currently displayed subset of the data back into a new multi-dimensional data structure or the like. This currently displayed subset includes either all visible items, or only that portion of the visible items that is currently selected. While the data is generally written back as a new multi-dimensional data structure, the data could be written in any known or later developed format, such as a disk file, a database table, or to a report generator.

Accordingly, beginning in step S1000, control continues to step S1010, where a worksheet generation form is created. Then, in step S1020, the created worksheet generation form is displayed to the user to allow the user to select a name for the data to be written back. Then, in step S1030, the displayed worksheet generation form is used to determine the subset of the data to be written back. Control then continues to step S1040.

In step S1040, a determination is made whether the user has indicated that the current state of the worksheet generation form is acceptable. If not, control jumps back to step S1020 to allow the user to change the name of the data and the subset of the data to be written back. Otherwise, once the user indicates acceptance, control continues to step S1050.

In step S1050, the name specified by the user for the data to be written back is output to the device to which the written-back data will be output. Then, in step S1060, if necessary, a reference to the named data storage area will be retrieved to facilitate the transfer of data to that named data storage area. Next, in step S1070, a control loop is established to select in turn each dimension and measure field selected in the writeback form by the user. Next, in step S1075, for the current dimension or measure field, the field name, type and usage of the field is output to the data storage device. It should be appreciated that, if appropriate, the layout information can also be transferred, such that the receiving device could recreate the currently-displayed layout. Next, in step S1080, the actual data values within each selected data field are then selected in turn. Then, in step S1405, the currently selected data value is output to the data storage device. Once all of the actual data values within each data field are selected, control continues back to step S1070. Once each dimension and measure data field has been selected in step S1070, control continues to step S1090.

In step S1090, a signal indicating the writeback process is complete is output to the data storage device. Then, in step S1095, control returns to the operate state S400.

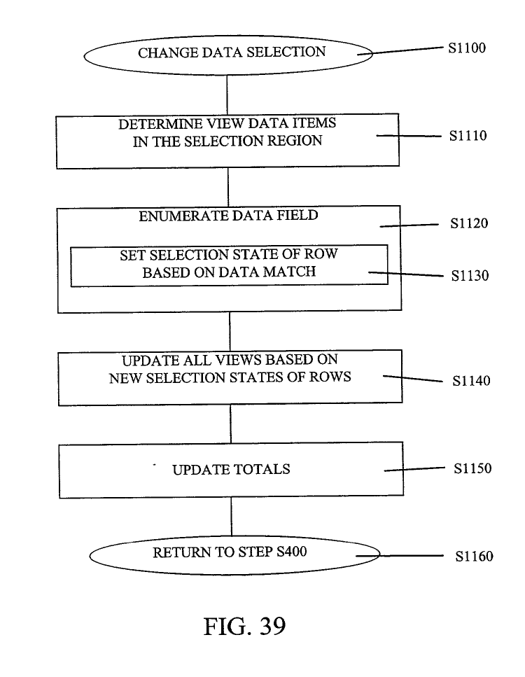

FIG. 39 is a flowchart outlining in greater detail one exemplary embodiment of a method of changing the data selection of step S1100. When in the operate state, the user may generate an input that changes the selection state of some number of data items within any of the single dimensional views or the currently displayed multi-dimensional view displayed in the multi-dimensional view portion.

Accordingly, beginning in step S1100, control continues to step S1110, where the data items in the selection region are determined. Then, in step S1120, a control loop is established to select in turn each row of the central data table field that the current view is displaying. Then, in step S1130, based on whether the data value is contained in the subset of user-selected items, the selection state of each row is set to either selected or unselected. Once all of the rows of the central data table field being displayed have been selected, control continues to step S1140. It should be appreciated that any selection operation, such as replace, intersect, union, addition, subtraction, select all, unselect all and toggle, as well as any other known or later developed selection operation, could be used in step S1130.

In step S1140, all of the single dimensional views and all of the multi-dimensional views are updated based on the new selection states of the rows of the central data table field being displayed. Then, in step S1150, the totals and percentages displayed in the total table portion are updated and the updated totals and percentages are displayed. Next, in step S1160, control returns to the operate state step S400.

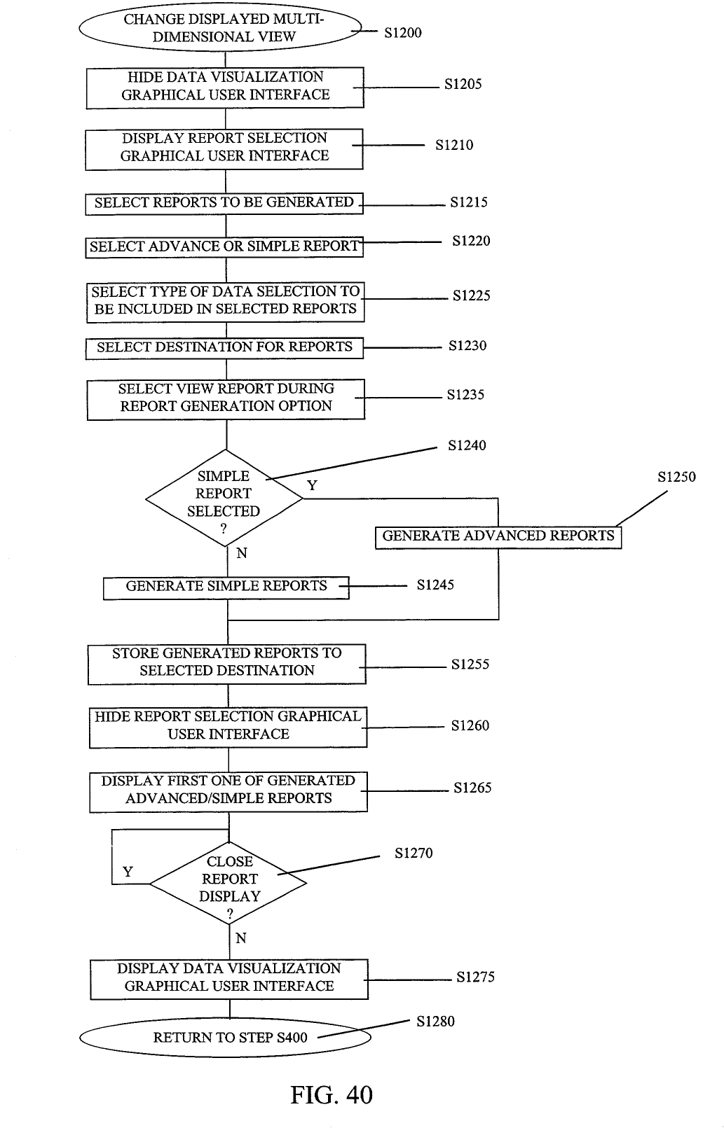

FIG. 40 is a flowchart outlining in greater detail one exemplary embodiment of a method of generating one or more simple or advanced reports of step S1200. When in the operate state, the user may generate an input indicating the user's desire to generate reports. In response, control jumps from step S400 to step S1200.

Accordingly, beginning in step S1200, control continues to step S1205, where the data visualization graphical user interface is hidden. Then, in step S1210, the report selection graphical user interface is displayed to the user. Next, in step S1215, the user interacts with the displayed report selection graphical user interface to select one or more reports to be generated. Control then continues to step S1220.

In step S1220, the user interacts with the displayed report selection graphical user interface to select whether advanced or simple reports will be generated. Next, in step S1225, the user interacts with the displayed report selection graphical user interface to select the type of data selection, such as all data, the currently selected data, or some other type of data, that defines what data will be used when generating the selected reports. Then, in step S1230, the user interacts with the displayed report selection graphical user interface to select the destination, such as a file and path, for the generated report document. Control then continues to step S1235.

In step S1235, the user interacts with the displayed report selection graphical user interface to select whether the selected reports, or various portions of the selected reports, will be displayed to the user as the selected reports are generated. It should be appreciated that steps S1215-1235 can be performed in any order, may be skipped, and/or may be repeatedly performed before the user decides to generate the selected reports. Once the user has decided to generate the selected reports using the options and selections made in performing steps S1215-1235, control continues to step S1240.

In step S1240, a determination is made whether the user has selected advanced or simple reports. If the user selected simple reports, control continues to step S1245. Otherwise, control jumps to step S1250. Instep S1245, one or more simple reports are generated using the options and selections made in steps S1215-S1235. Control then jumps to step S1255. In contrast, in step S1255, one or more advanced reports are generated using the options and selections made in steps S1215-S1235. Control then continues to step S1255.

In step S1255, the generated report document containing the generated reports is stored to the destination input by the user in step S1230. Then, in step S1260, the report selection graphical user interface is hidden. Next, in step S1265, a first one of the generated reports in the reports document is displayed to the user. Control then continues to step S1270.

In step S1270, a determination is made whether the report document is to be closed. If not, control jumps back to step S1270 to allow the user to continue viewing the displayed report document. If so, control continues to step S1275, where the data visualization graphical user interface is displayed. Next, in step S1280, the process stops and control returns to step S400.

As shown in FIG. 2, the web site activity data visualization system 300 is preferably implemented on a programmed general purpose computer 200. However, the web site activity data visualization system 300 can also be implemented on a special purpose computer, a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA or PAL, or the like. In general, any device, capable of implementing a finite state machine that is in turn capable of implementing the flowcharts shown in FIGS. 29-39, can be used to implement the web site activity data visualization system 300.

It should be understood that each of the circuits, modules and other system elements shown in FIGS. 1 and 2 can be implemented as portions of suitably programmed general purpose computers. Alternatively, each of the circuits, modules and other system elements shown in FIGS. 1 and 2 can be implemented as physically distinct hardware circuits within an ASIC, or using a FPGA, a PDL, a PLA or a PAL, or using discrete logic elements or discrete circuit elements. Moreover, each of the circuits, modules and other system elements shown in FIGS. 1 and 2 can be implemented as software modules, routines and/or subroutines executing on a programmed general purpose computer, a special purpose computer, a microprocessor or the like. The particular form each of the circuits, modules and other system elements shown in FIGS. 1 and 2 will take is a design choice and will be obvious and predicable to those skilled in the art.

The memory 230 can be implemented using any appropriate combination of alterable, volatile or non-volatile memory or non-alterable, or fixed, memory. The alterable memory, whether volatile or non-volatile, can be implemented using any one or more of static or dynamic RAM, a floppy disk and disk drive, a writable or re-rewriteable optical disk and disk drive, a hard drive, flash memory or the like. Similarly, the non-alterable or fixed memory can be implemented using any one or more of ROM, PROM, EPROM, EEPROM, an optical ROM disk, such as a CD-ROM or DVD-ROM disk, and disk drive or the like.

Each of the links 123, 125, 242 and 252 can be any known or later developed device or system for connecting the corresponding devices to the general purpose computer 200, including a direct cable connection, a connection over a wide area network or a local area network, a connection over an intranet, a connection over the Internet, or a connection over any other distributed processing network or system. Further, it should be appreciated that the each of the links 123, 125, 242 and 252 can be a wired or wireless link. In general, each of the links 123, 125, 242 and 252 can be any known or later developed connection system or structure usable to connect the corresponding devices to the general purpose computer 200.

While this invention has been described in conjunction with the exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. A conditioned data visualizing system usable to view conditioned data having a plurality of dimensions and a plurality of measures, comprising:
a workflow control having a plurality of workflow control entries, each workflow control entry associated with a predetermined set of at least one dimension of the plurality of dimensions of the conditioned data and at least one measure of the plurality of measures of the conditioned data; and
a display manager capable of displaying, on a display device, a plurality of data visualization views and the workflow control;
wherein, when a workflow control entry is selected for viewing, the display manager accesses a portion of the conditioned data based on the predetermined set of the at least one dimension of the plurality of dimensions of the conditioned data and the at least one measure of the plurality of measures of the conditioned data associated with the selected workflow control entry and generates and displays at least one of the plurality of data visualization views, each displayed data visualization view generated based on at least a subset of the accessed portion of the conditioned data.

2. The conditioned data visualizing system of claim 1, wherein:
the workflow control further comprises a plurality of workflow control class entries; and
for each of at least some of the workflow control class entries, at least some of the workflow control entries are associated with that workflow control class entry.

3. The conditioned data visualizing system of claim 2, wherein each of the workflow control class entries can be selectively opened or closed, such that, when a workflow control class entry is opened, the display manager displays any workflow control entries associated with that workflow control class entry in the workflow control, and when that workflow control class entry is closed, the display manager removes the workflow control entries associated with that workflow control class entry from a display of the workflow control.

4. The conditioned data visualizing system of claim 3, wherein the display manager displays the workflow control entries associated with an opened workflow control class entry in the workflow control in a nested manner under that opened workflow control class entry.

5. The conditioned data visualizing system of claim 2, wherein:
each workflow control class entry has a selection icon associated with that workflow control class entry, and
when the selection icon associated with a particular workflow control class entry is selected, the display manager toggles that workflow control class entry between being open and being closed.

6. The conditioned data visualizing system of claim 2, further comprising an association properties table having a plurality of entries, each entry associated with one of the plurality of workflow control entries and containing data identifying the predetermined set of at least one dimension of the plurality of dimensions of the conditioned data and at least one measure of the plurality of measures of the conditioned data for that one of the plurality of workflow control entries and data identifying the workflow control class entry to which that one of the plurality of workflow control entries is associated.

7. The conditioned data visualizing system of claim 6, further comprising means for creating a new entry in the association properties table, for creating a new workflow control entry that is associated with the new entry in the association properties table and with a predetermined one of the plurality of workflow control class entries, and for adding data to the new entry identifying a new predetermined set of at least one dimension of the plurality of dimensions of the conditioned data and at least one measure of the plurality of measures of the conditioned data based on the dimensions and measures of the conditioned data currently displayed on the display by the display manager.

8. The conditioned data visualizing system of claim 1, wherein:
the workflow control further comprises:
a plurality of workflow control class entries, and
a plurality of workflow control subclass entries; and
for each of at least some of the workflow control entries, at least one of the plurality of workflow control subclass entries are associated with that workflow control class entry.

9. The conditioned data visualizing system of claim 8, wherein:
for each of at least some of the workflow control class entries, at least some of the workflow control entries are associated with that workflow control class entry; and
for each of at least some of the workflow control subclass entries, at least some of the workflow control entries are associated with that workflow control subclass entry.

10. The conditioned data visualizing system of claim 9, wherein each of the workflow control subclass entries can be selectively opened or closed, such that, when a workflow control subclass entry is opened, the display manager displays any workflow control entries associated with that workflow control subclass entry in the workflow control, and when that workflow control subclass entry is closed, the display manager removes the workflow control entries associated with that workflow control subclass entry from a display of the workflow control.

11. The conditioned data visualizing system of claim 10, wherein the display manager displays the workflow control entries associated with an opened workflow control subclass entry in the workflow control in a nested manner under that opened workflow control subclass entry.

12. The conditioned data visualizing system of claim 9, wherein:
each workflow control class subentry has a selection icon associated with that workflow control subclass entry, and
when the selection icon associated with a particular workflow control subclass entry is selected, the display manager toggles that workflow control subclass entry between being open and being closed.

13. The conditioned data visualizing system of claim 1, further comprising an association properties table having a plurality of entries, each entry associated with one of the plurality of workflow control entries and containing data identifying the predetermined set of at least one dimension of the plurality of dimensions of the conditioned data and at least one measure of the plurality of measures of the conditioned data for that one of the plurality of workflow control entries.

14. The conditioned data visualizing system of claim 1, wherein the display manager generates, as the plurality of data visualization views, at least two single dimensional views and at least one multiple dimensional view based on the predetermined set of at least one dimension and at least one measure associated with the selected workflow control entry.

15. The conditioned data visualizing system of claim 14, wherein the at least one multiple dimensional view comprises at least one of a multiscape view, a textual data view and a multiple dimensions view.

16. The conditioned data visualizing system of claim 15, wherein each workflow control entry is further associated with a predetermined set of enabled ones of the at least two single dimensional views, the multiscape view, the textual data view and the multiple dimensions view.

17. The conditioned data visualizing system of claim 14, wherein the predetermined set of at least one dimension and at least one measure comprises a first subset of at least one dimension associated with a first one of the at least two single dimensional views, a second subset of at least one dimension associated with a second one of the at least two single dimensional views.

18. The conditioned data visualizing system of claim 14, wherein the predetermined set of at least one dimension and at least one measure comprises a subset of at least one measure, the subset of at least one measure associated with each of the at least two single dimensional views and the at least one multiple dimensional views.

19. The conditioned data visualizing system of claim 14, wherein the display manager associates colors to values of the data visualized in the at least two single dimensional views and the at least one multiple dimensional views based on a selected one of the at least one dimension of the predetermined set of at least one dimension and at least one measure.

20. The conditioned data visualizing system of claim 1, wherein the workflow control is a tree-structured workflow control.

21. A graphical user interface for a conditioned data visualization system usable to view conditioned data having a plurality of dimensions and a plurality of measures, comprising:
a workflow control portion comprising a plurality of selectable workflow control entries, each workflow control entry associated with a predetermined set of at least one dimension of the plurality of dimensions of the conditioned data and at least one measure of the plurality of measures of the conditioned data; and
a data visualization portion comprising a plurality of data visualization views, each data visualization view usable to visualize at least one dimension and at least one measure;
wherein, when a workflow control entry is selected, the plurality of data visualization views are automatically populated with portions of the conditioned data selected based on the predetermined set of at least one dimension and at least one measure associated with the selected workflow control entry.

22. The graphical user interface of claim 21, wherein:
the workflow control portion further comprises a plurality of workflow control class entries; and
for each of at least some of the workflow control class entries, at least some of the workflow control entries are organized under that workflow control class entry.

23. The graphical user interface of claim 22, wherein each of the workflow control class entries can be selectively opened or closed, such that, when a workflow control class entry is opened, any workflow control entries organized under that workflow control class entry are displayed in the workflow control portion, and when that workflow control class entry is closed, the workflow control entries organized under that workflow control class entry not displayed in the workflow control portion.

24. The graphical user interface of claim 23, wherein the workflow control entries organized under an opened workflow control class entry are displayed in the workflow control in a nested manner under that opened workflow control class entry.

25. The graphical user interface of claim 22, wherein:
the workflow control portion further comprises a plurality of selection icons, each selection icon associated with one of the workflow control class entries, and
when the selection icon associated with a particular workflow control class entry is selected, that workflow control class entry is toggled between being open and being closed.

26. The graphical user interface of claim 21, wherein:
the workflow control portion further comprises:
a plurality of workflow control class entries, and
a plurality of workflow control subclass entries; and
for each of at least some of the workflow control entries, at least one of the plurality of workflow control subclass entries are organized under that workflow control class entry.

27. The graphical user interface of claim 26, wherein:
for each of at least some of the workflow control class entries, at least some of the workflow control entries are organized under that workflow control class entry; and
for each of at least some of the workflow control subclass entries, at least some of the workflow control entries are organized under that workflow control subclass entry.

28. The graphical user interface of claim 27, wherein each of the workflow control subclass entries can be selectively opened or closed, such that, when a workflow control subclass entry is opened, any workflow control entries organized under that workflow control subclass entry are displayed in the workflow control portion, and when that workflow control subclass entry is closed, the workflow control entries organized under that workflow control subclass entry are not displayed in the workflow control portion.

29. The graphical user interface of claim 28, wherein the workflow control entries organized under an opened workflow control subclass entry are displayed in the workflow control portion in a nested manner under that opened workflow control subclass entry.

30. The graphical user interface of claim 27, wherein:
the workflow control portion further comprises a plurality of selection icons, each selection icon associated with one of the workflow control class entries or one of the workflow control subclass entries, and
when the selection icon associated with a particular workflow control class or subclass entry is selected, that workflow control class or subclass entry is toggled between being open and being closed.

31. The graphical user interface of claim 21, wherein the data visualization portion comprises, as the plurality of data visualization views, at least two single dimensional views and at least one multiple dimensional view.

32. The graphical user interface of claim 31, wherein the predetermined set of at least one dimension and at least one measure comprises a first subset of at least one dimension associated with a first one of the at least two single dimensional views, and a second subset of at least one dimension associated with a second one of the at least two single dimensional views.

33. The graphical user interface of claim 32, wherein each single dimensional view comprises a list box, the list box comprising the dimensions of the subset of at least one dimension associated with that single dimensional view, such that, when a dimension of the list box is selected, data corresponding to that dimension is displayed in that single dimensional view and at least the multiscape view of the at least one multiple dimensional view.

34. The graphical user interface of claim 31, wherein the predetermined set of at least one dimension and at least one measure comprises a subset of at least one measure, the subset of at least one measure associated with each of the at least two single dimensional views and the at least one multiple dimensional views.

35. The graphical user interface of claim 34, further comprising a measures list box, the measures list box comprising the measures of the subset of at least one measure associated with the selected workflow control entry, such that, when a measure of the measures list box is selected, data corresponding to that measure is displayed in the at least two single dimensional views and at least the multiscape view of the at least one multiple dimensional view.

36. The graphical user interface of claim 31, further comprising a color-by list box, the color-by list box comprising the at least one dimension associated with the selected workflow control entry, wherein colors are associated to values of the data visualized in the at least two single dimensional views and the at least one multiple dimensional views based on a selected one of the at least one dimension of the color-by list box.

37. The graphical user interface of claim 31, wherein the at least one multiple dimensional view comprises at least one of a multiscape view, a textual data view and a multiple dimensions view.

38. The graphical user interface of claim 37, wherein the data visualization portion displays at most one of the multiscape view, the textual data view and the multiple dimensions view at any time.

39. The graphical user interface of claim 37, wherein each workflow control entry is further associated with a predetermined set of enabled ones of the at least two single dimensional views, the multiscape view, the textual data view and the multiple dimensions view.

40. The graphical user interface of claim 37, wherein:
the multiscape view comprises a three-dimensional landscape view;
a first axis of the three-dimensional landscape view is associated with the dimension currently displayed in a first one of the single dimensional views;
a second axis of the three-dimensional landscape view is associated with the dimension currently displayed in a second one of the single dimensional views; and
a third axis of the three-dimensional landscape view is associated with the measure currently displayed in the at least two single dimensional views;

41. The graphical user interface of claim 37, wherein:
the textual data view comprises a plurality of columns, each column associated with one of the at least one dimension associated with the selected workflow control entry;
each column displays at least one of textual and numerical data for the associated dimension; and
at least some of the columns has a column header having a sorting icon, such that, when the sorting icon is selected, the dimension associated with that column becomes a primary sort dimension.

42. The graphical user interface of claim 41, wherein, when the sorting icon of a column is selected, a sort order of the dimension associated with that column is toggled between a first order and a second order.

43. The graphical user interface of claim 41, wherein, when the sorting icon of a column is selected, the dimension associated with an immediately previously selected column becomes a second sort dimension.

44. The graphical user interface of claim 41, wherein the textual data view further comprises a window having a vertical scroll bar having a scroll bar element and a pair of scale elements.

45. The graphical user interface of claim 44, wherein a distance between the pair of scale elements defines a scale factor between a vertical extent of the window of the textual data view and a vertical length of the data displayed in the plurality of columns of the textual data view.

46. The graphical user interface of claim 45, wherein a size of each data element in each column of the textual data view is determined based on the scale factor.

47. The graphical user interface of claim 41, wherein, for each at least some of the at least two single dimensional views, one column of the textual data view displays data of the dimension currently displayed in that single dimensional view.

48. The graphical user interface of claim 37, wherein:
the multiple dimensional view comprises a plurality of columns, each column associated with one of the at least one dimension associated with the selected workflow control entry;
each column displays at least one of textual and numerical data for the associated dimension;
at least some of the columns displaying numerical data display a relative value for each value of the numerical data; and
at least some of the columns has a column header having a sorting icon, such that, when the sorting icon is selected, the dimension associated with that column becomes a primary sort dimension.

49. The graphical user interface of claim 48, wherein, when the sorting icon of a column is selected, a sort order of the dimension associated with that column is toggled between a first order and a second order.

50. The graphical user interface of claim 48, wherein, when the sorting icon of a column is selected, the dimension associated with an immediately previously selected column becomes a second sort dimension.

51. The graphical user interface of claim 48, wherein, for each at least some of the at least two single dimensional views, one column of the multiple dimensional view displays data of the dimension currently displayed in that single dimensional view.

52. The graphical user interface of claim 31, wherein, when a portion of data displayed in one of the at least two single dimensional views and the displayed one of the at least one multiple dimensional view displayed in the data visualization portion is selected and other data is deselected, data in the other ones of the at least two single dimensional views and the displayed one of the at least one multiple dimensional view displayed in the data visualization portion corresponding to the selected data is selected, and any other displayed data in the other ones of the at least two single dimensional views and the displayed one of the at least one multiple dimensional view displayed in the data visualization portion is deselected.

53. The graphical user interface of claim 52, wherein the deselected data is displayed using at least a first color and the selected data is displayed using colors other than the at least first color.

54. The graphical user interface of claim 52, wherein the selected data is displayed in color and the deselected data is not displayed.

55. The graphical user interface of claim 21, wherein the workflow control is a tree-structured workflow control.

56. A method for visualizing conditioned data, comprising:
inputting a set of conditioned data having a plurality of dimensions and a plurality of measures;
displaying a workflow control view comprising a plurality of selectable workflow control entries;
associating, for each workflow control entry, that workflow control entry with a predetermined set comprising at least one dimension of the plurality of dimensions of the conditioned data and at least one measure of the plurality of measures of the conditioned data;
receiving an input selecting one of the selectable workflow control entries;
selecting a portion of the conditioned data based on the predetermined set associated with the selected workflow entry; and
generating and displaying at least one of a plurality of data visualization views based on the selected portion of the conditioned data.

57. The method of claim 56, wherein:
the workflow control view further comprises a plurality of workflow control class entries; and
for each of at least some of the workflow control class entries, at least some of the workflow control entries are organized under that workflow control class entry.

58. The method of claim 57, further comprising:
selecting a workflow control class entry; and
in response to selecting that workflow control class entry, toggling a display state of that workflow control class entry between open and closed.

59. The method of claim 58, wherein:
toggling the display state of that workflow control class entry to open comprises displaying any workflow control entries organized under that workflow control class entry in the workflow control view; and
toggling the display state of that workflow control class entry to closed comprises not displaying the workflow control entries organized under that workflow control class entry in the workflow control view.

60. The method of claim 59, wherein displaying the workflow control entries organized under an opened workflow control class entry comprises displaying those workflow control entries in a nested manner under that opened workflow control class entry.

61. The method of claim 58, wherein selecting a workflow control class entry comprises selecting a selection icon associated with that workflow control class entry.

62. The method of claim 56, wherein:
the workflow control view further comprises:
a plurality of workflow control class entries, and
a plurality of workflow control subclass entries; and
for each of at least some of the workflow control class entries, at least some of the workflow control entries are organized under that workflow control class entry; and
for each of at least some of the workflow control subclass entries, at least some of the workflow control entries are organized under that workflow control subclass entry.

63. The method of claim 62, further comprising:
selecting a workflow control class or subclass entry; and
in response to selecting that workflow control class or subclass entry, toggling a display state of that workflow control class or subclass entry between open and closed.

64. The method of claim 63, wherein:
toggling the display state of that workflow control class entry to open comprises displaying any workflow control entries or workflow control subclass entries organized under that workflow control class entry in the workflow control view; and
toggling the display state of that workflow control class entry to closed comprises not displaying the workflow control entries and workflow control subclass entries organized under that workflow control class entry in the workflow control view.

65. The method of claim 63, wherein:
toggling the display state of that workflow control subclass entry to open comprises displaying any workflow control entries organized under that workflow control subclass entry in the workflow control view; and
toggling the display state of that workflow control subclass entry to closed comprises not displaying the workflow control entries organized under that workflow control subclass entry in the workflow control view.

66. The method of claim 63, wherein displaying the workflow control subclass entries organized under an opened workflow control class entry comprises displaying those workflow control subclass entries in a nested manner under that opened workflow control class entry.

67. The method of claim 63, wherein displaying the workflow control entries organized under an opened workflow control subclass entry comprises displaying those workflow control entries in a nested manner under that opened workflow control subclass entry.

68. The method of claim 63, wherein selecting a workflow control subclass entry comprises selecting a selection icon associated with that workflow control subclass entry.

69. The method of claim 56, wherein generating and displaying the plurality of data visualization views comprises generating and displaying at least two single dimensional views and at least one multiple dimensional view.

70. The method of claim 69, wherein the predetermined set of at least one dimension and at least one measure comprises a first subset of at least one dimension associated with a first one of the at least two single dimensional views, and a second subset of at least one dimension associated with a second one of the at least two single dimensional views.

71. The method of claim 70, wherein generating and displaying a single dimensional view comprises generating and displaying a list box based on the dimensions of the subset of at least one dimension associated with that single dimensional view.

72. The method of claim 71, further comprising, in response to a selection of a dimension of the list box, displaying data corresponding to the selected dimension in the corresponding single dimensional view and at least a multiscape view of the at least one multiple dimensional view.

73. The method of claim 69, wherein the predetermined set of at least one dimension and at least one measure comprises a subset of at least one measure, the subset of at least one measure associated with each of the at least two single dimensional views and the at least one multiple dimensional views.

74. The method of claim 73, wherein generating and displaying the plurality of data visualization views comprises generating and displaying a list box based on the subset of at least one measure associated with the selected workflow control entry.

75. The method of claim 74, further comprising, in response to a selection of a measure of the list box, displaying data corresponding to the selected measure in the at least two single dimensional views and at least a multiscape view of the at least one multiple dimensional view.

76. The method of claim 69, wherein the predetermined set of at least one dimension and at least one measure comprises a subset of at least two dimensions, each dimension of the subset associated with at least one of the at least two single dimensional views.

77. The method of claim 76, wherein generating and displaying a single dimensional view comprises generating and displaying a list box based on the dimensions of the subset of at least two dimensions associated with the at least two single dimensional view.

78. The method of claim 77, further comprising, in response to a selection of a dimension of the list box, associating colors to values of the data visualized in the at least two single dimensional views and the at least one multiple dimensional view based on the selected dimension.

79. The method of claim 69, wherein generating and displaying at least one multiple dimensional view comprises generating and displaying at least one of a multiscape view, a textual data view and a multiple dimensions view.

80. The method of claim 79, wherein generating and displaying at least one of the multiscape view, the textual data view and the multiple dimensions view comprises displaying at most one of the multiscape view, the textual data view and the multiple dimensions view at any time.

81. The method of claim 79, wherein generating and displaying at least one of the multiscape view, the textual data view and the multiple dimensions view comprises selectively generating each of the multiscape view, the textual data view and the multiple dimensions view based on the selected workflow control entry.

82. The method of claim 79, wherein generating the multiscape view comprises:
generating a three-dimensional landscape view;
associating a first axis of the three-dimensional landscape view with the dimension currently displayed in a first one of the single dimensional views;
associating a second axis of the three-dimensional landscape view with the dimension currently displayed in a second one of the single dimensional views; and
associating a third axis of the three-dimensional landscape view with the measure currently displayed in the at least two single dimensional views;

83. The method of claim 79, wherein generating the textual data view comprises:
generating a plurality of columns, at least some of the columns has a column header having a sorting icon; and
associating each column with one of the at least one dimension associated with the selected workflow control entry, where each column displays at least one of textual and numerical data for the associated dimension; and

84. The method of claim 79, further comprising, in response to a selection of a sorting icon of a column, sorting the data values displayed in the plurality of columns using the dimension associated with that column as a primary sort dimension.

85. The method of claim 84, further comprising, in response to a further selection of the sorting icon of that column, toggling a sort order data values of the dimension associated with that column between a first order and a second order.

86. The method of claim 84, further comprising, in response to the selection of the sorting icon of that column, sorting the data values displayed in the plurality of columns using the dimension associated with an immediately previously selected column as a second sort dimension.

87. The method of claim 83, wherein displaying the textual data view comprises displaying the plurality of columns in a window having a vertical scroll bar having a scroll bar element and a pair of scale elements.

88. The method of claim 87, further comprising defining a scale factor between a vertical extent of the window of the textual data view and a vertical length of the data displayed in the plurality of columns of the textual data view for displaying the data values in the plurality of columns in the window based on a distance between the pair of scale elements.

89. The method of claim 88, further comprising determining a size of each data element in each column of the textual data view based on the scale factor.

90. The method of claim 83, further comprising, for each of at least some of the at least two single dimensional views, displaying in one column of the textual data view data of the dimension currently displayed in that single dimensional view.

91. The method of claim 79, wherein generating the multiple dimensional view comprises:
generating a plurality of columns, at least some of the columns having a column header having a sorting icon;
associating each column with one of the at least one dimension associated with the selected workflow control entry, each column displaying at least one of textual and numerical data for the associated dimension;

92. The method of claim 91, wherein displaying the multiple dimensional view comprises displaying, for at least some of the columns displaying numerical data, a relative value for each value of the numerical data.

92. The method of claim 91, further comprising, in response to a selection of a sorting icon of a column, sorting the data values displayed in the plurality of columns using the dimension associated with that column as a primary sort dimension.

94. The method of claim 93, further comprising, in response to a further selection of the sorting icon of that column, toggling a sort order data values of the dimension associated with that column between a first order and a second order.

95. The method of claim 93, further comprising, in response to the selection of the sorting icon of that column, sorting the data values displayed in the plurality of columns using the dimension associated with an immediately previously selected column as a second sort dimension.

96. The method of claim 91, further comprising, for each at least some of the at least two single dimensional views, displaying in one column of the multiple dimensional view data of the dimension currently displayed in that single dimensional view.

97. The method of claim 69, further comprising:
selecting a portion of data displayed in one of the at least two single dimensional views and the displayed one of the at least one multiple dimensional view displayed in the data visualization portion and deselecting other data; and
in response, selecting data in the other ones of the at least two single dimensional views and the displayed one of the at least one multiple dimensional view displayed in the data visualization portion corresponding to the selected data, and deselecting any other displayed data in the other ones of the at least two single dimensional views and the displayed one of the at least one multiple dimensional view.

98. The method of claim 97, wherein displaying the selected and deselected data comprises displaying the deselected data using at least a first color and displaying the selected data using colors other than the at least first color.

99. The method of claim 97, further comprising removing the deselected data from the at least two single dimensional views and the displayed one of the at least one multiple dimensional view, wherein displaying the selected data comprises displaying the selected data in color.

100. A conditioned data report generating system usable to generate at least one report from conditioned data having a plurality of dimensions and a plurality of measures, comprising:
a report selection control having a plurality of report selection control entries, each report selection control entry associated with a predetermined set of at least one dimension of the plurality of dimensions of the conditioned data and at least one measure of the plurality of measures of the conditioned data; and
a display manager capable of displaying, on a display device, the report selection control;
a report generation manager capable of generating at least one different type of report;
wherein, when a report selection entry is selected for generation of a corresponding report, the report generation manager accesses a portion of the conditioned data based on the predetermined set associated with the selected report selection entry and generates one of the at least one different type of report, each generated report generated based on at least a subset of the accessed portion of the conditioned data.

101. The conditioned data report generating system of claim 100, wherein:
the report selection control further comprises a plurality of report selection control class entries; and
for each of at least some of the report selection control class entries, at least some of the report selection control entries are associated with that report selection control class entry.

102. The conditioned data report generating system of claim 101, wherein each of the report selection control class entries can be selectively opened or closed, such that, when a report selection control class entry is opened, the display manager displays any report selection control entries associated with that report selection control class entry in the report selection control, and when that report selection control class entry is closed, the display manager removes the report selection control entries associated with that report selection control class entry from a display of the report selection control.

103. The conditioned data report generating system of claim 102, wherein the display manager displays the report selection control entries associated with an opened report selection control class entry in the report selection control in a nested manner under that opened report selection control class entry.

104. The conditioned data report generating system of claim 101, wherein:
each report selection control class entry has a selection icon associated with that report selection control class entry, and
when the selection icon associated with a particular report selection control class entry is selected, the display manager toggles that report selection control class entry between being open and being closed.

105. The conditioned data report generating system of claim 101, further comprising an association properties table having a plurality of entries, each entry associated with one of the plurality of report selection control entries and containing data identifying the predetermined set of at least one dimension of the plurality of dimensions of the conditioned data and at least one measure of the plurality of measures of the conditioned data for that one of the plurality of report selection control entries and data identifying the report selection control class entry to which that one of the plurality of report selection control entries is associated.

106. The conditioned data report generating system of claim 105, further comprising means for creating a new entry in the association properties table, for creating a new report selection control entry that is associated with the new entry in the association properties table and with a predetermined one of the plurality of report selection control class entries, and for adding data to the new entry identifying a new predetermined set of at least one dimension of the plurality of dimensions of the conditioned data and at least one measure of the plurality of measures of the conditioned data based on the dimensions and measures of the conditioned data currently displayed on the display by the display manager.

107. The conditioned data report generating system of claim 100, wherein:
the report selection control further comprises:
a plurality of report selection control class entries, and
a plurality of report selection control subclass entries; and
for each of at least some of the report selection control entries, at least one of the plurality of report selection control subclass entries are associated with that report selection control class entry.

108. The conditioned data report generating system of claim 107, wherein:
for each of at least some of the report selection control class entries, at least some of the report selection control entries are associated with that report selection control class entry; and
for each of at least some of the report selection control subclass entries, at least some of the report selection control entries are associated with that report selection control subclass entry.

109. The conditioned data report generating system of claim 108, wherein each of the report selection control subclass entries can be selectively opened or closed, such that, when a report selection control subclass entry is opened, the display manager displays any report selection control entries associated with that report selection control subclass entry in the report selection control, and when that report selection control subclass entry is closed, the display manager removes the report selection control entries associated with that report selection control subclass entry from a display of the report selection control.

110. The conditioned data report generating system of claim 109, wherein the display manager displays the report selection control entries associated with an opened report selection control subclass entry in the report selection control in a nested manner under that opened report selection control subclass entry.

111. The conditioned data report generating system of claim 108, wherein:
each report selection control class subentry has a selection icon associated with that report selection control subclass entry, and
when the selection icon associated with a particular report selection control subclass entry is selected, the display manager toggles that report selection control subclass entry between being open and being closed.

112. The conditioned data report generating system of claim 100, further comprising an association properties table having a plurality of entries, each entry associated with one of the plurality of report selection control entries and containing data identifying the predetermined set of at least one dimension of the plurality of dimensions of the conditioned data and at least one measure of the plurality of measures of the conditioned data for that one of the plurality of report selection control entries.

113. The conditioned data report generating system of claim 100, wherein the report generation manager generates, as the at least one different type of report, at least one of a first type report and a second type report, the first type report comprising a single dimensional view, the second type report comprising at least two single dimensional views and at least one multiple dimensional view.

114. The conditioned data report generating system of claim 113, wherein, in response to an input selecting the first type report, the report generation manager generates, for the selected report generation control entry, at least one first type report, each first type report based on a different dimension of the predetermined set of at least one dimension associated with the selected report generation control entry and a selected measure of the predetermined set of at least one measure associated with the selected report selection control entry.

115. The conditioned data report generating system of claim 114, wherein each first type report comprises the single dimensional view and a table relating each value of the particular one of the predetermined set of at least one dimension with an appearance of a portion of the single dimensional view corresponding to that value.

116. The conditioned data report generating system of claim 115, wherein the appearance is a color.

117. The conditioned data report generating system of claim 114, wherein, in response to the input selecting the first type report, the report generation manager generates, for the selected report generation control entry, the at least one first type report based on a currently selected portion of the conditioned data.

118. The conditioned data report generating system of claim 113, wherein, in response to an input selecting the second type report, the report generation manager generates, for the selected report generation control entry, at least one second type report, each second type report based on a different subset of at least two dimensions of the predetermined set of at least one dimension associated with the selected report generation control entry and a selected measure of the predetermined set of at least one measure associated with the selected report selection control entry.

119. The conditioned data report generating system of claim 118, wherein each second type report comprises the two single dimensional views and a pair of tables, each table relating each value of the particular one of the subset of two dimension with an appearance of a portion corresponding to that value of a single dimensional view corresponding to that dimension.

120. The conditioned data report generating system of claim 119, wherein the appearance is a color.

121. The conditioned data report generating system of claim 118, wherein, in response to the input selecting the second type report, the report generation manager generates, for the selected report generation control entry, the at least one second type report based on a currently selected portion of the conditioned data.

122. The conditioned data report generating system of claim 113, further comprising a report display selection control having at least one report display selection control entry, each report display selection control entry associated with one of the at least one report generated by the report generation manager, wherein:
in response to the report generation manager generating the at least one first or second type report, the display manager displays the report display selection control and a predetermined one of the at least one first or second type report; and
in response to one of the at least one report display selection control entry being selected, the display manager displays the first or second type report associated with that selected report display selection control.

123. The conditioned data report generating system of claim 113, wherein the at least one multiple dimensional view comprises at least one of a multiscape view, a textual data view and a multiple dimensions view.

124. The conditioned data report generating system of claim 100, further comprising a report option selection control having at least one report option selector, wherein the report generation manager generates the at least one first or second type report further based on at least one report option selected using the at least one report option selector.

125. The conditioned data report generating system of claim 124, wherein the report option selection control includes a measure selector, the measure selector permitting one of the predetermined set of at least one measure to be selected, the report generation manager generating the at least one different type of report further based on the selected measure.

126. The conditioned data report generating system of claim 124, wherein the report option selection control includes a dimension selector, the dimension selector permitting one of the predetermined set of at least one dimension to be selected, wherein the report generation manager associates colors to values of the data contained in the at least one different type of report based on the selected dimension.

127. The conditioned data report generating system of claim 124, wherein the report option selection control includes a report type selector, the report type selector permitting one of the at least one different type of report to be selected, the report generation manager generating the at least one report further based on the selected report type.

128. The conditioned data report generating system of claim 124, wherein the report option selection control includes a data context selector, the data context selector permitting one of a predetermined set of at least two data contexts to be selected, the report generation manager generating the at least one different type of report further based on the selected data context.

129. The conditioned data report generating system of claim 128, wherein the predetermined set of at least two data contexts comprises at least two of a current selection state context, a currently displayed data context and an all data context.

130. The conditioned data report generating system of claim 100, wherein the report selection control is a tree-structured report selection control.

131. A graphical user interface for a conditioned data report generating system usable to generate reports from conditioned data having a plurality of dimensions and a plurality of measures, comprising:
a report selection control portion, comprising a plurality of selectable report selection control entries, each report selection control entry associated with a predetermined set of at least one dimension of the plurality of dimensions of the conditioned data and at least one measure of the plurality of measures of the conditioned data;
wherein, in response to an input indicating at least one report is to be generated, at least one report is generated, based on a selected report selection control entry, using portions of the conditioned data selected based on the predetermined set of at least one dimension and at least one measure associated with the selected report selection control entry.

132. The graphical user interface of claim 131, wherein:
the report selection control portion further comprises a plurality of report selection control class entries; and
for each of at least some of the report selection control class entries, at least some of the report selection control entries are organized under that report selection control class entry.

133. The graphical user interface of claim 132, wherein each of the report selection control class entries can be selectively opened or closed, such that, when a report selection control class entry is opened, any report selection control entries organized under that report selection control class entry are displayed in the report selection control portion, and when that report selection control class entry is closed, the report selection control entries organized under that report selection control class entry not displayed in the report selection control portion.

134. The graphical user interface of claim 133, wherein the report selection control entries organized under an opened report selection control class entry are displayed in the report selection control in a nested manner under that opened report selection control class entry.

135. The graphical user interface of claim 132, wherein:
the report selection control portion further comprises a plurality of selection icons, each selection icon associated with one of the report selection control class entries, and
when the selection icon associated with a particular report selection control class entry is selected, that report selection control class entry is toggled between being open and being closed.

136. The graphical user interface of claim 131, wherein:
the report selection control portion further comprises:
a plurality of report selection control class entries, and
a plurality of report selection control subclass entries; and
for each of at least some of the report selection control entries, at least one of the plurality of report selection control subclass entries are organized under that report selection control class entry.

137. The graphical user interface of claim 136, wherein:
for each of at least some of the report selection control class entries, at least some of the report selection control entries are organized under that report selection control class entry; and
for each of at least some of the report selection control subclass entries, at least some of the report selection control entries are organized under that report selection control subclass entry.

138. A The graphical user interface of claim 137, wherein each of the report selection control subclass entries can be selectively opened or closed, such that, when a report selection control subclass entry is opened, any report selection control entries organized under that report selection control subclass entry are displayed in the report selection control portion, and when that report selection control subclass entry is closed, the report selection control entries organized under that report selection control subclass entry are not displayed in the report selection control portion.

139. The graphical user interface of claim 138, wherein the report selection control entries organized under an opened report selection control subclass entry are displayed in the report selection control portion in a nested manner under that opened report selection control subclass entry.

140. The graphical user interface of claim 137, wherein:
the report selection control portion further comprises a plurality of selection icons, each selection icon associated with one of the report selection control class entries or one of the report selection control subclass entries, and
when the selection icon associated with a particular report selection control class or subclass entry is selected, that report selection control class or subclass entry is toggled between being open and being closed.

141. The graphical user interface of claim 131, further comprising a report option selection portion comprising at least one report option selector, wherein, in response to an input indicating at least one report is to be generated, the at least one report is generated further based on at least one report option selected using the at least one report option selector of the report option selection portion.

142. The graphical user interface of claim 141, wherein the report option selection portion includes a measure selector, the measure selector permitting one of the predetermined set of at least one measure to be selected, the at least one report generated further based on the selected measure.

143. The graphical user interface of claim 142, wherein measure selector comprises a list box, the list box comprising the measures of the subset of at least one measure associated with the selected report selection control entry.

144. The graphical user interface of claim 141, wherein the report option selection portion includes a dimension selector, the dimension selector permitting one of the predetermined set of at least one dimension to be selected, colors associated to values of the data contained in the at least one report based on the selected dimension.

145. The graphical user interface of claim 144, wherein dimension selector comprises a list box, the list box comprising the dimensions of the subset of at least one dimension associated with the selected report selection control entry.

146. The graphical user interface of claim 141, wherein the report option selection portion includes a report type selector, the report type selector permitting one of a plurality of different types of report to be selected, the at least one report generated further based on the selected report type.

147. The graphical user interface of claim 146, wherein the report type selector comprises a plurality of radio buttons, each radio button associated with one of the plurality of different types of reports.

148. The graphical user interface of claim 141, wherein the report option selection portion includes a data context selector, the data context selector permitting one of a predetermined set of a plurality of data contexts to be selected, the at least one report generated further based on the selected data context.

149. The graphical user interface of claim 148, wherein the predetermined set of at least two data contexts comprises at least two of a current selection state context, a currently displayed data context and an all data context.

150. The graphical user interface of claim 148, wherein the data context selector comprises a plurality of radio buttons, each radio button associated with one of the plurality of data contexts.

151. The graphical user interface of claim 131, further comprising a report display screen, comprising:
a report display selection portion having at least one report display selection control entry, each report display selection control entry associated with one of the generated at least one report; and
a data visualization portion, wherein at least one data visualization view is displayed for a displayed one of the generated at least one report.

152. The graphical user interface of claim 151, wherein, in response to an input selecting a first type report, the data visualization portion comprises a single dimensional view and a table portion.

153. The graphical user interface of claim 152, wherein each report display selection control entry is associated with a different first type report that is based on a different dimension of the predetermined set of at least one dimension associated with the selected report generation control entry and a selected measure of the predetermined set of at least one measure associated with the selected report selection control entry.

154. The graphical user interface of claim 152, wherein the table portion comprises a table relating each value of a dimension with an appearance of a portion of the single dimensional view corresponding to that value.

155. The graphical user interface of claim 154, wherein the appearance is a color.

156. The graphical user interface of claim 151, wherein, in response to an input selecting a second type report, the data visualization portion comprises a multiple dimensional view, a plurality of single dimensional views, and a plurality of table portions.

157. The graphical user interface of claim 156, wherein each report display selection control entry is associated with a different second type report that is based on a different set of a plurality of dimension of the predetermined set of at least one dimension associated with the selected report generation control entry and a selected measure of the predetermined set of at least one measure associated with the selected report selection control entry.

158. The graphical user interface of claim 156, wherein each table portion is associated with one of the plurality of single dimensional views and comprises a table relating each value of a dimension with an appearance of a portion of that single dimensional view corresponding to that value.

159. The graphical user interface of claim 158, wherein the appearance is a color.

160. The graphical user interface of claim 156, wherein the multiple dimensional view comprises at least one of a multiscape view, a textual data view and a multiple dimensions view.

161. The graphical user interface of claim 160, wherein:
the multiscape view comprises a three-dimensional landscape view;
a first axis of the three-dimensional landscape view is associated with the dimension displayed in a first one of the single dimensional views;
a second axis of the three-dimensional landscape view is associated with the dimension displayed in a second one of the single dimensional views; and
a third axis of the three-dimensional landscape view is associated with the measure currently displayed in the first and second single dimensional views;

162. A method for generating reports based on conditioned data, comprising:
inputting a set of conditioned data having a plurality of dimensions and a plurality of measures;
displaying a report selection control view comprising a plurality of selectable report selection control entries;
associating, for each report selection control entry, that report selection control entry with a predetermined set of at least one dimension of the plurality of dimensions of the conditioned data and at least one measure of the plurality of measures of the conditioned data;
receiving an input selecting one of the selectable report selection control entries;
selecting a portion of the conditioned data based on the predetermined set associated with the selected report selection entry; and
generating at least one report based at least on the selected portion of the conditioned data.

163. The method of claim 162, wherein:
the report selection control view further comprises a plurality of report selection control class entries; and
for each of at least some of the report selection control class entries, at least some of the report selection control entries are organized under that report selection control class entry.

164. The method of claim 163, further comprising:
selecting a report selection control class entry; and
in response to selecting that report selection control class entry, toggling a display state of that report selection control class entry between open and closed.

165. The method of claim 164, wherein:
toggling the display state of that report selection control class entry to open comprises displaying any report selection control entries organized under that report selection control class entry in the report selection control view; and
toggling the display state of that report selection control class entry to closed comprises not displaying the report selection control entries organized under that report selection control class entry in the report selection control view.

166. The method of claim 160, wherein displaying the report selection control entries organized under an opened report selection control class entry comprises displaying those report selection control entries in a nested manner under that opened report selection control class entry.

167. The method of claim 164, wherein selecting a report selection control class entry comprises selecting a selection icon associated with that report selection control class entry.

168. The method of claim 162, wherein:
the report selection control view further comprises:
a plurality of report selection control class entries, and
a plurality of report selection control subclass entries; and
for each of at least some of the report selection control class entries, at least some of the report selection control entries are organized under that report selection control class entry; and
for each of at least some of the report selection control subclass entries, at least some of the report selection control entries are organized under that report selection control subclass entry.

169. The method of claim 168, further comprising:
selecting a report selection control class or subclass entry; and
in response to selecting that report selection control class or subclass entry, toggling a display state of that report selection control class or subclass entry between open and closed.

170. The method of claim 169, wherein:
toggling the display state of that report selection control class entry to open comprises displaying any report selection control entries or report selection control subclass entries organized under that report selection control class entry in the report selection control view; and
toggling the display state of that report selection control class entry to closed comprises not displaying the report selection control entries and report selection control subclass entries organized under that report selection control class entry in the report selection control view.

171. The method of claim 169, wherein:
toggling the display state of that report selection control subclass entry to open comprises displaying any report selection control entries organized under that report selection control subclass entry in the report selection control view; and
toggling the display state of that report selection control subclass entry to closed comprises not displaying the report selection control entries organized under that report selection control subclass entry in the report selection control view.

172. The method of claim 169, wherein displaying the report selection control subclass entries organized under an opened report selection control class entry comprises displaying those report selection control subclass entries in a nested manner under that opened report selection control class entry.

173. The method of claim 169, wherein displaying the report selection control entries organized under an opened report selection control subclass entry comprises displaying those report selection control entries in a nested manner under that opened report selection control subclass entry.

174. The method of claim 169, wherein selecting a report selection control subclass entry comprises selecting a selection icon associated with that report selection control subclass entry.

175. The method of claim 162, further comprising:
displaying a report option selection view comprising at least one report option selector; and
receiving at least one input selecting at least one report option of at least one report option selector;
wherein generating the at least one report based on the selected portion of the conditioned data comprises generating the at least one report further based on the selected at least one report option.

176. The method of claim 175, wherein:
the at least one report option selector includes a measure selector;
receiving the at least one input selecting at least one report option of at least one report option selector comprises selecting one of the predetermined set of at least one measure using the measure selector; and
generating the at least one report based on the selected portion of the conditioned data comprises generating the at least one report further based on the selected measure.

177. The method of claim 175, wherein:
the at least one report option selector includes a dimension selector;
receiving the at least one input selecting at least one report option of at least one report option selector comprises selecting one of the predetermined set of at least one dimension using the dimension selector; and
generating the at least one report based on the selected portion of the conditioned data comprises associating colors to values of the data contained in the at least one report based on the selected dimension.

178. The method of claim 175, wherein:
the at least one report option selector includes a data context selector permitting one of a plurality of data contexts to be selected;
receiving the at least one input selecting at least one report option of at least one report option selector comprises selecting one of the plurality of different data contexts using the data context selector; and
generating the at least one report based on the selected portion of the conditioned data comprises generating the at least one report further based on the selected data context.

179. The method of claim 175, wherein:
the at least one report option selector includes a report type selector permitting one of a plurality of different types of report to be selected;
receiving the at least one input selecting at least one report option of at least one report option selector comprises selecting one of the plurality of different types of report using the report type selector; and
generating the at least one report based on the selected portion of the conditioned data comprises generating the at least one report further based on the selected report type.

180. The method of claim 162, further comprising displaying the at least one generated report.

181. The method of claim 180, wherein displaying the at least one report comprises:
displaying a report display selection view having at least one report display selection control entry, each report display selection control entry associated with one of the generated at least one report; and
displaying the at least one generated report in a data visualization view.

182. The method of claim 181, wherein, in response to receiving an input selecting a first type report, displaying the at least one generated report in the data visualization view comprises displaying at least one first type report comprising a single dimensional view and a table portion in the data visualization portion.

183. The method of claim 182, wherein, in response to receiving an input selecting a first type report, each report display selection control entry is associated with a different first type report that is based on a different dimension of the predetermined set of at least one dimension associated with the selected report generation control entry and a selected measure of the predetermined set of at least one measure associated with the selected report selection control entry.

184. The method of claim 182, wherein displaying the table portion comprises displaying a table relating each value of a dimension with an appearance of a portion of the single dimensional view corresponding to that value.

185. The method of claim 184, wherein the appearance is a color.

186. The method of claim 181, wherein, in response to an input selecting a second type report, displaying the at least one generated report in the data visualization view comprises displaying at least one second type report comprising a multiple dimensional view, a plurality of single dimensional views, and a plurality of table portions in the data visualization portion.

187. The method of claim 182, wherein, in response to receiving an input selecting a second type report, each report display selection control entry is associated with a different second type report that is based on a different set of at least two dimensions of the predetermined set of at least one dimension associated with the selected report generation control entry and a selected measure of the predetermined set of at least one measure associated with the selected report selection control entry.

188. The method of claim 187, wherein displaying the plurality of table portions comprises displaying, for each of the plurality of single dimensional views, a table relating each value of a dimension with an appearance of a portion of that single dimensional view corresponding to that value.

189. The method of claim 188, wherein the appearance is a color.

190. The method of claim 186, wherein the multiple dimensional view comprises at least one of a multiscape view, a textual data view and a multiple dimensions view.

191. The method of claim 190, wherein displaying the multiscape view as the multiple dimensional view comprises displaying a three-dimensional landscape view

192. The method of claim 191, wherein displaying the three-dimensional landscape view comprises:
associating a first axis of the three-dimensional landscape view with the dimension displayed in a first one of the single dimensional views;
associating a second axis of the three-dimensional landscape view with the dimension displayed in a second one of the single dimensional views; and
associating a third axis of the three-dimensional landscape view with the measure displayed in the first and second single dimensional views.

193. A web site activity log data managing system that manages web site activity data for a web site, comprising:
at least one memory, each memory usable to store at least one web site activity log;
at least one web site server, each web site server usable to receive requests from clients for web pages of the web site stored on that web site serve, to store information about the received requests in a corresponding one of the at least one web site activity log for that web site server, and to transmit the requested web pages and appended information to the clients; and
at least one server/log interface, each server/log interface provided between an associated one of the at least one web site server and the corresponding web site activity log;
wherein, for each server/log interface, upon the associated web site server receiving a web page request, that server/log interface is usable to analyze the information to be stored about the received request to determine if the received request is a first request of a new visitor to the web site, and, upon determining that the received request is the first request of a new visitor to the web site, that server/log interface is usable to add an information string to the information to be stored about that received request and to the appended information to be transmitted with the web page corresponding to the received request, such that, when the associated web site server transmits the corresponding web page and appended information, both the appended information and the stored information about that received request include the information string.

194. The web site activity log data managing system of claim 193, wherein, when the at least one web site server receives a subsequent web page request from a current visitor to the web site that contains the appended information, the at least one server log interface stores the subsequent web page request and the appended information in one of the at least one web site activity log, such that, when the at least one web site activity log is analyzed, the information stored in the at least one web site activity log about the first web page request from a particular visitor can be associated with the information stored in the at least one web site activity log about subsequent web page requests from that visitor.
